(19) United States
(12) Patent Application Publication
(10) Pub. No.: US 2016/0289418 A1
(43) Pub. Date: Oct. 6, 2016

(54) HYDRAULIC BARRIER COMPOSITION AND METHOD OF MAKING THE SAME

(71) Applicant: AMCOL INTERNATIONAL CORPORATION, Hoffman Estates, IL (US)

(72) Inventors: Michael DONOVAN, Huntley, IL (US); Christos Athanassopoulos, Volo, IL (US)

(21) Appl. No.: 15/090,559

(22) Filed: Apr. 4, 2016

Related U.S. Application Data
(63) Continuation-in-part of application No. 13/752,366, filed on Jan. 28, 2013.
(60) Provisional application No. 61/591,834, filed on Jan. 27, 2012.

(51) Int. Cl. C08K 3/34

(52) U.S. Cl. CPC C08K 3/346

(57) ABSTRACT

A hydraulic barrier composition can include granules of a water-swellable clay and a water-solvatable polymer. Upon contact with a leachate at least portion of the polymer is solvated by the leachate and becomes entrapped in at least one of clay pores, at clay platelet edges, and between adjacent platelets.

### CROSS-REFERENCE TO RELATED APPLICATION

This application is a continuation-in-part of U.S. patent application Ser. No. 13/752,366, filed on Jan. 28, 2013, and published as U.S. Patent Application Publication No. US 2013/0196165 A1 on Aug. 1, 2013, which claims the benefit under 35 U.S.C. §119(e) of U.S. Provisional Patent Application No. 61/591,834, filed on Jan. 27, 2012; and the disclosure of both are hereby incorporated by reference in their entirety, expressly including any drawings.

### BACKGROUND

### Field of the Disclosure

The disclosure is directed to a hydraulic barrier and method of making the same. More particularly, the disclosure is directed to a hydraulic barrier containing polymer-clay granules and method of making the same, the hydraulic barrier being particularly suited for use in aggressive environments.

### BRIEF DESCRIPTION OF RELATED TECHNOLOGY

Hydraulic barriers are used in a number of industries for water absorption, containment, and/or retention. In a variety of industries, for example, the mining industry, the water source to be absorbed, contained, or retained is present in conditions that are incompatible with use of conventional clay-based barriers or even conventional clay and polymer dry mixtures containing barriers. Conventional barriers include, for example, geosynthetic clay liners (GCLs), which have a layer of clay, such as bentonite clay, supported by a geotextile or a geomembrane material, mechanically held together by needling, stitching, or chemical adhesives.

Conventional clay-based hydraulic barriers have shown to be ineffective or inefficient if the source has a high or low pH or contains a high concentrations of soluble salts, and in particular divalent ions. It is commonly known that bentonite clay swells well in fresh water, but poorly in water having drastic pH conditions (pH<3 or pH>10) and/or containing salts and/or metals, such as saltwater, seawater, acid mining drainage, and the like. In such environments, it may be necessary to sufficiently prehydrate a conventional bentonite clay-based hydraulic barriers with fresh water prior to use, which can be burdensome and cost prohibitive in a variety of applications.

It is also commonly known that bentonite-based hydraulic barriers can undergo ion exchange in situations where the liners are exposed to calcium rich leachates and allowed to undergo repeated wetting and drying cycles in certain conditions. Once the sodium bentonite inside the liner has been exchanged to a calcium bentonite, the swelling and gelling capacity is reduced and the hydraulic conductivity is increased. It is generally recommended that bentonite-based liners be used in scenarios that reduce the likelihood for desiccation for situations where the leachates are known to contain elevated calcium levels.

The hydraulic conductivity response of a granular bentonite-based GCL when exposed to a high pH leachate (pH>10) obtained from an aluminum leaching process has been investigated. The bauxite leachate had an ionic strength of 774 millimolar and a ratio of monovalent to multivalent cations (RMD)=1.15 M^{1/2}, with Al and Na being the predominant metals in solution. The hydraulic conductivity (k) of the GCLs was approximately 10⁻⁹ cm/s when permeated with tap water. When permeated with the highly caustic bauxite leachate, the granular bentonite based GCL became much more permeable, with a final hydraulic conductivity ranging between 4.2×10⁻⁷ cm/s and 1.8×10⁻⁶ cm/s.

Clay-polymer based hydraulic barriers such as those disclosed in U.S. Pat. No. 6,737,472 and U.S. Pat. No. 6,783,802 have been primarily developed with use of a water-absorbent polymer to facilitate and improve the retention of the clay within the hydraulic barrier mat material. For example, U.S. Pat. No. 6,783,802 describes a porous substrate, such as a geotextile liner having a polymerization initiator or polymerization catalyst embedded therein. The hydraulic barrier is formed by contacting this substrate with a monomer, cross-linking agent, and any other desired additives and subjecting it to conditions sufficient to polymerize the monomer within the substrate. The process results in improved retention of and embedding of the clay and polymer within the substrate material. In such a hydraulic barrier it can be preferable to have highly cross-linked polymers to ensure that the polymer remains retained and interlocked with the substrate during use. It was also believed that having such highly cross-linked polymers was necessary to ensure that the polymers were water insoluble and, therefore, would remain within the substrate during use.

### SUMMARY

The inventors have advantageously found that a long-term use hydraulic barrier having improved and substantially immediate impermeability in aggressive environments can be formed by providing a clay-polymer hydraulic barrier composition in which the polymer has a wide distribution of molecular weight, or in other words, a high polydispersity. This beneficially provides a hydraulic barrier that can be used in aggressive environments without the need for pre-hydration with fresh water. It has further been discovered that the performance characteristics of the hydraulic barrier can be tailored by adjusting various processing conditions in the method of forming the clay-polymer granules. The inventors have also advantageously found that a hydraulic barrier composition using a sulfonated water-solvatable polymer, specifically, a polymer formed from the monomer acrylamido-methyl-propane sulfonate (AMPS), works well in aggressive environments with, or without, a wide distribution of polymer molecular weights. These and additional advantages of the hydraulic barrier of the disclosure are described in detail below.

In accordance with an embodiment of the disclosure, a hydraulic barrier composition includes clay-polymer granules comprising a water-swellable clay and a polymer. In some embodiments, the polymer includes a cross-linked polymer portion and a linear polymer portion, wherein upon contact with an aqueous leachate at least a portion of the polymer is solvated by the leachate and at least a portion of the polymer becomes entrapped in at least one of pores of the clay, at clay platelet edges, and between adjacent clay platelets.

In accordance with other embodiments of the disclosure, a hydraulic barrier composition includes clay-polymer granules comprising a water-swellable clay and a polymer. In some embodiments, the polymer includes a cross-linked polymer portion and a mobile linear polymer portion. In some embodiments, the polymer includes a cross-linked polymer portion and a portion not part of a cross-linked polymer network which may be linear polymer, lightly branched polymer, or a combination thereof. In some embodiments, the composition has a hydraulic conductivity of 1×10⁻⁷ cm/sec or less when exposed to leachates having one or more of an ionic strength of 0.02 mol/liter to 3 mol/liter and a ratio of monovalent to divalent ions (RMD) value of less than 50 M^{1/2}.

In accordance with other embodiments of the disclosure, a hydraulic barrier composition includes clay-polymer granules comprising a water-swellable clay and a polymer, the polymer being a homopolymer of AMPS, a copolymer of AMPS and one or more other monomers, or a combination of a homopolymer of AMPS and a copolymer of AMPS. In some embodiments, the polymer includes a cross-linked polymer portion and a linear polymer portion. In some embodiments, the polymer includes a cross-linked polymer portion and a portion not part of a cross-linked polymer network which may be linear polymer, lightly branched polymer, or a combination thereof. In some embodiments, the cross-linked polymer portion is at least 80 weight % (wt %) of the polymer of the clay-polymer granules. In some embodiments, the polymer is a copolymer of AMPS and acrylic acid, acrylamide, or a combination thereof.

In accordance with other embodiments of the disclosure, a hydraulic barrier composition includes clay-polymer granules comprising a water-swellable clay and a sulfonated water-solvatable polymer. In some embodiments, the composition has a hydraulic conductivity of 1×10⁻⁷ cm/sec or less when exposed to leachates having a pH of less than 3 and an ionic strength of about 0.1 mol/liter to about 10 mol/liter.

In accordance with embodiments of the disclosure, a hydraulic barrier composition includes granules of a water-swellable clay containing a water-soluble polymer, a water-swellable polymer, or a polymer that is both water-soluble and water-swellable, capable of being activated by water, to enhance a water barrier property of the water-swellable clay, said granules forming a hydraulic barrier, wherein upon contact to dissolve, disperse, or both dissolve and disperse at least a portion of the polymer in the water the portion of the polymer becomes entrapped in at least one of clay pores, at clay platelet edges, and between adjacent platelets.

In accordance with embodiments of the disclosure, a hydraulic barrier includes granules comprising a water-swellable clay and a polymer system, the polymer system having an average molecular weight of about 300,000, as determined by size exclusion chromatography with a multi-angle laser light scattering detector, and a wide distribution of high and low molecular weight polymer chains such that at least a portion of the polymer dissolves or disperses rapidly in water upon contact of the granules with water and at least a portion of the high molecular weight polymer chains, once dissolved, dispersed, or both in water, become entrapped in at least one of clay pores, at clay platelet edges, and between adjacent platelets of the water-swellable clay.

In accordance with embodiments of the disclosure, a hydraulic barrier includes granules comprising a water-swellable clay and a polymer system, the polymer system having polymers with a linear and/or lightly-branched structure and capable of being activated by water such that the polymer dissolves, disperses, or both dissolves and disperses upon contact of the granules with water and at least a portion of the polymer becomes entrapped in at least one of clay pores, at clay platelet edges, and between adjacent platelets of the water-swellable clay.

In accordance with embodiments of the disclosure, a hydraulic barrier includes first granules comprising a water-swellable clay and a polymer, and second granules mixed with the first granules, the second granules comprising a water-swellable clay. The first granules are capable of being activated by water to form a hydraulic barrier, wherein upon contact of the first granules with water, the polymer dissolves, disperses, or both dissolves and disperses in water and at least a portion of the polymer becomes entrapped in pores and/or at clay platelet edges and/or between adjacent platelets of the water-swellable clay.

In accordance with other embodiments of the disclosure, a hydraulic barrier composition includes a polymer, the polymer being a homopolymer or copolymer of acrylamido-methyl-propane sulfonate (AMPS). In preferred embodiments, the constituent monomer(s) of the polymer of the hydraulic barrier composition are at least 25 mol % AMPS, at least 30 mol % AMPS, at least 40 mol % AMPS, at least 50 mol % AMPS, or at least 60% AMPS, and not more than 70% AMPS, not more than 75% AMPS, not more than 80% AMPS, not more than 85% AMPS, not more than 90% AMPS, or not more than 95% AMPS. In those embodiments in which the polymer includes a copolymer of AMPS, the other monomer(s) forming the copolymer with AMPS are acrylic acid, acrylamide, or a combination thereof. In some embodiments, the polymer is physically blended with clay or clay granules to form the hydraulic barrier composition. In some embodiments, the polymer and clay are combined to form granules, the granules including clay and polymer.

In accordance with an embodiment of the disclosure, a hydraulic barrier composition includes a physical blend of a water-swellable clay and a polymer. In some embodiments, the polymer includes a cross-linked polymer portion and a linear polymer portion, wherein upon contact with an aqueous leachate at least a portion of the polymer is solvated by the leachate and at least a portion of the polymer becomes entrapped in at least one of pores of the clay, at clay platelet edges, and between adjacent clay platelets. In some embodiments, the AMPS polymer includes a cross-linked polymer portion and a portion not part of a cross-linked polymer network which may be linear polymer, and/or lightly branched polymer. In some embodiments, the polymer of the physical blend of polymer and clay (and optional other materials) is of a size (diameter) range such that it passes through a 14 mesh sieve and is retained on an 80 mesh sieve (diameters ranging from about 1410 microns to about 177 microns), or it passes through a 35 mesh sieve and is retained on an 140 mesh sieve (diameters ranging from 105 microns to 500 microns), or it passes through a 120 mesh sieve and is retained on a 140 mesh sieve (diameters ranging from about 105 microns to about 125 microns). In some embodiments, the polymer of the physical blend is a polymer derived from AMPS, which may be a homopolymer, a copolymer, or a combination thereof. In some embodiments, the clay of the physical blend is a natural sodium bentonite clay with a size (diameter) range of approximately 500 microns to 2500 microns (as determined by sieving).

In accordance with further embodiments of the disclosure, a hydraulic barrier can include any of the hydraulic barrier compositions in accordance with the disclosure disposed in a sheet material.

In accordance with further embodiments of the disclosure, a hydraulic barrier can include any of the hydraulic barrier compositions in accordance with the disclosure disposed in a first sheet material and include a second sheet material attached to the first sheet material, with the hydraulic barrier composition being disposed between the first and second sheet materials.

In accordance with an embodiment of the disclosure, a method of containing a leachate includes disposing any one of the hydraulic barriers in accordance with the disclosure in contact with an aqueous leachate, wherein upon contact with the leachate the hydraulic barrier composition is activated to contain the leachate, and upon activation at least a portion the polymer of the clay-polymer granules is solvated and swollen by the leachate and at least a portion of the polymer becomes entrapped in at least one of the clay pores, at clay platelet edges, and between adjacent clay platelets.

In accordance with an embodiment of the disclosure, disposing any one of the hydraulic barriers in accordance with the disclosure in contact with an aqueous leachate where the hydraulic properties are retained such that the hydraulic conductivity as measured by ASTM 6766 does is less than 1×10⁻⁷ cm/sec on multiple wet/dry cycles (at least two wet then dry cycles) where the aqueous leachate has a predominance of multivalent cations (RMD value is <0.7 M^{1/2}, where M is molarity).

In accordance with an embodiment of the disclosure, a method of manufacturing a hydraulic barrier includes contacting a clay-containing slurry with a polymerization initiator, wherein the clay-containing slurry comprises water-swellable clay and a monomer; initiating polymerization of the clay-containing slurry and polymerization initiator under conditions sufficient to polymerize the monomer to form a clay-polymer mixture; and grinding the clay-polymer mixture into granules to form clay-polymer granules. The clay-polymer granules have a linear polymer component and a cross-linked polymer component.

In accordance with an embodiment of the disclosure, a method of manufacturing a hydraulic barrier includes forming a slurry of clay, water, and a polymerizable monomer and polymerizing the monomer in the slurry to form a clay/polymer mixture, and shearing the clay-polymer mixture into granules to form clay-polymer granules. Upon contact of the clay-polymer granules with water, the polymer dissolves, disperses, or both dissolves and disperses in the water and at least a portion of the polymer becomes entrapped in at least one of clay pores, at clay platelet edges, and between adjacent platelets of the water-swellable clay.

In accordance with an embodiment of the disclosure, a method of manufacturing a clay containing entrapped, water-soluble polymer molecules includes forming a slurry of clay, water, and a polymerizable monomer and polymerizing the monomer in the slurry to form a clay/polymer mixture, and grinding the clay-polymer mixture into granules to form clay-polymer granules, such that the average molecular weight of the polymer is reduced, and the water-solubility of the polymer is increased. The polymer, after grinding, has a wide distribution of high and low molecular weight polymer chains such that the polymer dissolves, disperses, or both dissolves and disperses rapidly in water upon contact of the granules with water and at least a portion of the high molecular weight polymer chains, once dissolved, dispersed, or both dissolved and dispersed in water, become entrapped in at least one of clay pores, at clay platelet edges, and between adjacent platelets of the water-swellable clay.

In accordance with an embodiment of the disclosure, a method of manufacturing a hydraulic barrier includes contacting a clay-containing slurry with a polymerization initiator, wherein the clay-containing slurry comprises clay and a monomer, heating the clay-containing slurry and polymerization initiator under conditions sufficient to polymerize the monomer to form a clay-polymer mixture, and grinding the clay-polymer mixture into granules to form clay-polymer granules. The polymerization conditions result in the polymers having linear, lightly-branched and cross-linked structure. The polymers are capable of being activated by water such that the polymer dissolves, disperses, or both dissolves and disperses upon contact of the granules with water and at least a portion of the polymer becomes entrapped in at least one of clay pores, at clay platelet edges, and between adjacent platelets of the water-swellable clay.

In accordance with an embodiment of the disclosure, a method of using a hydraulic barrier includes activating a hydraulic barrier comprising a water-swellable clay and a polymer by contacting the hydraulic barrier with water to dissolve, disperse, or both dissolve and disperse the polymer in water such that at least a portion of the polymer becomes entrapped in at least one of clay pores, at clay platelet edges, and between adjacent platelets of the water-swellable clay to form a substantially water-impermeable barrier.

In accordance with an embodiment of the disclosure, a method of separating higher molecular weight, water-soluble polymer molecules from lower molecular weight water-soluble polymer molecules includes forming a slurry of clay, water, a polymerizable monomer, an initiator, and optionally a crosslinker, and polymerizing the monomer in the slurry to form a clay/polymer mixture, shearing the clay-polymer mixture into granules to form clay-polymer granules, passing water through the clay-polymer granules resulting in lower molecular weight polymer molecules passing through the clay-polymer granules and higher molecular weight polymer molecules being entrapped in the clay.

### BRIEF DESCRIPTION OF THE DRAWINGS

FIG. 1 is a graph illustrating the RMD and ionic strength of various aggressive environments to clay-based hydraulic barriers

FIG. 2 is a graph illustrating the hydraulic conductivity as a function of permeate calcium chloride concentration for clay-polymer granules in accordance with an embodiment of the disclosure and conventional granular bentonite;

FIG. 3 is a graph illustrating the hydraulic conductivity as a function of percentage of clay-polymer granules for a mixture of granular bentonite and clay-polymer granules in accordance with an embodiment of the disclosure, permeated with a 50 mmol calcium chloride leachate;

FIG. 4A is a graph illustrating the permeability as a function of permate pH for clay-polymer granules in accordance with an embodiment of the disclosure and conventional granular bentonite;

FIG. 4B is a graph illustrating the permeability for clay-polymer granules in accordance with an embodiment of the disclosure and conventional granular bentonite in 500 mmol CaCl₂, 1M NaOH, 1M HNO₃.

FIG. 5A is a light scattering plot illustrating the polymer molecular weight distribution of an effluent collected after contacting a hydraulic barrier composition in accordance with an embodiment of the disclosure with water;

FIG. 5B is a scanning electron micrograph of the polymer effluent from the permeability experiments analyzed in FIG. 5A;

FIG. 6A are GPC refractive index and right-angle light scattering chromatograms and the log(molecular weight) vs. retention volume plot (calculated using light scattering analysis) of the influent in contact with a hydraulic barrier composition in accordance with an embodiment of the disclosure;

FIG. 6B is GPC refractive index and right-angle light scattering chromatograms and the log(molecular weight) vs. retention volume plot (calculated using light scattering analysis) of the effluent after passing through a hydraulic barrier composition in accordance with an embodiment of the disclosure;

FIG. 7 is a graph illustrating the concentration of polymer released from a control and clay-polymer granules in accordance with embodiments of the disclosure as tested using the elution test in 500 mmol CaCl₂;

FIG. 8 is a graph illustrating the concentration of polymer released from a control and clay-polymer granules in accordance with embodiments of the disclosure as tested using the elution test in a low pH leachate;

FIG. 9 is a graph illustrating the concentration of polymer released from a control and clay-polymer granules in accordance with embodiments of the disclosure as tested using the elution test in a high pH leachate;

FIG. 10 is a graph illustrating the concentration of polymer released from a control and clay-polymer granules in accordance with embodiments of the disclosure as tested using the elution test in deionized water;

FIG. 11 is a graph illustrating the permeability of a hydraulic barrier composition in accordance with an embodiment of the disclosure as compared to a hydraulic barrier containing bentonite clay in various leachates.

FIG. 12A is a schematic drawing of a hydraulic barrier having a layer of clay-polymer granules placed after (in the direction of fluid flow) a layer of granular clay;

FIG. 12B is a schematic drawing of a hydraulic barrier having a layer of clay-polymer granules placed before (in the direction of fluid flow) a layer of granular clay;

FIG. 13A is a schematic illustration of the structure of clay-polymer polymer granule in accordance with an embodiment of the disclosure;

FIG. 13B is a schematic illustration of the molecular structure of a clay-polymer composition in accordance with an embodiment of the disclosure;

FIG. 14 is a graph illustrating the hydraulic conductivity as a function of in-flow pore volumes for various clay-AMPS polymer granule types at various loadings needle punched into a GCL in accordance with an embodiment of the disclosure for the copper leachate;

FIG. 15 is a graph illustrating the hydraulic conductivity as a function of in-flow pore volumes for various clay-AMPS polymer granule types at various loadings needle punched into a GCL in accordance with an embodiment of the disclosure for the phosphogypsum leachate;

FIG. 16 is a graph illustrating the hydraulic conductivity as a function of in-flow pore volumes for various clay-AMPS polymer granule types at 8% AMPS granule loadings needle punched into a GCL in accordance with an embodiment of the disclosure for the vanadium leachate;

FIGS. 17, 18, and 19 are graphs illustrating the permeability as a function of electrical conductivity in accordance with embodiments of the disclosure with 4 wt %, 6 wt %, and 8 wt % polymer loading in the GCL;

FIG. 20 is a graph illustrating the permeability of a GCL as a function of electrical conductivity for P4/clay blends comparing different polymer loadings at 4 wt %, 6 wt % and 8 wt % P4 system in accordance with the embodiments of the disclosure;

FIG. 21 is a graph illustrating the effect of the monomer to cross-linking agent molar ratio of the polymer on the hydraulic conductivity for GCLs prepared with 8 wt % AMPS polymer systems mixed with clay;

FIG. 22 is a graph illustrating the effect of the monomer to cross-linking agent molar ratio on the free swell of various AMPS polymer (P1-P4) and the STOCKSORB® systems in deionized water;

FIG. 23 is a graph illustrating the free swell of various polymer systems as a function of the electrical conductivity of the various leachates.

FIG. 24 is a graph illustrating the permeability of GCL samples prepared with 8 wt % of the various AMPS systems (P1-P4) as a function of free swell for the various AMPS systems in accordance with the embodiments of the disclosure;

FIG. 25 is a chart illustrating the influence of clay filler size on the hydraulic conductivity of GCLS samples prepared with 8 wt % P2-system blended into clay of different particle sizes.

FIG. 26 is a chart illustrating the influence of P2 polymer diameter and particle size distribution on the hydraulic conductivity vs pore volume flow against leachate B for GCL systems with 8 wt % polymer.

FIG. 27 is a chart illustrating the hydraulic conductivity as a function of polymer average particle diameter for the fractionated polymer size ranges.

### DETAILED DESCRIPTION

Use of the singular herein, including the claims, includes the plural and vice versa unless expressly stated to be otherwise. That is, “a” and “the” refer to one or more of whatever the word modifies. For example, “a polymer” may refer to one polymer, two polymer, etc. Likewise, “the barrier” may refer to one, two or more barriers, and “the polymer” may mean one polymer or a plurality of polymers. By the same token, words such as, without limitation, “barriers” and “polymers” would refer to one barrier or polymer as well as to a plurality of barriers or polymers unless it is expressly stated that such is not intended.

As used herein, unless specifically defined otherwise, any words of approximation such as without limitation, “about,” “essentially,” “substantially,” and the like mean that the element so modified need not be exactly what is described but can vary from the description. The extent to which the description may vary will depend on how great a change can be instituted and have one of ordinary skill in the art recognize the modified version as still having the properties, characteristics and capabilities of the unmodified word or phrase. With the preceding discussion in mind, a numerical value herein that is modified by a word of approximation may vary from the stated value by ±15% in some embodiments, by ±10% in some embodiments, by ±5% in some embodiments, or in some embodiments, may be within the 95% confidence interval. For example, the term “consisting essentially of” may be 85%-100% in some embodiments, may be 90%-100% in some embodiments, or may be 95%-100% in some embodiments. In addition, when values are expressed as approximations by use of the antecedent “about,” “essentially,” or “substantially,” it will be understood that the particular value forms another embodiment.

As used herein, any ranges presented are inclusive of the end-points. For example, “a temperature between 10° C. and 30° C.” or “a temperature from 10° C. to 30° C.” includes 10° C. and 30° C., as well as any temperature in between. In addition, throughout this disclosure, various aspects of this invention may be presented in a range format. The description in range format is merely for convenience and brevity and should not be construed as an inflexible limitation on the scope of the invention. Accordingly, the description of a range should be considered to have specifically disclosed all the possible subranges as well as individual numerical values, both integers and fractions, within that range. As an example, a description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. Unless expressly indicated, or from the context clearly limited to integers, a description of a range such as from 1 to 6 should be considered to have specifically disclosed subranges 1.5 to 5.5, etc., and individual values such as 3.25, etc. This applies regardless of the breadth of the range. In addition, ranges may be expressed herein as from “about” or “approximately” one particular value and/or to “about” or “approximately” another particular value. When such a range is expressed, another embodiment includes from one particular value and/or to the other particular value. Similarly when values are expressed as approximations by use of the antecedent “about,” it will be understood that the particular value forms another embodiment.

As used herein, a “polymer” refers to a molecule comprised of, actually or conceptually, repeating “constitutional units.” The constitutional units derive from the reaction of monomers. As a non-limiting example, ethylene (CH₂═CH₂) is a monomer that can be polymerized to form polyethylene, CH₃CH₂(CH₂CH₂)—CH₂CH₃ (where n is a positive integer), wherein the constitutional unit is —CH₂CH₂—, ethylene having lost the double bond as the result of the polymerization reaction. A polymer may be derived from the polymerization of two or more different monomers and therefore may comprise two or more different constitutional units. Such polymers are referred to as “copolymers.” “Terpolymers” are a subset of “copolymers” in which there are three different constitutional units. The constitutional units themselves can be the product of the reactions of other compounds. Those skilled in the art, given a particular polymer, will readily recognize the constitutional units of that polymer and will equally readily recognize the structure of the monomer or materials from which the constitutional units derive. Polymers may be straight or branched chain, star-like or dendritic, or one polymer may be attached (grafted) onto another. Polymers may have a random disposition of constitutional units along the chain, the constitutional units may be present as discrete blocks, or constitutional units may be so disposed as to form gradients of concentration along the polymer chain. Polymers may be cross-linked to form a network.

As used herein, a polymer has a chain length of 20 constitutional units or more, and those compounds with a chain length of fewer than 20 constitutional units are referred to as “oligomers.”

In some embodiments, “molecular weight” refers to the molecular weight of individual segments, blocks, or polymer chains, and in some embodiments, the term “molecular weight” refers to weight average molecular weight, the number average molecular weight, or other average molecular weight, of types of segments, blocks, or polymer chains.

With respect to polymers, the number average molecular weight (Mₙ) is the common, mean, or average of the molecular weights of the individual segments, blocks, or polymer chains. It is determined by measuring the molecular weight of N polymer molecules, summing the weights, and dividing by N:

$${M}_{n} = \frac{{\sum }_{i}^{ } {N}_{i} {M}_{i}}{{\sum }_{i}^{ } {N}_{i}}$$

where Nᵢ is the number of polymer molecules with molecular weight Mᵢ. The weight average molecular weight is given by:

$${M}_{w} = \frac{{\sum }_{i}^{ } {N}_{i} {M}_{i}^{2}}{{\sum }_{i}^{ } {N}_{i} {M}_{i}}$$

where Nᵢ is the number of molecules of molecular weight Mᵢ. Another commonly used molecular weight average is the viscosity average molecular weight which may be expressed as Mᵥ=[ΣᵢNᵢMᵢ^{1+a})/(ΣᵢNᵢMᵢ)]^{1/a} where a is typically less than 1. Less commonly used are the z average molecular weight or higher molecular weights, which are calculated as M_{z}=[(Σᵢ NᵢMᵢ^{b+1})/(ΣᵢNᵢMᵢ^{b})] where b=2 for M_{z}, and b=3 for M_{z+1}.

As used herein, the polydispersity for a polymer is typically the ratio of M_{w}/Mₙ.

As used herein, unless specified otherwise, a mesh size refers to the U.S. standard mesh size.

As used herein, unless specified otherwise, wt % and wt. % refer to percent (%) by weight.

Disclosed herein is a hydraulic barrier suitable for use in a variety of environments, including in aggressive environments, in which clay-based barriers are typically less effective due to the inability of the clay to swell rapidly in such conditions. As used herein “aggressive environment” refers to a system in which water absorption, retention or containment is desired, having a high or low pH, a high ionic strength, a high concentration of divalent and/or multivalent ions, or any combination of two or more of the preceding. In some embodiments, aggressive environments include water systems having high pH, such as and without limitation, a pH of 10 or greater, or having a low pH, such as and without limitation, a pH of 3 or less. Aggressive environments include water systems having a high ionic strength, such as and without limitation, an ionic strength greater than 10 mol dm⁻³. The ionic strength (I), expressed as mol dm⁻³, is a function of the concentration of all ions present in that solution and is calculated by Formula 1, below:

$$I = \frac{1}{2} \sum {C}_{i} {Z}_{i}^{2} , \qquad Formula 1$$

wherein Cᵢ is a molar concentration of i^{th} ion present in the solution and zᵢ is its charge. In some embodiments, aggressive environments include water systems having a high ionic strength, as defined above, in conjunction with a high or a low pH, as defined above.

In some embodiments, aggressive environments are water systems having high concentrations of divalent and/or multivalent ions, where the concentration of divalent and/or multivalent ions is defined by an RMD value. The RMD value is the ratio of monovalent to divalent (or multivalent ions). The RMD of the solution, expressed as the square route molarity, can be calculated by the equation below, where M_{M} and M_{D} are the total molarity of monovalent and divalent cations in the solution respectively. The RMD of the solution, expressed as the square route molarity, can be calculated by Formula 2, below:

$$RMD = \frac{{M}_{M}}{\sqrt{{M}_{D}}} , \qquad Formula 2$$

wherein M_{M} and M_{D} are the total molarity of monovalent and divalent cations in the solution respectively. In some embodiments, aggressive environments include water systems having low RMD values, such as and without limitation, less than 0.7, especially less than 0.5 and particularly less than 0.1. Divalent and other multivalent ions bridge the platelets of a clay, preventing the clay from swelling and forming a hydraulic barrier. Thus, in environments having low RMD values, clay barriers cannot properly function without prehydration to swell the clay. Should the clay eventually dry out during use, the barrier would become significantly more permeable and the clay would not reswell due to the effects of the water having a high concentration of divalent or multivalent ions.

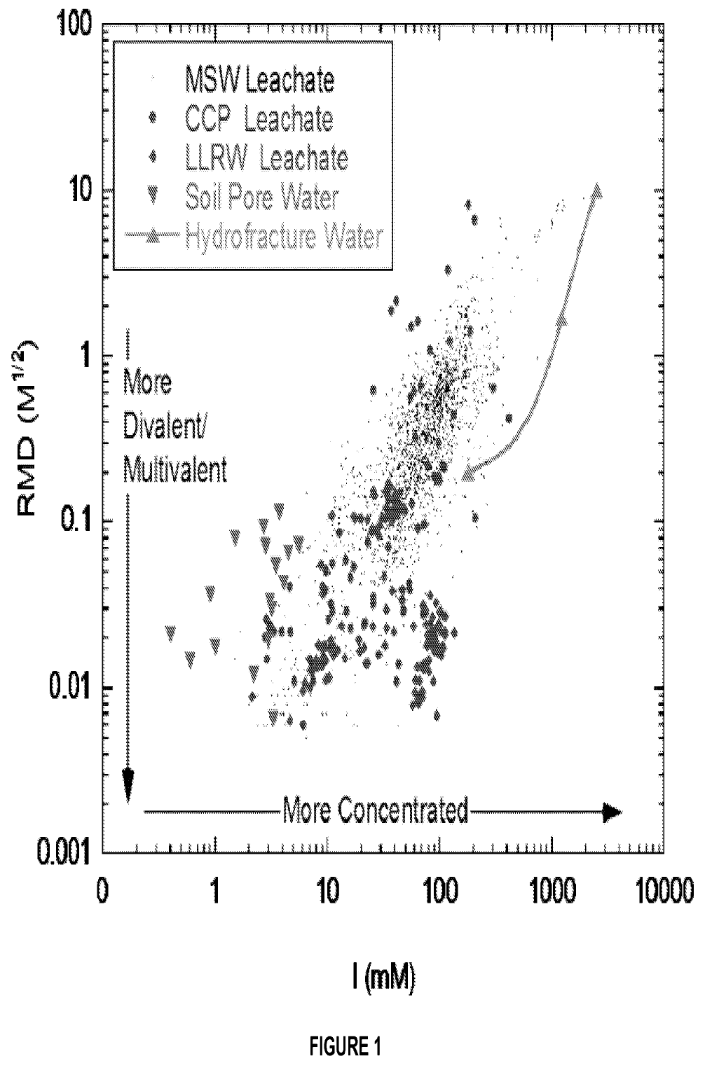

In some embodiments, the aggressive environment includes high concentrations of calcium chloride, such as and without limitation, calcium chloride concentrations of 50 mmol or greater. In some embodiments, the aggressive environment has a calcium chloride concentration, such as and without limitation, of 50 mmol or greater, 100 mmol or greater, 150 mmol or greater, 200 mmol or greater, 250 mmol or greater, 300 mmol or greater, 350 mmol or greater, 400 mmol or greater, 450 mmol or greater, and 500 mmol or greater. FIG. 1 graphically illustrates the RMD and ionic strength of various aggressive environments as compared to soil pore water (a generally non-aggressive environment). As shown in FIG. 1, municipal solid waste (MSW) presents an aggressive environment to clay-based barriers in that it generally has an ionic strength of about 100 mM. Low level radioactive waste (LLRW) also presents an aggressive environment to clay-based barriers as it has an RMD value of less than 0.5. Coal Combustion Products (CCP) is yet another aggressive environment for clay-based barriers, having high ionic strength and low RMD values. Hydrofracture water is an example of an aggressive environment having high ionic strength. In some embodiments, the hydraulic barriers of the disclosure are used as barrier liner for mining waste or capping liners for mining waste, non-limiting examples of which include calcium chloride, hydrochloric acid, sulfuric acid, cyanide salts, and can be caustic for example, sodium hydroxide.

Hydraulic barriers in accordance with embodiments of the disclosure provide reduced permeability (improved performance) to a leachate per unit weight of hydraulic barrier as compared to conventional liners or hydraulic barriers such as geosynthetic clay liners (GCLs) and as compared to polymer only containing hydraulic barrier, at least in aggressive environments. In some embodiments, hydraulic barriers in accordance with embodiments of the disclosure have a hydraulic conductivity in aggressive environments of 1×10⁻⁷ cm/sec or less, such as and without limitation, 1×10¹⁰ cm/sec or less. As used herein, the terms “permeability” and “hydraulic conductivity” are used interchangeably. In some embodiments, aggressive environments include an RMD value of less than about 50 M^{1/2} and/or an ionic strength of about 0.02 mol/liter to about 3 mol/liter, or about 0.5 mol/liter to about 1.2 mol/liter. In some embodiments, the leachates have an RMD value of less than about 50, 40, 30, 20, 10, or 5 M^{1/2}. In some embodiments, the aggressive leachate has an ionic strength, for example, of about 0.2 mol/liter to about 2.8 mol/liter, about 0.3 mol/liter to about 2.7 mol/liter, about 0.4 mol/liter to about 2.5 mol/liter, about 0.5 mol/liter to about 2.3 mol/liter, about 0.7 mol/liter to about 2.1 mol/liter, about 0.9 mol/liter to about 1.9 mol/liter, about 1 mol/liter to about 1.7 mol/liter, about 1.3 mol/liter to about 1.5 mol/liter. In some embodiments, the leachates have an ionic strength of about 0.3, 0.4, 0.5, 0.6, 0.7, 0.8, 0.9, 1, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9., and 3 mol/liter. The hydraulic barriers of the disclosure are also suitable for non-aggressive environments.

The hydraulic barriers in accordance with embodiments of the disclosure are used for geo-environmental applications such as water (or leachate) absorption, water (or leachate) retention, and water (or leachate) containment, and particularly in such industries in which the water (or leachate) is present in an aggressive environment, such as, for example, in mining and/or gold extraction operations. For example, the hydraulic barriers in accordance with embodiments of the disclosure may have particular use in landfill caps, fraq water storage ponds, coal ash containment ponds, low pH heap leach pads, high-pH mine solutions, and waters containing elevated salt levels (chlorides, sulfates). The hydraulic barrier in accordance with embodiments of the disclosure can also be useful in below grade water proofing, such as underground parking garages, shopping malls, and the like to prevent ground water intrusion; waste landfills; man-made bodies of water; and other geo-environmental applications where a low-permeability hydraulic barrier is needed. In general, the hydraulic barriers of the disclosure can be disposed in contact with a leachate or in a region suspected to be in contact with a leachate to thereby contain the leachate.

A hydraulic barrier composition in accordance with embodiments of the disclosure includes granules containing a water-swellable clay and a polymer that is activated by water. As used herein, “granules” refers to particles of a powder or granulation. The range of the size (diameter) granules can be from about 50 microns (4 mesh) to about 4760 microns (200 mesh) where those retained on the 4 mesh screen and those passing through the 200 mesh screen are not used or not used without further size reduction. Preferably in the diameter is in range of 250-600 microns as determined by a sieve analysis where those under or over the range are removed by sieving. In some embodiments, the granules have an average diameter of about 500 microns or greater as determined by sieve analysis. In some embodiments, a sieve analysis encompasses determining the weight (mass) of particles of a given same sample retained on each screen, where a distribution is determined by the weight percent of the total sample retained on each sieve (and passing through the sieve size above).

In some embodiments, the granules are advantageously activated rapidly by contact with water, including water present in aggressive environments. For example, when the granules are contacted with water, at least a portion of the polymer rapidly dissolves or disperses in water to provide a more immediate hydraulic barrier response, at least as compared to conventional clay-based systems in aggressive environments. In some embodiments, the polymer is a water-soluble or water-dispersible polymer that is activated by water by dissolving or dispersing when contacted with water. In some embodiments, the polymer has a wide distribution of high and low molecular weights, and generally has a low molecular weight component (also referred to herein as “low molecular weight polymer chains”) and a high molecular weight component (also referred to herein as “high molecular weight polymer chains”). As used herein, low molecular weight polymer chains may also include oligomers. Without intending to be bound by theory, it is believed that a portion of the polymer initially and rapidly (at least as compared to the high molecular weight polymer component) is solvated by the aqueous leachate upon contact with the leachate to provide a temporary barrier that allows sufficient time for the larger molecular weight portion to activate. It is believed that the low molecular weight polymer chains and/or oligomers, which are more water soluble by virtue of their lower molecular weight, dissolve and disperse upon contact with water and travel through and become temporarily entrapped in the clay pores, around clay platelets at clay platelet edges, and/or between adjacent platelets, temporarily blocking water or other leachate from traveling through the hydraulic barrier. It is further theorized that the polymer produced by the polymerization in the presence of clay may have a greater activity than polymers produced by traditional methods. The low molecular weight polymer may also interact with other low molecular weight polymers or high molecular weight polymers to form covalent or non-covalent bonds to further promote entrapment or clogging.

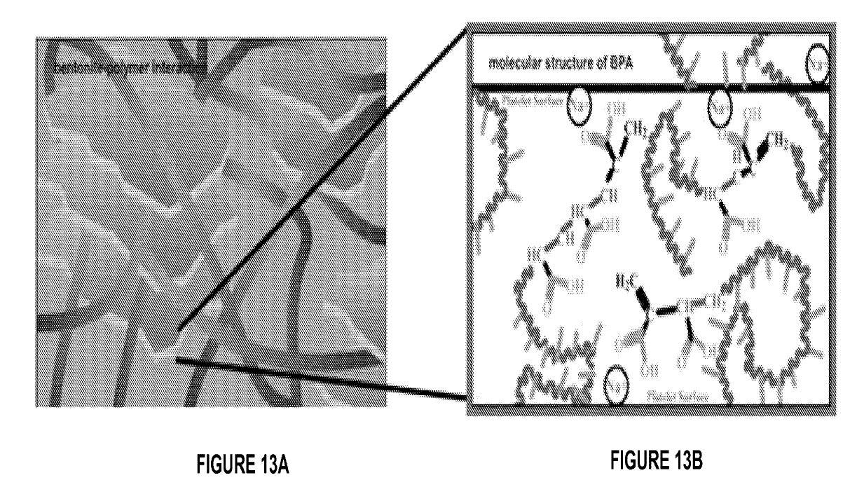

This temporary blocking is particularly advantageous in aggressive environments because the clay cannot swell to prevent passage of water in such environments. While the low molecular weight polymer chains may only be temporarily trapped in the clay pores, at the edges of the clay platelets, and/or between clay platelets, this initial response provided by the low molecular weight polymer chains provide sufficient time for the high molecular weight polymer chains to dissolve or disperse in water and become entrapped in the clay pore, at the edges of the clay platelets, between clay platelets, and any other such water passageways of the hydraulic barrier, thereby providing a more permanent and long-lasting hydraulic barrier. A schematic illustration of the polymer-clay interaction and the molecular structure of clay-polymer granules in accordance with the invention are provided at FIG. 13.

Another possibility is that the linear or lightly branched (or cross-linked) polymers may form covalent or non-covalent bonds with the clay promoting entrapment. In calcium-rich and other multivalent-rich environments, for example, it is believed that the polymer chains that initially dissolve and disperse upon contact with water, cross-link and associate with the calcium or other multivalent ions. It is believed that ionic crosslinking in the presence of multivalent ions, such as calcium, results in formation of a gel that coats the clay platelets and blocks clay pores, thereby improving the barrier properties of the hydraulic barrier. It is believed that in some embodiments, the polymer also functions to reduce the concentration of the divalent and other multivalent ions in the system, which may otherwise bridge clay platelets and prevent the clay from swelling. Thus, in some aggressive environments, it is believed that the polymer improves the ability of the clay to swell by withdrawing at least some of the divalent or multivalent ions from the system. It is believed that the polymer also helps functionality by absorbing the aggressive leachate and improving the swell of the system. Accordingly, the hydraulic barrier of some embodiments of the disclosure advantageously provides a barrier that can be used in aggressive environments without the need to pre-swell the clay by pre-hydrating with fresh water.

It is further believed that the polymer at least partially coats and protects the clay platelets, thereby allowing for use of the clay-based granules in environments typically harmful and/or destructive to clay. It is believed that, upon activation, the polymer protects the clay platelets from harmful exfoliation when exposed to acidic environments.

In some embodiments, the hydraulic barrier composition further include fillers, such as but not limited to, granulated water-swellable clay mixed with the clay-polymer granules. In some embodiments, the mixture includes at least 0.5 weight percent (wt. %) of the clay-polymer granules based on the total weight of the mixture. In some embodiments, the advantages of the clay-polymer granules, including resistance and impermeability to aggressive environments, are achieved with the mixture. In such a hydraulic barrier, the clay-polymer granules represent a significantly more expensive component, particularly when compared to granulated water-swellable clay. Thus, the mixture beneficially allows for production of a hydraulic barrier for aggressive environments at lower cost. In some embodiments, the delivery of the polymer blend predispersed in a clay-polymer granule also helps to match the specific gravity of the clay if the product is to be blended, which can prevent segregation in handling equipment and help to maintain a consistent distribution of the polymer in the blend.

### Water-Swellable Clay

In some embodiments, the water-swellable clay of the clay-polymer granules and/or the granulated clay or used in a physical blend is a water-swellable smectite clay. Examples of suitable water-swellable clays include, but are not limited to, montmorillonite, saponite, nontronite, laponite, beidellite, iron-saponite, hectorite, sauconnite, stevensite, vermiculite, and mixtures thereof. In some embodiments, the clay is a smectite clay, such as, and without limitations, sodium smectite clay, calcium smectite clay, sodium activated smectite clay, and preferably sodium montmorillonite and sodium bentonite.

In some embodiments, the clay is about 10 wt % to about 99 wt % or 20% to 98% based on the totally weight of the granules. Other suitable ranges include about 15 wt % to about 85 wt %, about 20 wt % to about 80 wt %, about 30 wt % to about 70 wt %, about 40 wt % to about 60 wt %, and about 20 wt % to about 50 wt %. In some embodiments, the clay includes about 10, 15, 20, 24, 30, 35, 40, 45, 50, 55, 60, 65, 70, 75, 80, 85, 90, or 99 wt % based on the total weight of the granules.

In some embodiments, other non-water-swellable clays or fillers are also added to the granules and/or are added to the hydraulic barrier composition separately. In some embodiments, filler granules are added to the composition. Non-limiting examples of such clays and fillers are calcium carbonate, talc, mica, vermiculite, acid activated clays (where a hydrogen ion has replaced the sodium), kaolin, silicon dioxide, titanium dioxide, calcium silicate, calcium phosphate, alumina, fly-ash, silicon carbide, lignite, silica sand, recycled glass, calcium sulfate, cement and mixtures thereof. In some embodiments, these clays and fillers are added in any suitable amount such that the hydraulic barrier composition comprises at least 0.5 wt %, at least 1 wt %, at least 2 wt % of the clay-polymer granules. In some embodiments, the hydraulic barrier composition includes 100 wt % clay-polymer granules, 90 wt % clay-polymer granules, or 80 wt % clay-polymer granules. In some embodiments, the hydraulic barrier composition comprises at least 0.5 wt % and not more than 25 wt % clay-polymer granules.

### Polymer

In some embodiments, the polymer of the polymer-clay granules or generally has a linear or a lightly-branched structure. In some embodiments, the granules include a polymer system having a cross-linked polymer portion and a portion that is non-crosslinked. In some embodiments, the non-cross-linked portion, that is the polymer not forming a polymer network, is linear, while in other embodiments the non-cross-linked portion is lightly branched polymer, and in still other embodiments, the non-cross-linked portion is a combination of linear and lightly branched polymers. In other embodiments, the polymer is substantially cross-linked, that is at least 80 wt %, at least 85 wt %, or at least 90 wt % of the polymer present in the granules is part of a polymer network. In some embodiments, the polymer system of the granules has a wide molecular weight distribution that includes both high molecular weight polymer and low molecular weight polymer. High molecular weight polymer includes cross-linked polymer. In some embodiments, the average molecular weight of the polymer system of the granules is about 300,000 g/mol as determined by size exclusion chromatography in conjunction with a multi-angle laser light scattering detector (SEC-MALLS). In some embodiments in which the polymer has a low molecular weight portion, the low molecular weight polymer has a sufficiently low molecular weight to activate quickly in water, for example, by dissolving or dispersing in the water, upon contact with water. It is believed that once dissolved or dispersed, the chains of the low molecular weight polymer become temporarily entrapped in the clay pores, at the edges of the clay platelets, and between clay platelets to provide the hydraulic barrier with an initial impermeability to water. In some embodiments in which the polymer has a low molecular weight portion, the chains of the low molecular weight polymer, however, have a sufficiently low molecular weight such that ultimately these polymer chains flow through the clay. In some embodiments in which the polymer has a low molecular weight portion, the low molecular weight polymer has an average molecular weight, for example, of about 6×10⁵ g/mol or less as determined by SEC-MALLS. Other molecular weights may be suitable so long as the low molecular weight polymer activates upon contact with water such that the low molecular weight polymer component quickly dissolves or disperses in water and may ultimately pass between hydrated clay granules. In some embodiments in which the polymer has a low molecular weight portion, the clay-polymer granules have low molecular weight components such that at least 5 wt % of the polymer of the polymer granules passes out of the granule after about 24 hrs. Additionally, in some embodiments, some of the low molecular weight polymers are also capable of interacting with other polymer chains through covalent or non-covalent bond formation to retard their passage between the hydrated clay granules.

While the impermeability provided by the low molecular weight polymer may be temporary, it is substantially simultaneous with contact of the hydraulic barrier with water and provides sufficient time for the high molecular weight polymer to dissolve or disperse in the water and become entrapped in the clay pores, about and between the clay platelets, and any other water passages ways of the hydraulic barrier to provide a permanent hydraulic barrier having low permeability even in aggressive environments. In some embodiments, the high molecular weight polymer has a sufficiently high molecular weight such that they are entrapped by the clay and do not pass through as an effluent. In some embodiments, the high molecular weight polymer has an average molecular weight about equal to or greater than 6×10⁵ g/mol as determined by SEC-MALLS. In some embodiments, the high molecular weight polymer chains may have a molecular weight in a range of about 6×10⁵ g/mol to about 1×10⁷ g/mol as determined by SEC-MALLS.

In some embodiments, the polymer is formed from any organic monomer(s) able to be polymerized to provide a water-soluble or water-dispersible polymer. In some embodiments, the organic monomer is of the following structural formula:

H₂C═CH—(C═O)—O—R,

wherein R is selected from the group consisting of an alkali metal, H, CH₃, CH₂, CH₃, CH(CH₃)₂, and mixtures thereof. In some embodiments, the monomer is selected from the group consisting of acrylic acid, acrylamide, an alkali metal acrylate, such as sodium acrylate, or other functional monomers such as glycols, amines, alcohols, and organic salts, and mixtures thereof. Other non-limiting examples of suitable monomers, include alkylacrylamides, methacrylamides, styrenes, allylamines, allylammonium, diallylamines, diallylammoniums, alkylacrylates, methacrylates, acrylates, n-vinyl formamide, vinyl ethers, vinyl sulfonate, acrylic acid, sulfobetaines, carboxybetaines, phosphobetaines, and maleic anhydride, and mixtures thereof. The monomers may be used individually, forming a homopolymer, or in combination, forming a copolymer. Blends of polymers may be used. In some embodiments, the mixtures include 50-90 mole percent of an alkali metal acrylate and 10-50 mole percent acrylic acid, or 65-85 mole percent of an alkali metal acrylate and 15-35 mole percent acrylic acid, based on the total moles of polymerizable acrylic acid monomer.

In various embodiments, the polymer includes a sulfonated water-soluble polymer. In some embodiments, the polymer includes a homopolymer or copolymer of acrylamido-methyl-propane sulfonate (AMPS). In some embodiments, the polymer of the clay-polymer granules is a copolymer of which the constituent monomers are at least 25 mol % AMPS, at least 30 mol % AMPS, at least 40 mol % AMPS, at least 50 mol % AMPS, or at least 60% AMPS, and not more than 70% AMPS, not more than 75% AMPS, not more than 80% AMPS, not more than 85% AMPS, not more than 90% AMPS, or not more than 95% AMPS. The mol % of the constituent monomer(s) of the polymer encompasses the mol % AMPS contributed from one or more polymers from a blend of polymers, the mol % AMPS of one or more copolymers, and combinations thereof. In those embodiments in which the polymer includes a copolymer of AMPS, the one or more other monomers are selected from those organic monomers above. In some embodiments, the other monomer(s) forming the copolymer of AMPS are acrylic acid, acrylamide, or a combination thereof. In particular, it is preferred that the content of the AMPS monomer (on a mole percent basis) is greater than 25% relative to the other monomers such as acrylamide or acrylic acid (or combinations thereof). Even more preferred is an AMPS content greater than 50% relative to the other monomers such as acrylamide or acrylic acid (or combinations thereof). Embodiments of the disclosure in which the hydraulic barrier composition contains a sulfonated water-soluble polymer are advantageously suitable for containing leachates having a pH of less than 1.5 and an ionic strength of about 0.1 mol/liter to about 10 mol/liter. Such embodiments are also suitable for containing other aggressive leachates, as described above. Clay-polymer granules containing an AMPS polymer advantageously and unexpectedly demonstrate good free swell, with low fluid loss when exposed to aggressive leachates, such as a nickel leachate

### Method of Making the Hydraulic Barrier Composition

In some embodiments, a method of forming a hydraulic barrier composition in accordance with embodiments of the disclosure includes forming a polymerizable mixture or slurry by mixing clay and an organic monomer. In some embodiments, the mixture further includes a cross-linking agent, a neutralizing agent, an inhibitor, an additional additive, or any combination thereof. In some embodiments, a polymerization initiator or polymerization catalyst is then added to the polymerizable mixture. In some embodiments, the resulting mixture is then subjected to conditions sufficient to completely polymerize the monomer and form a polymerized cake of material (a clay-polymer composite). In some embodiments, the resulting product is then granulated or crushed into a granular or powder to form the clay-polymer granules. Any known granulation or powder forming methods may be used to process the polymerized cake (clay-polymer composite) into the clay-polymer granules.

In various embodiments, the monomer is polymerized in the presence of a cross-linking agent. Any cross-linking agent compatible with the organic monomer and capable of, and suitable for, cross-linking the organic monomer may be used. In some embodiments, the cross-linking agent is phenol formaldehyde, terephthaladehyde, N,N′-methylenebisacrylamide (MBA), or any mixture thereof. In specific embodiments, the cross-linked polymer systems can include homopolymers of AMPS with various amounts of cross-linker such as N,N′-methylenebisacrylamide (MBA). In other specific embodiments, cross-linked polymer systems can include copolymers of AMPS with either acrylamide or acrylic acid (or combinations thereof) with various amounts of cross-linker such as N,N′-methylenebisacrylamide (MBA).

Any amount of the cross-linking agent or any ratio of the cross-linker to the monomer sufficient to cross-link the monomer to the desired degree may be used. In some embodiments, the monomer is polymerized without the use of a cross-linking agent. The amount or ratio of cross-linking agent use will vary depending upon, among other factors, the desired characteristics or properties of the hydraulic barrier, including its water-absorbing capacity and its ability to rapidly activate in the presence of water. For example, it has been found that as the ratio of the cross-linking agent to the monomer is increased, the availability of free water soluble polymer decreases. Additionally, the water solubility of the resulting absorbent polymer and the water absorbing capacity of the absorbent polymer tend to decrease. In some embodiments, a sufficient amount of cross-linker may be needed to provide the desired molecular weight distribution and the desired portion of high molecular weight polymer chains. In some embodiments, the sufficient amount of cross-linker is a molar ratio of cross-linking agent to monomer from about 1:100 to about 1:2000. The amount of cross-linking agent can be used as one factor for tailoring the desired response of the resulting hydraulic barrier. In some embodiments, the molar ratio of cross-linking agent to monomer is about 1:100 to about 1:2000, about 1:500 to about 1:2000, about 1:700 to about 1:1800, about 1:800 to about 1:1600, about 1:900 to about 1:1400, or about 1:1000 to about 1:1500. In some embodiments, the amount of cross-linker is in the range of 1500 to 4500 to obtain a free swell using 2 grams of granulated polymer in 100 mL of leachate of at least 30 mL in leachates with an electrical conductivity of greater than approximately 2000 μS/cm. In some embodiments, the amount of cross-linker is in the range of 1500 to 4500 to obtain a free swell using 2 grams of granulated polymer in 100 mL of leachate of at least 30 mL in leachates with a pH of less than 2.7 or greater than 11.5. In some embodiments, the amount of cross-linker is in the range of 1500 to 4500 to obtain a free swell using 2 grams of granulated polymer in 100 mL of leachate of at least 30 mL in leachates with an RMD of less than 0.1 M^{1/2}. In specific embodiments, the amount of cross-linker is in the range of 1500 to 4500 to obtain a free swell using 2 grams of granulated polymer in 100 mL of leachate of at least 30 mL in leachates with an RMD of less than 0.1 M^{1/2} after repeated wet/dry cycling in that leachate, where a wet/dry cycle is hydration for 24 hours, followed by drying to a maximum of 40% moisture content as measured according to the methods outlined in ASTM D2216 Standard Test Method for Laboratory Determination of Moisture Content of Soil and Rock.

In some embodiments, methods of forming the clay-polymer granules include mixing the organic monomer with water and a neutralizing agent, such as, and without limitation, sodium hydroxide. In some embodiments, the organic monomer, water, and neutralizing agent are mixed prior to the addition of the clay to form a polymerization solution in order to more easily effect neutralization of at least a portion of the polymerizable organic monomer or monomers. In some embodiments, about 65-85 mole percent of the organic monomer is neutralized before clay addition. Preferably, a cross-linking agent is also added. In some embodiments, the organic monomer, water, neutralizing agent, and cross-linking agent are mixed to form a homogenous or substantially homogenous polymerization solution prior to adding the clay to from the polymerizable mixture. By forming such a homogenous or substantially homogenous polymerization solution prior to addition of the clay, it may be possible to obtain improved consistency and homogeneity in intercalation of the clay. However, in some embodiments, the clay is added without forming such a homogenous or substantially homogenous mixture.

The clay can be added to the polymerization solution to form the polymerizable mixture in any manner. In various embodiments, the polymerization mixture containing the clay is sheared during mixing, which can intercalate a portion of the organic monomer between clay platelets to partially exfoliate the clay platelets prior to, or simultaneously with, polymerization.

In general, the degree of mixing of the polymerizable mixture depends upon the desired characteristics of the resulting mixture. In some embodiments, the clay is simply combined together with the polymerization monomer, initiator, and optional additives, without regard for the degree of mixing or homogeneity of the resulting mixture. In various embodiments, however, the mixture is mixed to form a substantially homogenous or homogenous mixture.

Any mixer and any mixing method may be used which are capable of mixing the clay and the monomer to achieve the desired characteristics of the slurry. The mixing step may be performed for any period or length of time sufficient to achieve the desired characteristics of the slurry. In some embodiments, the mixing step may be performed for a sufficient length of time to mix the clay and the polymerizable solution such that the resulting mixture is homogenous or substantially homogenous. In some embodiments, a sufficient length of time is from 5 minutes to 12 hours.

In some embodiments, the monomer is polymerized using a polymerization catalyst or initiator and conditions sufficient to promote polymerization. The polymerization catalyst or initiator can be any suitable initiator or catalyst depending on the monomer(s) chosen. In some embodiments, the initiator is a persulfate type of initiator, such as, without limitation, sodium persulfate. In some embodiments, the monomer is acrylic acid and the initiator is sodium persulfate. The initiator is provided in an amount sufficient for complete polymerization of the monomer. In some embodiments, a sufficient amount of initiator for complete polymerization of the monomer can range from approximately 10:1 to 1000:1. In some embodiments, once the polymerizable mixture is formed, it is contacted with a polymerization catalyst or initiator and subjected to conditions sufficient to polymerize the mixture. In some embodiments, the conditions sufficient to result in the chain polymerization of the monomers are those that result in the insitu generation of free radicals with sufficient reactivity to add across the double bond of the monomer. In these embodiments, the free radicals can be produced through various routes including but not limited to ionizing radiation (such as gamma rays, beta rays), ultraviolet irradiation of a photoinitiator, redox catalyst systems such as the an alkali metal persulfate, or a thermal initiator such as an “azo” compound or the generation of free radical via exposure to high-intensity ultrasound and the like. In some embodiments, the polymerizable mixture combined with a polymerization catalyst or polymerization initiator is transferred to a suitable receptacle and heated to a temperature sufficient to polymerize the monomer. In some embodiments, conditions sufficient to promote polymerization are temperatures that can range from 140° F. to 450° F. with polymerization times ranging from 10 minutes to 24 hours. In some embodiments, the polymerization temperatures can range from 275° F. to 400° F. with polymerization times between 10 minutes to 12 hours.

In some embodiments, additives are incorporated to the mixture prior to polymerization and/or attached to the polymer backbone to promote the attachment of the polymer chains to the surface of the clay platelets. In some embodiments one or more additives are attached to the polymer backbone post-polymerization. Non-limiting examples of the additives include phosphonium salts, quarternary amine salts, alkyl and arylsilanes, alcohols, glycols, amines, and combinations thereof.

In preferred embodiments, the temperature for polymerization is near or is raised during polymerization to be near to or higher than the boiling point of water so that the water is removed from the polymerizable mixture during heating. In some embodiments, the polymerizable mixture is heated to a temperature in a range of about 100° C. to about 150° C., about 150° C. to about 240° C., about 160° C. to about 230° C., about 170° C. to about 220° C., about 180° C. to about 210° C., about 190° C. to about 200° C. Non-limiting examples of other suitable temperatures include about 100, 110, 120, 130, 140, 150, 160, 170, 180, 190, 200, 210, 220, 230, and 240° C. In some embodiments, the polymerization is initiated in another manner other than or in addition to heating. Non-limiting suitable energies that may be used for initiation include ultraviolet (UV), infrared (IR), ionizing radiation, and redox reactions.

In those embodiments in which heating is used, the polymerizable mixture is heated any suitable amount of time to effect polymerization. In some embodiments, the polymerizable mixture is heated for about 1 minute to about 30 minutes, about 5 minutes to about 25 minutes, about 8 minutes to about 20 minutes, and about 10 minutes to about 15 minutes. Other suitable times include, without limitation, about 1, 2, 3, 4, 5, 6, 7, 8, 9, 10, 12, 14, 16, 18, 20, 22, 24, 26, 28, and 30 minutes.

In those embodiments in which heating is used, any heater and any heating process may be used which are capable of heating the mixture to polymerize the monomer. In some embodiments, the polymerizable mixture is passed through an oven for heating. The polymerizable mixture can be passed through the oven at any suitable rate capable of effecting polymerization of the monomer. In some embodiments, the polymerizable mixture is passed through the oven at a belt speed of about 5 ft/min to 30 ft/min, about 10 ft/min to 20 ft/min, about 5 ft/min to 10 ft/min, or about 15 ft/min to 30 ft/min. Other suitable rates include, without limitation, about 5, 6, 7, 8, 9, 10, 11, 12, 13, 14, 15, 16, 17, 18, 19, 20, 21, 22, 23, 24, 25, 26, 27, 28, 29, and 30 ft/min.

In some embodiments, the polymerized mixture (or clay-polymer composite) is maintained at an elevated temperature after the heating step. The elevated temperature is equal to or greater than the temperature of the heating step. In some embodiments, the polymerized mixture is maintained at the elevated temperature, for example, to remove any excess water from the polymerized mixture prior to granulation. In some embodiments, the elevated temperature is in a range of about 150° C. to about 250° C., about 175° C. to about 200° C., about 180° C. to about 230° C., about 195° C. to about 215° C., about 200° C. to about 250° C. Other suitable temperatures include, without limitation, about 150, 155, 160, 165, 170, 175, 180, 185, 190, 195, 200, 205, 210, 215, 220, 225, 230, 235, 240, 245, and 250° C.

In those embodiments in which the polymerized mixture (or clay-polymer composite) is maintained at an elevated temperature after the heating step, the polymerized mixture can be maintained at the elevated temperature after the heating step for any suitable amount of time. In some embodiments, the polymerized mixture is maintained at the elevated temperature for about 0.5 minutes to about 30 minutes, about 10 minutes to about 25 minutes, about 7 minutes to about 30 minutes, about 12 minutes to about 20 minutes, about 14 minutes to about 18 minutes, or about 15 minutes to about 30 minutes. Other suitable times include, without limitation, about 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30 minutes.

Without intending to be bound by theory, it is believed that polymerization of the polymer in the presence of the clay beneficially improves the desired structure of the polymer—that is providing polymers having linear or lightly-branched structures. It is believed that the clay acts as a template for the growing polymer chains and cross-linked structures. The interaction of the monomer and the clay may impart a more active product. Thus, it was unexpectedly discovered that polymerization of the monomer and crosslinker in the presence of the clay beneficially provides a higher amount of mobile linear and lightly-branched or lightly cross-linked structures, which in turn has been determined as more desirable for providing rapidly activating hydraulic barriers.

In some embodiments, the polymerized mixture (or clay-polymer composite) is then granulated or crushed into a granular or powder to form the clay-polymer granules. The polymer may be sheared during the granulation process, which can assist in providing clay-polymer granules having polymer chains with linear or lightly branched polymer structures. The granules can have any suitable size, which may, for example, depend upon the end use and/or application method for incorporation into a substrate. In some embodiments, the granules have an average diameter of about 500 microns or greater as determined by a weight average using a sieve screening analysis. The size (diameter) range can be between approximately 50 microns and 4760 microns (4 mesh to 200 mesh.) as determined by sieving. In some embodiments, at least 80% of the granules, by number, have a size in a range of about 5 mesh to about 325 mesh, about 10 mesh to about 300 mesh, about 20 mesh to about 200 mesh, about 14 mesh to about 200 mesh, about 14 mesh to about 80 mesh, about 25 mesh to about 100 mesh, about 50 mesh to about 200 mesh, about 75 mesh to about 175 mesh, about 100 mesh to about 150 mesh, about 75 mesh to about 100 mesh, and about 6 mesh to about 50 mesh where the mesh is the mesh size of a U.S. standard sieve. In preferred embodiments, at least 95% of the granules, by number, have a size in a range of about 4 mesh to about 270 mesh, about 10 mesh to about 300 mesh. In some embodiments, at least 80 wt % of the granules as determined by a sieve analysis using U.S. standard size sieves where the mass of particles per sieve is determined and the weight percent of the sample falling between the sieve sizes is determined, have a size (diameter) in a range of about 5 mesh to about 325 mesh, about 10 mesh to about 300 mesh, about 20 mesh to about 200 mesh, about 14 mesh to about 200 mesh, about 14 mesh to about 80 mesh, about 25 mesh to about 100 mesh, about 50 mesh to about 200 mesh, about 75 mesh to about 175 mesh, about 100 mesh to about 150 mesh, about 75 mesh to about 100 mesh, and about 6 mesh to about 50 mesh. Other suitable sizes include about 5, 6, 7, 8, 9, 10, 12, 14, 16, 18, 20, 22, 24, 26, 28, 30, 32, 34, 36, 38, 40, 42, 44, 46, 48, 50, 60, 70, 80, 90, 100, 110, 120, 130, 140, 150, 160, 170, 180, 190, 200, 225, 250, 275, 300, and 325 mesh (U.S. standard sieve). In some embodiments, the granules are separated to obtain granules in any of the above size ranges for use in forming the hydraulic barrier. In some embodiments, an average diameter is determine based upon the percent by weight of the total sample falling between two sieves in a sieve stack, and a diameter determined in this manner would approximate a volume average diameter if the density were the same for all particles in the sample.

It has been advantageously and unexpectedly discovered that the properties of the resulting hydraulic barrier, including the speed at which the barrier activates in aggressive environments, can be tailored by tailoring one or more of the processing parameters for forming the clay-polymer granules, such as the amount of cross-linking agent and the temperature at which the polymerizable mixture is polymerized. In some embodiments, a higher activity was observed and a rapidly activating hydraulic barrier can be produced using a small amount of cross-linking agent, and a lower temperature for the polymerization reaction. The temperature must, however, be sufficiently high to polymerize the monomer (at least 98 weight % of the monomer added) and drive off substantially all of the moisture from the polymerized product. Without intending to be bound by theory, it is believed that adjustment of the polymerization conditions, such as the amount of cross-linking agent and the temperature of polymerization, results in changes in the structure of the polymers (i.e., linear or branched structures) and the molecular weight distribution and particularly the content of low molecular weight polymer able to activate rapidly when contacted with water to provide a substantially immediate impermeability to water.

In some embodiments, a pre-synthesized polymer or polymer mixture is added to the clay instead of formation of the polymer in the presence of the clay. In some embodiments, the hydraulic barrier composition is a physical blend of polymer and clay. In some embodiments, the hydraulic barrier composition includes granules including both polymer and clay. Any polymers based on the monomers described above may be used. In some embodiments, the pre-synthesized polymer or polymer mixture has a wide molecular weight distribution, and in some embodiments, the term “wide molecular weight distribution” is a polydispersity index of the mixture of polymers or polymer which is added to form the granules, or composite, of at least 5, but not more than 100. In preferred embodiments, the polydispersity index of the mixture or polymer which is added to form the granules or composite is at least 10 but not more than 90. In some embodiments, a high molecular weight polymer and a low molecular weight polymer are combined and mixed with the clay to form the clay-polymer granules or a clay-polymer composite which is granulated or crushed to form clay-polymer granules. In some embodiments, a high molecular weight pre-synthesized polymer has an average molecular weight of greater than 1×10⁶ g/mole as determined by SEC-MALLS. In some embodiments, a low molecular weight pre-synthesized polymer has an average molecular weight of about 100,000 to about 300,000, about 150,000 to about 250,000, or about 200,000 to about 250,000 as determined by SEC-MALLS. In some embodiments, the low molecular weight polymer has a polydispersity index (M_{w}/Mₙ) in a range of about 1 to about 7, about 2 to about 6, about 3 to about 5. Other suitable values of the polydispersity index include, for example, about 1, 2, 3, 4, 5, 6, and 7. In some embodiments, the high molecular weight polymer also has a polydispersity index in a range of about 1 to about 7, about 2 to about 6, about 3 to about 5. Other suitable values of the polydispersity index include, without limitation, about 1, 2, 3, 4, 5, 6, and 7. In some embodiments, the high molecular weight polymer is crosslinked where the molar ratio of monomer to cross-linking agent of not less than 800.

In some embodiments, the pre-synthesized polymer is about 0.07 wt % to about 70 wt % of the clay-polymer mixture, or 1 wt % to 90 wt % of the clay-polymer mixture, or 2 wt % to 80 wt % of the clay-polymer mixture, based on the total weight of the mixture. Other suitable amounts include about 0.1 wt. % to about 70 wt. %, about 10 wt. % to about 60 wt. %, about 20 wt. % to about 40 wt. %, about 30 wt. % to about 70 wt. %, about 1 wt. % to about 10 wt. %, about 0.5 wt % to about 3 wt. %, 0.1 wt % to about 0.5 wt %, about 0.1 wt % to about 1 wt %, about 0.2 wt % to about 4 wt %, about 0.4 wt % to about 3 wt %, or about 0.6 wt % to about 2 wt %, based on the total weight of the mixture. Other suitable amounts include about 0.07, 0.1, 0.2, 0.3, 0.4, 0.5, 0.6, 0.7, 0.8, 0.9, 1, 5, 10, 15, 20, 25, 30, 35, 40, 45, 50, 55, 60, 65, and 70 wt. %.

In those embodiments in which a mixture of high and low molecular weight polymers is used, embodiments of the disclosure encompass mixtures where each of the polymers is provided in the amounts provided above subject to the limitation that the total amount of polymer in the clay-polymer granules is less than 100 wt. %. In some embodiments, the clay-polymer granules are less than 70 wt. % polymer. In yet other embodiments the clay-polymer granules are in the range of 3 wt. % and 12 wt. % of polymer. In some embodiments, the low molecular weight polymer concentration is about 8 wt % to about 70 wt % based on the total weight of the polymer in the clay-polymer granules. In some embodiments, the low molecular weight polymer is about 40 wt. % to 60 wt. % based on the total polymer in the clay-polymer granules. In some embodiments, such as but not limited to those above, the wt % of low molecular weight polymer is determined from a polymer weight distribution measured by SEC-MALLS.

In some embodiments, the pre-synthesized polymer or polymer mixture has a weight distribution is a polydispersity of less than 10. In some embodiments, the pre-synthesized polymer is a cross-linked polymer in which at least 98 wt % of the polymer is part of a polymer network. In some embodiments, the pre-synthesized polymer is a cross-linked polymer in which not more than 20 wt %, not more than 15 wt %, not more than 10 wt %, not more than 8 wt %, or not more than 5 wt % of the polymer is free polymer. In some embodiments, the “free polymer” is polymer not forming a part of a cross-linked polymer network. In some embodiments, the “free polymer” is linear polymer, lightly branched polymer, or a combination thereof. In some embodiments, “free polymer” is polymer which can elute from the polymer mass within 24 hours with an aqueous flow of water at pH in the range of 0.3 to 11.5, and ionic strength in the range of 0.03 to 3 at flux of 2.4×10⁻⁷ m³/m²/sec or while soaked in water for 24 hours at pH in the range of 0.3 to 11.5, and ionic strength in the range of 0.03 to 3. In some embodiments, “free polymer” is polymer which will not elute from the polymer mass within 24 hours with an aqueous flow of water with an RMD of less than 0.1 M^{1/2} at flux of 2.4×10⁻⁷ m³/m²/sec or after being subject to multiple wet/dry cycles in water with an RMD of less than 0.1 M^{1/2}. In some embodiments, the cross-link density of the cross-linked pre-synthesized polymer is in the range of about 100:1 to about 20,000:1 monomer(s)/cross-linker (mol/mol) ratio, preferably, in the range of 1000:1 to about 15,000:1 (mol/mol) ratio.

In some embodiments, dry polymer powders, granules, or a combination thereof are added directly to the clay to form clay-polymer granules, or a clay-polymer composite which is granulated or ground to form clay-polymer granules. In some embodiments, dry polymer powders, granules, or a combination thereof are added directly to the clay and compressed into a larger size and possible reduced in size in a subsequent step. In some embodiments, dry polymer powders, granules, or a combination thereof are coated with clay using various types of coating equipment such as pin mixer or the like. In some embodiments, a slurry of the polymer and clay is predispersed in water, dried to form a polymer-clay composite, and granulated or ground to a powder. In some embodiments, a combination of the above two methods are used. In some embodiments, dry polymer powders are added directly to the clay-polymer composite, dry clay is added to the clay-polymer composite, or a combination thereof. In some embodiments, a combination of clay-polymer granules formed by dry addition and slurry combination are used. In some embodiments, the powder or granules, or at least a portion thereof, is then be used in the hydraulic barrier composition. In some embodiments, the powder, granules, or both are segregated by size prior to using a selected size range in the hydraulic barrier composition.

In some embodiments, the hydraulic barrier composition consists essentially of the clay-polymer granules. In other embodiments, the hydraulic barrier composition includes a combination of the clay-polymer granules and additional filler granules, such as clay granules. Any suitable granular clays can be used, such as the water-swellable clays described above. The filler granules can include any suitable filler including, for example, calcium carbonate, talc, mica, vermiculite, acid activated clays (where a hydrogen ion has replaced the sodium), kaolin, silicon dioxide, titanium dioxide, calcium silicate, calcium phosphate, alumina, fly-ash, silicon carbide, silica sand, lignite, recycled glass, calcium sulfate, cement and mixtures thereof. In some embodiments, the composition further includes such fillers in non-granular form. In some embodiments, the composition includes additional polymers, not included in the clay-polymer granules. In some embodiments, the composition includes a super absorbent polymer. Non-limiting suitable additional polymers include alkylacrylamides, methacrylamides, styrenes, allylamines, allylammonium, diallylamines, diallylammoniums, alkylacrylates, methacrylates, acrylates, n-vinyl formamide, vinyl ethers, vinyl sulfonate, acrylic acid, sulfobetaines, carboxybetaines, phosphobetaines, and maleic anhydride and mixtures and copolymers thereof. In some embodiments, the hydraulic barrier composition is a physical blend of the clay and the polymer, optionally including a filler, a superabsorbent polymer, or both, and optionally including other additives.

In some embodiments, the hydraulic barrier includes at least 0.25 wt % of clay-polymer granules based on the total weight of the hydraulic barrier composition. The remaining weight percent is granular clay, a mixture of granular clays, a filler, a mixture of fillers, or any combination thereof. In some embodiments, the amount of clay-polymer granules when combined with additional fillers or clay include about 0.25 wt % to about 100 wt %, about 0.5 wt. % to about 95 wt %, about 1 wt % to about 80 wt %, about 5 wt % to about 70 wt %, about 10 wt % to about 60 wt %, about 15 wt % to about 50 wt %, about 20 wt % to about 40 wt %, about 0.5 wt % to about 5 wt %, about 1 wt % to about 10 wt %, about 2 wt % to about 8 wt %, about 2 wt % to about 6 wt %, or about 1 wt % to about 5 wt %. In some embodiments, other suitable amounts of clay-polymer granules are used and these include about 0.25, 0.3, 0.35, 0.4, 0.45, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 12, 14, 16, 18, 20, 25, 30, 35, 40, 45, 50, 55, 60, 65, 70, 75, 80, 85, 90, 95, and 100 wt %. In some embodiments, the total amount of polymer in the hydraulic barrier composition, that is the sum of the polymer of the clay-polymer granules, if present, and the additional added polymer, if present, is at least about 2 wt % and not more than about 35 wt %, preferably at least about 3 wt % and not more than 25 wt %, and most preferably at least about 4 wt % and not more than 20 wt %. In some embodiments, the polymer is about 4 wt % to about 12 wt %. In preferred embodiments, clay-polymer granules are present.

In some embodiments, the weight % of polymer derived from the monomer AMPS in the hydraulic barrier composition, whether part of the clay-polymer granules, or as additional added polymer, or both part of the clay-polymer granules and additional polymer, is at least about 3 wt % and not more than about 35 wt %, preferably at least about 4 wt % and not more than 25 wt %, and most preferably at least about 5 wt % and not more than 20 wt % of the hydraulic barrier composition. In some embodiments, the polymer is about 6 wt % to about 11 wt % of the hydraulic barrier composition. In some embodiments, the weight % of polymer derived from the monomer AMPS in the hydraulic barrier composition which is part of the clay-polymer granules is at least about 3 wt % and not more than about 35 wt %, preferably at least about 4 wt % and not more than 25 wt %, and most preferably at least about 5 wt % and not more than 20 wt % of the hydraulic barrier composition. The polymer derived from AMPS may be a homopolymer, a copolymer, or a combination thereof. In calculating the weight % of polymer derived from the monomer AMPS, the weight % derived from the monomer AMPS of a copolymer of AMPS is calculated from the weight % of the copolymer in the hydraulic barrier composition times the weight % of the copolymer that is derived from AMPS (which can be calculated from the mol % of the monomer AMPS used in forming the polymer and the mol % of the other monomer(s) used in forming the AMPS copolymer).

In some embodiments, the polymer of the physical blend of polymer and clay, or additional polymer added to clay-polymer granules, or both, is of a size (diameter) range such that it passes through a 14 mesh sieve and is retained on an 80 mesh sieve (diameters ranging from 1410 microns to 177 microns). In some embodiments, the polymer of the physical blend of polymer and clay, or additional polymer added to clay-polymer granules, is of a size (diameter) range such that it passes through a 35 mesh sieve and is retained on an 140 mesh sieve (diameters ranging from 105 microns to 500 microns). In some embodiments, the polymer of the physical blend of polymer and clay, or additional polymer added to clay-polymer granules, is of a size (diameter) range such that it passes through a 120 mesh sieve and is retained on a 140 mesh sieve (diameters ranging from about 105 microns to about 125 microns). In some embodiments, the polymer of the physical blend of polymer and clay, or additional polymer added to clay-polymer granules, or both, is a polymer derived from AMPS, which may be a homopolymer, a copolymer, or a combination thereof.

### Method of Making the Hydraulic Barriers

In some embodiments, a hydraulic barrier is formed by incorporating the hydraulic barrier composition into a substrate, for example, a geotextile. The hydraulic barrier composition can be incorporated and retained in a substrate using any known methods, such as and without limitation, needle punching, stitching, chemical binding, adhesive binding, and combinations thereof. In some embodiments, the hydraulic barrier is formed by needle punching from 10,000 strikes/ft² to about 24,00 strike/ft². In various embodiments, granules having a larger mesh size, for example, in a range of 50 to 4000 microns, are used when needle punching is used. The use of the larger granule size when needle punching is used can advantageously provide improved performance. Without intending to be bound by theory, it is believed that the larger granules can more effectively clog passageways formed by the needling punching operation. In various embodiments, hydraulic barriers formed using needle punching include at least about 4% clay-polymer granule loading. Without intending to be bound by theory, it is believed that additional loading of the clay-polymer granules can be advantageous when needle punching to block passages (fiber bundles) formed by the needle punching. Also, without intending to be bound by theory, it is believed that the additional lower molecular weight polymer aids the drainage of the crosslinked granules into the fiber bundles. The substrate can be any substrate that is compatible with the hydraulic barrier composition. In some embodiments, the substrate is a fibrous substrate. The substrate can be water-absorbent, water-adsorbent, or both. In some embodiments, the substrate is formed from or includes a geotextile material, including woven and non-woven geotextile materials. The geotextile materials can have any weight and formed from any material suitable for use in intended application of the hydraulic barrier, for example, in aggressive environments. The geotextile can have a unit weight of about 0.05 kg/m² to about 0.8 kg/m², about 0.1 kg/m² to about 0.4 kg/m², or about 0.1 kg/m² to about 0.2 kg/m². In some embodiments, forming the hydraulic barrier by incorporating the hydraulic barrier composition into a substrate, such as without limitation, a geotextile, includes incorporating into the substrate the hydraulic barrier composition at a loading of the clay/polymer mixture of at least 0.75 lbs/ft², at least 0.80 lbs/ft², at least 0.85 lbs/ft², or at least 0.90 lbs/ft² and up to 10 lbs/ft². In some embodiments, the hydraulic barrier composition is incorporated into a substrate at a loading of not more than 200 lbs/ft², 150 lbs/ft², or 120 lbs/ft².

Further, the geotextile material may be in any form compatible with providing the desired hydraulic barrier material in any size or shape to fit any area to be protected against substantial water contact. In some embodiments, the substrate is a substantially planar sheet comprising at least one layer of the geotextile material. Examples of suitable geotextile materials include, but are not limited to, PETROMAT 4597, PETROMAT 4551, AND PETROMAT 4506, available from Amoco, GEO-4-REEMAY 60, a polyester material, available from Foss, Inc., and 25WN040-60, available from Cumulus Corp. The substrate can have any suitable thickness. In some embodiments, the GEO-4-REEMAY 60 material, which is available in 2 mm thickness, is used, and in some embodiments, the 25WN040-60 material, which is available in a 5 mm thickness, is used. The substrate can be a geotextile such as HH65L by Propex, which is a polypropylene nonwoven geotextile with a mass per unit area of 6.0 oz/yd², a thickness of 1.022 millimeters and a maximum apparent opening size of 0.21 millimeters as measured per ASTM D4751. Alternatively the geotextile the substrate can be a geotextile such as 82 TEX by Synthetic Industries, which is a polypropylene nonwoven geotextile with a mass per unit area of 3.2 oz/yd² The substrate can be a combination of geosynthetic materials such as combinations of nonwoven geotextile, woven geotextile and geomembranes.

In some embodiments, the hydraulic barrier includes a coversheet and/or carrier sheet. In some embodiments, the coversheet and/or carrier sheet is a geotextile material. The coversheet and/or carrier sheet can be attached to the substrate using any known methods, such as those used in forming geosynthetic clay liners. In some embodiments, the hydraulic barrier composition is needle punched, whereby fibers from an upper non-woven sheet material layer are displaced and secured to a lower non-woven sheet material layer, and fibers from the lower non-woven sheet material layer are displaced and secured to the upper non-woven sheet material layer. Any other suitable methods for adhering the coversheet may be used, such as stitching or use of an adhesive. Combinations of the above methods may be used. The coversheet can be a geotextile such as GE160 or GE180 by Skaps, which are polypropylene nonwovens geotextile with a mass per unit area of 6 oz/yd² and 9 oz/yd², respectively.

In some embodiments, a protective layer is incorporated between the clay/polymer layers and any one (or both) of the geotextile layers. This protective layer can be any sheet good or protective coating that can provide as extra protection against erosion of the clay/polymer layer. Non-limiting examples of sheet goods are thin gauge plastic films such as, and without limitation, polyolefin type membranes or water dissolving films such as, and without limitation, polyvinyl alcohol. A non-limiting example of a polyolefin film is a polyethylene film such as IntePlus PL® 4-mil film by Inteplast. A non-limiting example of a water dissolving film is a polyvinylalcohol film such as POVAL® FILM from Kurrary. A non-limiting example of a coating is a spray applied latex such as UCAR123® by Union Carbide. The coating weight may be in the range of 40 to 80 grams per square foot.

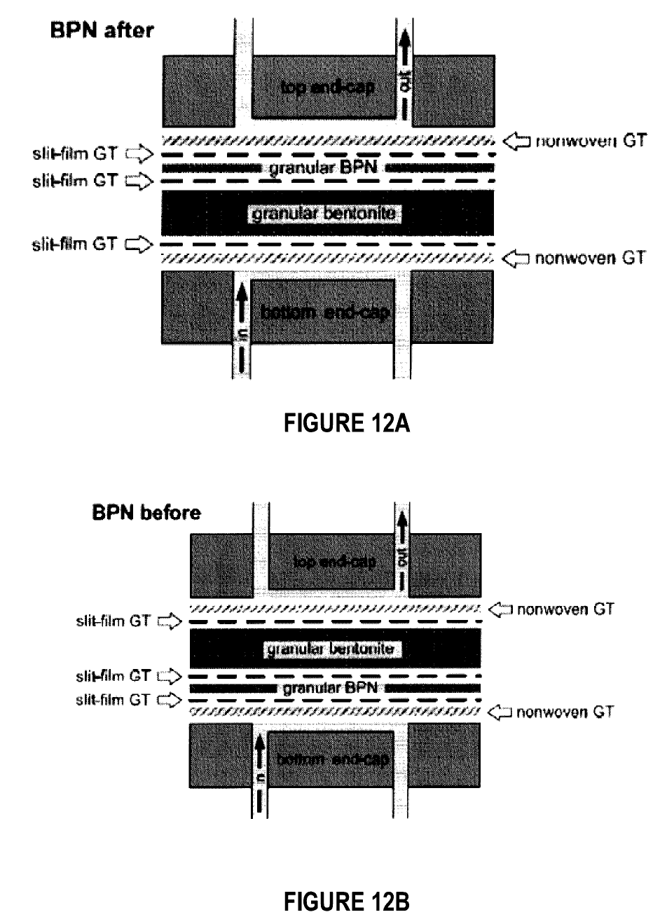

In some embodiments of the disclosure, the clay-polymer granules are provided as a layer separate from a granular bentonite layer. In some embodiments, a hydraulic barrier is formed by forming a layer of the clay-polymer granules, such as and without limitation, by embedding the clay-polymer granules in a substrate or using a sequential method to add the clay-polymer granules before, after, or both before and after, the addition of the bentonite granules. The clay-polymer granules may be retained in a substrate using any suitable methods. Any suitable substrate can be used. In an embodiment illustrated in Referring to FIG. 12B, the hydraulic barrier is formed by placing the clay-polymer granular layer before (in the direction of fluid flow) a layer of granular clay. The layer of granular bentonite may be formed in any way using any suitable substrate and methods of retaining the granular bentonite in the substrate. In some embodiments, the clay-polymer granules are embedded in a coversheet of the hydraulic barrier. The granular clay is embedded into a lower sheet material of the hydraulic barrier and retained in the hydraulic barrier by needle punching the coversheet to the lower sheet material. In other embodiments, the granular bentonite and the clay-polymer granules are separately formed into geocomposite mats using any suitable substrates and methods of forming the mats. In these embodiments, the mats are then assembled into a hydraulic barrier, wherein the clay-polymer granule-containing mat is placed before (in the direction of fluid flow) the granular clay-containing mat.

The following examples are provided for illustration and are not in any way intended to limit the scope of the invention.

### EXAMPLES

### Example 1

### Formation of a Clay-Polymer Granular Composition

Clay-polymer granular compositions were formed using the ingredients and amounts shown in Table 1, below.

TABLE 1
Clay-Polymer Composite Composition

| | Material | Function | Amount (wt %) |
|---|---|---|---|
| CPC-1 | Acrylic Acid, 99% | Organic monomer | 11.41% |
| | N′N′ Methylene-bisacryl- | Cross-linking | 0.03% |
| | amide, 99% (MBA) | agent | |
| | Deionized water | Water | 38.90% |
| | 50% NaOH | Neutralizing | 9.5% |
| | | agent | |
| | Sodium Bentonite Clay | Clay | 38.76% |
| | 30% Sodium Persulfate in | Initiator | 1.4% |
| | water | | |
| | | Total | 100% |
| CPC-2 | Acrylic Acid, 99% | Organic monomer | 43.85% |
| | N′N′ Methylene-bisacryl- | Cross-linking | 0.03% |
| | amide, 99% (MBA) | agent | |
| | Deionized water | Water | 3.23% |
| | 50% Sodium Hydroxide | Neutralizing | 38.95% |
| | (NaOH) | agent | |
| | Sodium Bentonite Clay | Clay | 13.7% |
| | 30% Sodium Persulfate in | Initiator | 0.24% |
| | water | | |
| | | Total | 100% |

The MBA was dissolved into the acrylic acid and then diluted with the deionized water and neutralized with the NaOH solution. The sodium bentonite clay (“clay” or Na—B) was then added slowly while mixing using a Sterling Multimixer. The initiator was added and stirred using the Multimixer. About 1 liter of the slurry was placed into a 3 quart baking pan and heated to 190° C. for about 20 minutes. The temperature was then lowered to 110° C. and the polymerized mixture was allowed to remain at the elevated temperature overnight. The resulting material was then broken into smaller chunks and ground to form the clay-polymer granules. Table 2 provides various parameters of the slurry used to form the clay-polymer granules.

TABLE 2
Slurry Analysis

| | Feature | Percentage |
|---|---|---|
| CPC-1 | Weight percent of the polymer based on the total | 28.46 wt % |
| | weight of the solids | |
| | Weight percent of the clay based on the total | 70.69 wt % |
| | weight of the solids | |
| | Weight percent of the crosslinker based on the | 0.18 wt % |
| | total weight of the polymer | |
| | Mole percent of the crosslinker to monomer | 0.10 mol % |
| | Weight percent of water based on the total weight | 41.47 wt % |
| | of the slurry | |
| | Weight percent of solids based on the total weight | 58.53 wt % |
| | of the slurry | |

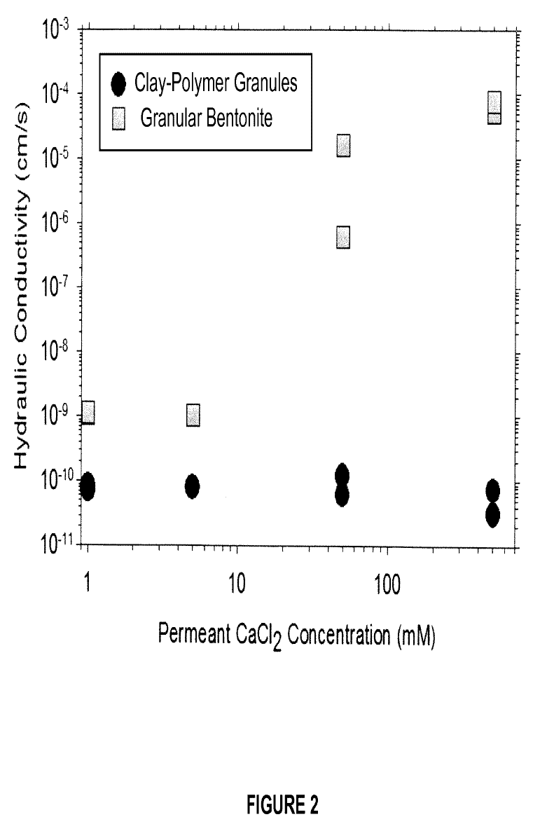

The granules were evaluated for permeability as compared to granular bentonite at varying calcium chloride (CaCl₂) concentrations (i.e., representing an aggressive environment). The permeability experiments were conducted according to ASTM D 5084 with an average effective stress of 20 kPa and a hydraulic gradient of 200. The concentration of calcium chloride of the permeate was increased from 1 to 500 mMol/liter. The hydraulic barrier was prehydrated in the CaCl₂ leachate solution. As shown in FIG. 2, the clay-polymer granules, tested by themselves, performed well against all permeate solutions, particularly as compared to the granular bentonite at calcium chloride concentrations of greater than 5 mMol/liter. The clay-polymer granules demonstrated a permeability of less than 1×10¹⁰ cm/sec. In some experiments, clogging of the permeameter lines was observed, resulting sudden decrease in permeability. It is believed that the released oligomer from the clay-polymer granules caused the clogging. All permeability measurements described herein have removed from consideration reduced permeability measurements during clogging.

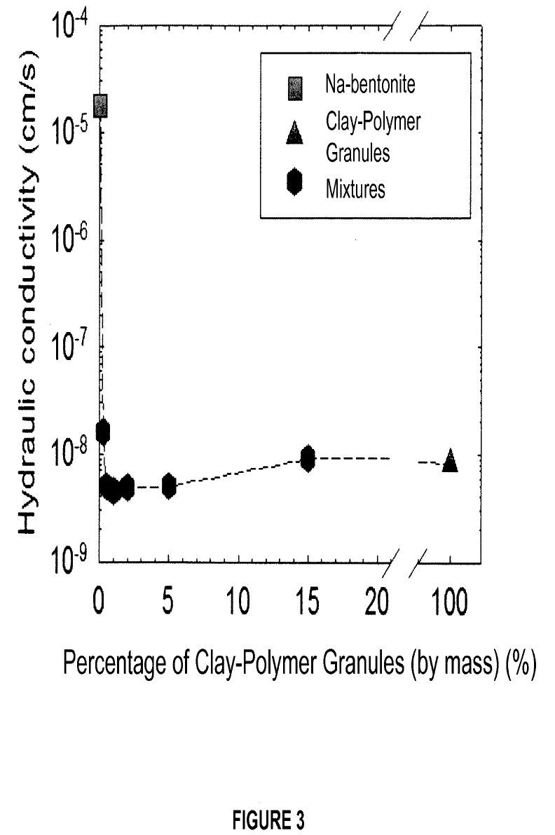

As shown in FIG. 3, it was further demonstrated that mixing granular bentonite with the clay-polymer granules at levels as low as 0.5 wt. % of the clay-polymer granules also demonstrated acceptable low permeability of less than 1×10⁻⁸ cm/sec at calcium chloride concentrations up to 50 mMol/liter. The granular bentonite control, however, exhibited a permeability of 2×10⁻⁵ cm/sec.

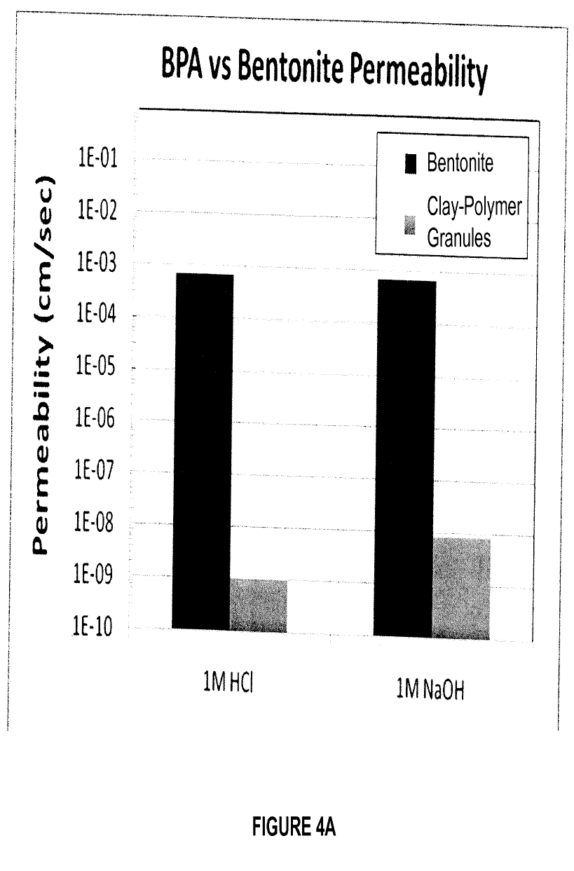

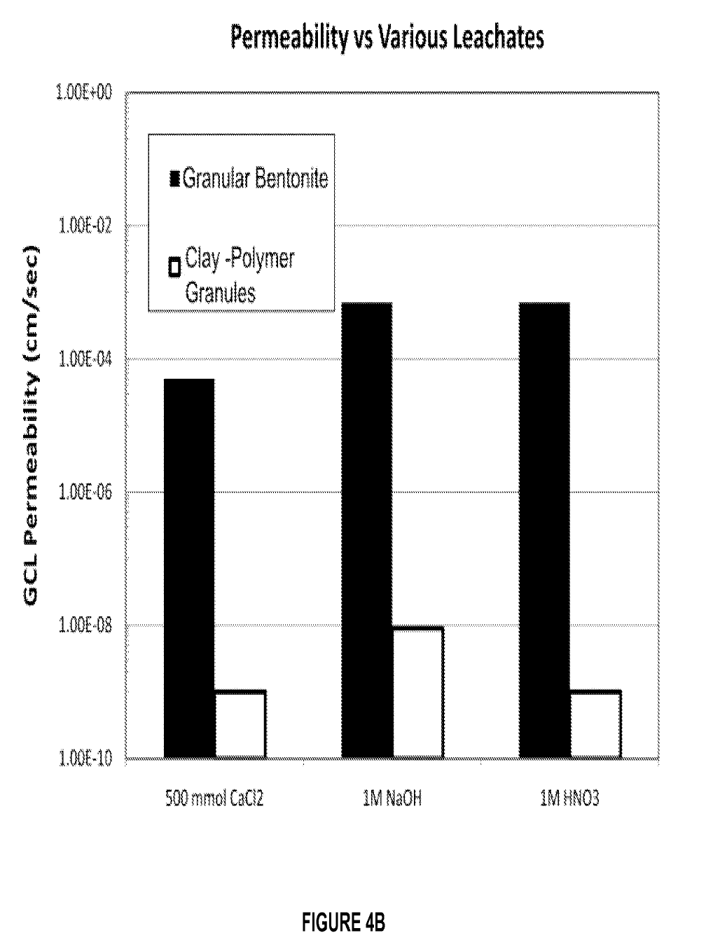

As shown in FIG. 4A, the clay-polymer granules exposed to both high pH (1M NaOH) and low pH (1M HNO₃) solutions performed well, exhibiting hydraulic conductivities of 8×10⁻⁹ cm/sec and 1×10⁻⁹ cm/sec, respectively. The sample tested including 100% of the clay-polymer granules formed in accordance with Example 1, CPC-1. FIG. 4B further demonstrates that, as compared to bentonite clay alone, the clay-polymer granules demonstrated low hydraulic conductivity in 500 mmol CaCl₂ and 1M HNO₃.

The clay-polymer granules were subjected to these aggressive conditions for approximately two years, and demonstrated acceptably low permeability over the course of testing.

The foregoing example demonstrates that the clay-polymer granules in accordance with embodiments of the disclosure advantageously demonstrate low permeability in aggressive environments such as high calcium chloride concentrations and both high and low pH solutions.

The clay-polymer granules demonstrated significant improvement over bentonite in such environments.

### Example 2

### Large-Scale Formation of Clay-Polymer Granules

Clay-polymer granules in accordance with embodiments of the disclosure were synthesized in a large-scale, belt feed oven used for hydraulic barrier production. The slurries for forming the clay-polymer granules were formed by weighing the acrylic acid (polymerizable monomer) in polypropylene cup, measuring methylene bisacrylamide (cross-linking agent) in a separate vessel and adding it to the acrylic acid and mixing by swirling to form an acrylic acid solution. The water was measured in a separate plastic container and added to the acrylic acid solution. Sodium hydroxide was measured in a separate vessel and added very slowly to the acrylic acid solution to avoid overheating. The clay was added next and blended in a multimixer for at least 1 minute to disperse the clay. Just prior to heating in the oven, the sodium sulfate initiator was added as a 30% solution in water and then blended thoroughly with a spatula. The resulting slurry was emptied onto a Telfon® cookie sheet and heated in an oven having three heating zones and a final cooling zone. The cooling zone was at a temperature of about 200° F. The resulting, clay-polymer cake was then granulated to form the clay-polymer granules.

A first series of clay-polymer granules were produced at an average oven temperature of about 275° F. The oven had three zones, with the first and second zones being set to about 250° F. and the third zone being set to about 300° F. The compositions and processing parameters for the samples produced in the first series are shown in Table 3, below.

TABLE 3
Clay-Polymer Granules Produced Using an
Average Oven Temperature of about 275° F.

| | | | | 30% | | | |
|---|---|---|---|---|---|---|---|
| | Acrylic | | | Sodium | | | Belt |
| Run | Acid, | | | Persul- | 50% | | Speed |
| Num- | 99% | MBA | Clay | fate | NaOH | Water | (ft/ |
| ber | (wt %) | (wt %) | (wt %) | (wt %) | (wt %) | (wt %) | min) |
| 1 | 15.3 | 0.0338 | 50.0 | 1.12 | 13.5 | 20.1 | 10 |
| 2 | 15.8 | 0.0330 | 50.6 | 0.27 | 14.0 | 19.2 | 10 |
| 3 | 15.8 | 0.0330 | 50.6 | 0.27 | 14.0 | 19.2 | 10 |
| 4 | 23.3 | 0.0305 | 39.9 | 0.85 | 20.7 | 15.3 | 10 |
| 5 | 43.3 | 0.0293 | 13.2 | 0.97 | 38.5 | 4.0 | 10 |
| 6 | 30.8 | 0.0239 | 30.8 | 0.25 | 27.4 | 10.6 | 10 |
| 7 | 44.1 | 0.0224 | 13.0 | 0.48 | 39.2 | 3.3 | 10 |
| 8 | 30.6 | 0.0309 | 30.6 | 0.60 | 27.2 | 11.0 | 10 |
| 9 | 43.9 | 0.0286 | 13.7 | 0.24 | 38.9 | 3.2 | 10 |
| 10 | 15.3 | 0.0301 | 50.0 | 1.12 | 13.5 | 20.1 | 10 |
| 11 | 15.1 | 0.0260 | 51.2 | 0.56 | 13.4 | 19.8 | 10 |
| 12 | 30.3 | 0.0245 | 30.3 | 1.04 | 26.9 | 11.5 | 10 |
| 13 | 15.1 | 0.0260 | 51.2 | 0.56 | 13.4 | 19.8 | 20 |
| 14 | 43.3 | 0.0293 | 13.2 | 0.97 | 38.5 | 4.0 | 20 |
| 15 | 30.8 | 0.0239 | 30.8 | 0.25 | 27.4 | 10.6 | 20 |
| 16 | 44.1 | 0.0224 | 13.0 | 0.48 | 39.2 | 3.3 | 20 |
| 17 | 43.9 | 0.0286 | 13.7 | 0.24 | 38.9 | 3.2 | 20 |
| 18 | 30.6 | 0.0309 | 30.6 | 0.60 | 27.2 | 11.0 | 20 |
| 19 | 43.9 | 0.0286 | 13.7 | 0.24 | 38.9 | 3.2 | 20 |
| 20 | 15.3 | 0.0338 | 50.0 | 1.12 | 13.5 | 20.1 | 20 |
| 21 | 30.3 | 0.0245 | 30.3 | 1.04 | 26.9 | 11.5 | 20 |
| 22 | 15.8 | 0.0330 | 50.6 | 0.27 | 14.0 | 19.2 | 20 |
| 23 | 43.3 | 0.0260 | 13.2 | 0.97 | 38.5 | 4.0 | 20 |
| 24 | 23.3 | 0.0305 | 39.9 | 0.85 | 20.7 | 15.3 | 20 |

A second series of clay-polymer granules were produced at an average oven temperature of about 375° F. The oven had three heating zones, with the first and second zone being set to about 350° F. and the third zone being set to about 400° F. The compositions and processing conditions for the samples produced in the second series are shown in Table 4, below.

TABLE 4
Clay-Polymer Granules Produced Using an
Average Oven Temperature of about 375° F.

| | | | | 30% | | | |
|---|---|---|---|---|---|---|---|
| | Acrylic | | | Sodium | | | Belt |
| Run | Acid, | | | Persul- | 50% | | Speed |
| Num- | 99% | MBA | Clay | fate | NaOH | Water | (ft/ |
| ber | (wt %) | (wt %) | (wt %) | (wt %) | (wt %) | (wt %) | min) |
| 25 | 30.6 | 0.031 | 30.6 | 0.60 | 27.2 | 11.0 | 10 |
| 26 | 30.3 | 0.025 | 30.3 | 1.04 | 26.9 | 11.5 | 10 |
| 27 | 15.3 | 0.034 | 50.0 | 1.12 | 13.5 | 20.1 | 10 |
| 28 | 44.1 | 0.022 | 13.0 | 0.48 | 39.2 | 3.3 | 10 |
| 29 | 37.1 | 0.028 | 21.7 | 0.79 | 33.0 | 7.4 | 10 |
| 30 | 43.9 | 0.029 | 13.7 | 0.24 | 38.9 | 3.2 | 10 |
| 31 | 43.3 | 0.029 | 13.2 | 0.97 | 38.5 | 4.0 | 10 |
| 32 | 15.3 | 0.030 | 50.0 | 1.12 | 13.5 | 20.1 | 10 |
| 33 | 23.3 | 0.031 | 39.9 | 0.85 | 20.7 | 15.3 | 10 |
| 34 | 30.8 | 0.024 | 30.8 | 0.25 | 27.4 | 10.6 | 10 |
| 35 | 15.1 | 0.026 | 51.2 | 0.56 | 13.4 | 19.8 | 10 |
| 36 | 15.8 | 0.033 | 50.6 | 0.27 | 14.0 | 19.2 | 10 |
| 37 | 44.1 | 0.022 | 13.0 | 0.48 | 39.2 | 3.3 | 20 |
| 38 | 15.8 | 0.033 | 50.6 | 0.27 | 14.0 | 19.2 | 20 |
| 39 | 37.4 | 0.027 | 21.6 | 0.66 | 33.2 | 7.2 | 20 |
| 40 | 30.6 | 0.031 | 30.6 | 0.60 | 27.2 | 11.0 | 20 |
| 41 | 43.9 | 0.029 | 13.7 | 0.24 | 38.9 | 3.2 | 20 |
| 42 | 30.3 | 0.025 | 30.3 | 1.04 | 26.9 | 11.5 | 20 |
| 43 | 15.1 | 0.026 | 51.2 | 0.56 | 13.4 | 19.8 | 20 |
| 44 | 30.3 | 0.025 | 30.3 | 1.04 | 26.9 | 11.5 | 20 |
| 45 | 15.8 | 0.033 | 50.6 | 0.27 | 14.0 | 19.2 | 20 |
| 46 | 30.8 | 0.024 | 30.8 | 0.25 | 27.4 | 10.6 | 20 |
| 47 | 43.3 | 0.029 | 13.2 | 0.97 | 38.5 | 4.0 | 20 |
| 48 | 15.3 | 0.034 | 50.0 | 1.12 | 13.5 | 20.1 | 20 |
| 49 | 23.3 | 0.031 | 39.9 | 0.85 | 20.7 | 15.3 | 20 |
| 50 | 30.8 | 0.024 | 30.8 | 0.25 | 27.4 | 10.6 | 20 |

### Example 3

### Polymer Activation Testing

The molecular weight distribution and the ability of the clay-polymer granules formed under different conditions were tested. The results demonstrate that the performance of the clay-polymer granules can be tailored by altering the formation conditions. The inventors have advantageously and surprisingly discovered that the amount of cross-linking agent and the temperature of polymerization have significant effects on the performance of the clay-polymer granules. It was surprisingly found that the relative amount of clay to monomer ratio (ratio of weight of clay to the weight of monomer) impacts the activity of the final product. Surprisingly, higher clay contents favor higher activity at a given polymerization conditions. It was also surprisingly found that the amount of clay also affects the speed at which the polymer can activate and, thus, the overall performance of the clay-polymer granules. The clay would not have been expected to promote activation of the polymer in the formulation, affecting the speed at which a portion of the polymer solubilizes when contact with water. Without intending to be bound by theory, it is believed that the clay performs as a physical dispersing agent during polymerization of the organic monomer, thereby resulting in polymer chains having linear or lightly branched structures, which can have enhanced water solubility depending on the molecular weight.

To demonstrate the performance advantage of the clay/polymer composite in rapidly allowing the polymer to dissolve and become available in the hydraulic barrier, various clay-polymer formulations were tested by adding 20 grams of the clay-polymer granules to a polyester pouch with dimensions of 4 inches wide by 4 inches long. The polyester pouch had a fabric weight of 0.035 lb/sq. ft. The clay-polymer granules were completely sealed inside the polyester pouch using a heat sealer or adhesive. The pouches were completely submerged in 700 mL of deionized water. Air was allowed to escape the filled pouch and a lid or cover was placed onto the container to prevent water evaporation. The container was maintained at 72° F. (about 22° C.) and remained out of direct contact with sunlight. At set time intervals, the container lid was removed and a 2 mL sample of the water surrounding the filled pouch (i.e., the effluent) was taken using a pipette. The absorbance of the water sample was measured by UV-Vis at 195 nm. The sampled water was replaced back into the container to maintain constant water volume of 700 mL for further sampling.

The measured absorbance value can be used to calculate the concentration of free polymer in solution using the equation below. The concentration of free polymer in the sampled effluent is indicative of the performance and the extent of immediate response that would be exhibited by a hydraulic barrier containing the clay-polymer granules.

[AM]=(ABS−0.5)/0.0031 Equation 1.

wherein, AM is the concentration of active material (ppm), and ABS is the absorbance value of the water sample at 195 nm. The processing conditions for forming the clay-polymer granules along with the measured absorbance are shown in Table 5, below. “Clay” refers to sodium bentonite.

TABLE 5
Release Amounts of the Clay-Polymer Composite After Leaching in Deionized Water for Four Hours

| | | | | | | | | | 4 hr Active |
|---|---|---|---|---|---|---|---|---|---|
| | Acrylic | | | 30% Sodium | 50% | DI* | Line | Oven Zone | Material |
| | Acid, | MBA | Clay | Persulfate | NaOH | Water | Speed | Temp | Release |
| Example | (wt %) | (wt %) | (wt %) | (wt %) | (wt %) | (wt %) | (ft/min) | (° F.) | conc (ppm) |
| CPC-3 | 43.9% | 0.029% | 13.7% | 0.24% | 38.9% | 3.2% | 10 | 350/350/400 | 623.5 |
| CPC-4 | 43.9% | 0.029% | 13.7% | 0.24% | 38.9% | 3.2% | 10 | 250/250/300 | 588.7 |
| CPC-5 | 30.8% | 0.024% | 30.8% | 0.25% | 27.4% | 10.6% | 10 | 350/350/400 | 587.1 |
| CPC-6 | 30.8% | 0.024% | 30.8% | 0.25% | 27.4% | 10.6% | 20 | 250/250/300 | 584.8 |
| CPC-7 | 30.3% | 0.024% | 30.3% | 1.04% | 26.9% | 11.5% | 10 | 250/250/300 | 576.5 |
| CPC-8 | 15.8% | 0.033% | 50.6% | 0.27% | 14.0% | 19.2% | 10 | 250/250/300 | 571.6 |
| CPC-9 | 44.1% | 0.022% | 13.0% | 0.48% | 39.2% | 3.3% | 10 | 350/350/400 | 555.8 |
| CPC-10 | 43.9% | 0.029% | 13.7% | 0.24% | 38.9% | 3.2% | 20 | 250/250/300 | 503.5 |
| CPC-11 | 30.8% | 0.024% | 30.8% | 0.25% | 27.4% | 10.6% | 10 | 250/250/300 | 501.0 |
| CPC-12 | 37.1% | 0.028% | 21.7% | 0.79% | 33.0% | 7.4% | 10 | 350/350/400 | 496.5 |
| CPC-13 | 43.3% | 0.029% | 13.2% | 0.97% | 38.5% | 4.0% | 10 | 350/350/400 | 452.6 |
| CPC-14 | 15.1% | 0.026% | 51.2% | 0.56% | 13.4% | 19.8% | 10 | 350/350/400 | 432.6 |
| CPC-15 | 15.8% | 0.033% | 50.6% | 0.27% | 14.0% | 19.2% | 10 | 350/350/400 | 401.6 |
| CPC-16 | 23.3% | 0.031% | 39.9% | 0.85% | 20.7% | 15.3% | 10 | 350/350/400 | 361.9 |
| CPC-17 | 30.8% | 0.024% | 30.8% | 0.25% | 27.4% | 10.6% | 20 | 350/350/400 | 361.6 |
| CPC-18 | 30.6% | 0.031% | 30.6% | 0.60% | 27.2% | 11.0% | 10 | 350/350/400 | 316.1 |
| CPC-19 | 30.3% | 0.024% | 30.3% | 1.04% | 26.9% | 11.5% | 10 | 350/350/400 | 297.1 |
| CPC-20 | 15.8% | 0.033% | 50.6% | 0.27% | 14.0% | 19.2% | 20 | 350/350/400 | 266.8 |
| CPC-21 | 43.9% | 0.029% | 13.7% | 0.24% | 38.9% | 3.2% | 20 | 250/250/300 | 218.4 |
| CPC-22 | 15.1% | 0.026% | 51.2% | 0.56% | 13.4% | 19.8% | 10 | 250/250/300 | 200.0 |
| CPC-23 | 44.1% | 0.022% | 13.0% | 0.48% | 39.2% | 3.3% | 20 | 250/250/300 | 198.4 |
| CPC-24 | 43.3% | 0.029% | 13.2% | 0.97% | 38.5% | 4.0% | 20 | 350/350/400 | 191.9 |
| CPC-25 | 43.3% | 0.026% | 13.2% | 0.97% | 38.5% | 4.0% | 20 | 250/250/300 | 157.4 |
| CPC-26 | 44.1% | 0.022% | 13.0% | 0.48% | 39.2% | 3.3% | 20 | 350/350/400 | 151.0 |
| CPC-27 | 30.6% | 0.031% | 30.6% | 0.60% | 27.2% | 11.0% | 10 | 250/250/300 | 138.4 |
| CPC-28 | 30.6% | 0.031% | 30.6% | 0.60% | 27.2% | 11.0% | 20 | 350/350/400 | 86.1 |
| CPC-29 | 15.1% | 0.026% | 51.2% | 0.56% | 13.4% | 19.8% | 20 | 250/250/300 | 37.4 |
| CPC-30 | 15.3% | 0.034% | 50.0% | 1.12% | 13.5% | 20.1% | 10 | 350/350/400 | 32.9 |
| CPC-31 | 15.8% | 0.033% | 50.6% | 0.27% | 14.0% | 19.2% | 20 | 250/250/300 | 31.9 |
| CPC-32 | 15.3% | 0.034% | 50.0% | 1.12% | 13.5% | 20.1% | 10 | 250/250/300 | 20.0 |
| CPC-33 | 15.3% | 0.030% | 50.0% | 1.12% | 13.5% | 20.1% | 10 | 350/350/400 | 11.3 |
| CPC-34 | 30.3% | 0.024% | 30.3% | 1.04% | 26.9% | 11.5% | 20 | 250/250/300 | 7.7 |
| CPC-35 | 23.3% | 0.031% | 39.9% | 0.85% | 20.7% | 15.3% | 10 | 250/250/300 | 0.0 |
| CPC-36 | 30.6% | 0.031% | 30.6% | 0.60% | 27.2% | 11.0% | 20 | 250/250/300 | 0.0 |
| CPC-37 | 15.3% | 0.034% | 50.0% | 1.12% | 13.5% | 20.1% | 20 | 250/250/300 | 0.0 |
| CPC-38 | 23.3% | 0.031% | 39.9% | 0.85% | 20.7% | 15.3% | 20 | 250/250/300 | 0.0 |
| CPC-39 | 30.3% | 0.024% | 30.3% | 1.04% | 26.9% | 11.5% | 20 | 350/350/400 | 0.0 |
| CPC-40 | 30.3% | 0.024% | 30.3% | 1.04% | 26.9% | 11.5% | 20 | 350/350/400 | 0.0 |

*De-ionized water

Samples CPC-1 to CPC-27 demonstrated acceptable levels of polymer release capability to be characterized as a fast activating clay-polymer granule. A concentration of 100 PPM (parts per million by weight) after 4 hours in deionized water is acceptable and a concentration of >500 PPM after 4 hours is preferred.

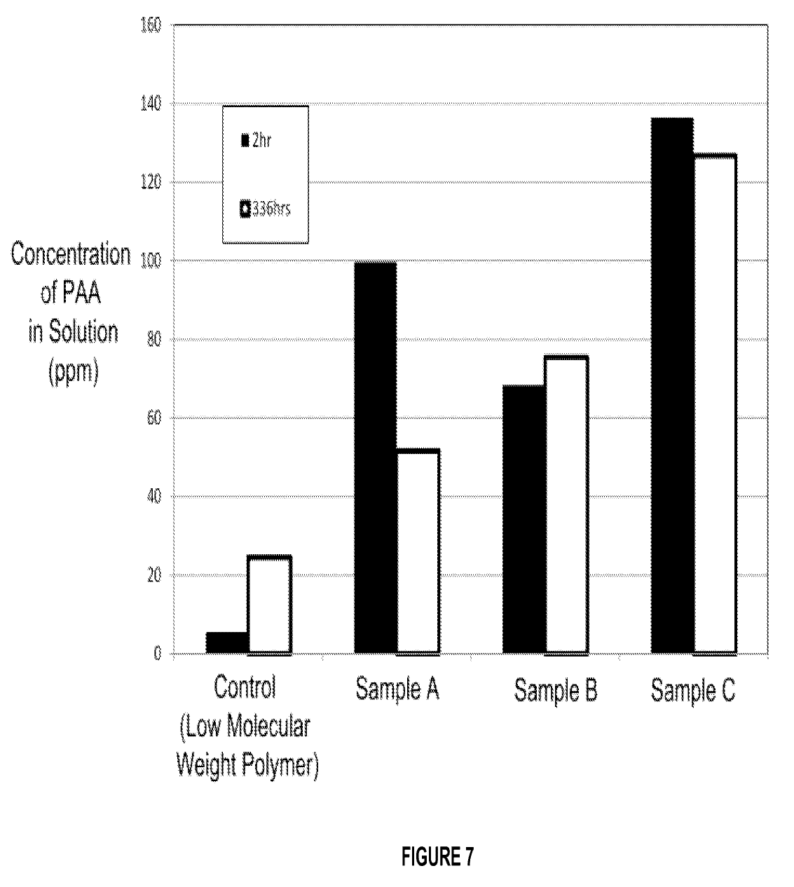

As illustrated in FIGS. 7-10, a subsequent test was performed in which select CPC (clay-polymer composite) formulations were tested in aggressive leachates. These leaching tests were similar to the prior Polymer Activation Tests except that the mass of CPC in the pouch was varied to keep total polymer content in the system was fixed at 7 grams, where the prior Polymer Activation Tests were performed with varying polymer loads depending on the formulation of the CPC. In this way, the CPC samples could be compared to a low molecular weight polymer control. Three leaching solutions were prepared where a high pH, a low pH and a 500 mmol CaCl₂.

Based on these tests it was determined that the amount of cross-linking agent and the temperature during polymerization had the most significant effect on the performance of the clay-polymer granules. In particular, it was determined that the clay-polymer granules would most quickly activate with lower polymerization temperatures and lower amounts of cross-linking agent. The temperature needs to be sufficiently high, however, to allow for polymerization of the monomer. Surprisingly, it was determined that increasing the clay content also promoted higher release rates of active material at a given monomer composition. Table 6 below provides a theoretically determined set of ranges for the composition and processing conditions, which is believed to produce clay-polymer granules having high polymer activity in the elution test.

TABLE 6
Theoretically Determined Optimized Composition
and Processing Conditions

| Material/Processing | | | |
|---|---|---|---|
| Condition | Function | Range | |
| Acrylic Acid, 99% | Organic monomer | 22.11-75.13 | wt % |
| N′N′ Methylene-bisacryl- | Cross-linking | 0.0382-0.0489 | wt % |
| amide, 99% (MBA) | agent | | |
| Sodium Bentonite Clay | Clay | 22.11-75.13 | wt % |
| 30% Sodium Persulfate, | Initiator | 1.35-5.42 | wt % |
| 98+% | | | |
| Belt Speed | — | 10-20 | ft/min |
| Oven Temperature | — | 275-375° | F. |
| Granule Size | — | 6-320 | mesh |

Based on these relationships, the compositions and processing conditions for forming the clay-polymer granules were particularly selected to achieve high activity during the elution test. Table 7 below provides the composition and processing conditions of these clay-polymer granules.

TABLE 7
Clay-Polymer Granules Produced to Gauge
Activity During the Elution Test

| | | | | | | | Predicted |
|---|---|---|---|---|---|---|---|
| | | | | | | | 4 hour |
| | Acrylic | | | Sodium | Belt | | Active |
| Sam- | Acid, | | | Persul- | Speed | Oven | Material |
| ple | 99% | MBA | Clay | fate | (ft/ | Temp | Release |
| No. | (wt %) | (wt %) | (wt %) | (wt %) | min) | (° F.) | (ppm) |
| 51 | 74.76 | 0.04 | 23.63 | 1.56 | 10 | 375 | 630 |
| 52 | 73.63 | 0.05 | 24.71 | 1.61 | 10 | 375 | 634 |
| 53 | 72.59 | 0.05 | 25.93 | 1.44 | 10 | 375 | 633 |
| 54 | 75.01 | 0.04 | 23.53 | 1.42 | 20 | 375 | 642 |
| 55 | 73.66 | 0.04 | 24.90 | 1.40 | 20 | 375 | 629 |
| 56 | 70.81 | 0.05 | 27.79 | 1.36 | 20 | 375 | 629 |
| 57 | 71.92 | 0.04 | 26.68 | 1.36 | 20 | 375 | 629 |
| 58 | 73.87 | 0.04 | 24.65 | 1.44 | 10 | 275 | 625 |
| 59 | 74.89 | 0.04 | 23.59 | 1.48 | 10 | 275 | 628 |
| 60 | 74.86 | 0.04 | 23.74 | 1.36 | 20 | 275 | 624 |
| 61 | 67.58 | 0.04 | 31.03 | 1.35 | 10 | 275 | 577 |
| 62 | 64.56 | 0.04 | 34.06 | 1.35 | 20 | 375 | 552 |
| 63 | 58.15 | 0.04 | 40.46 | 1.35 | 10 | 375 | 501 |
| 64 | 50.68 | 0.04 | 47.93 | 1.35 | 10 | 275 | 445 |
| 65 | 49.48 | 0.04 | 49.13 | 1.35 | 20 | 275 | 430 |
| 66 | 47.29 | 0.04 | 51.32 | 1.35 | 10 | 375 | 421 |
| 67 | 41.7 | 0.04 | 56.92 | 1.35 | 20 | 375 | 382 |

A regression analysis of the variables associated with the polymerization conditions and formula with the release response allowed for the development of a predictive transfer function. This transfer function allowed the inventors to calculate the predicted 4-hr Active Material release values which are listed in Table 6.

### Example 4

### Molecular Weight Testing

The molecular weight distribution of the polymer of the clay-polymer granules in accordance with embodiments of the disclosure was analyzed. This analysis confirms that upon contact with water, a portion of the polymer having a low molecular weight dissolves, disperses, or both dissolves and disperses in water and travels through the clay, temporarily clogging the clay pores and platelets to provide an immediate impermeability. The low molecular weight polymer chains eventually pass through the clay, but allow sufficient time for high molecular weight polymer chains to dissolve, disperse, or both dissolve and disperse in water and become entrapped (more permanently) in the clay platelets and pores to provide a more permanent and long-lasting impermeability.

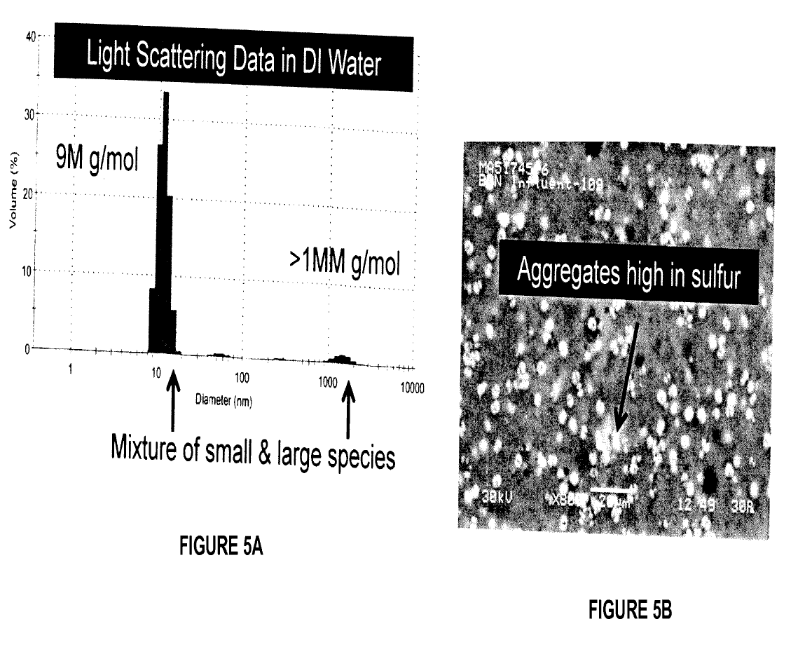

The CPC-1 granules were subjected to a permeability test in deionized water according to ASTM D 5084 with an average effective stress of 20 kPa and a hydraulic gradient of 200. The outlet water was collected in a bladder accumulator and analyzed using a Malvern Nano-ZS® zetasizer. The particle/molecular size distribution information from the Malvern Nano-ZS zetasizer, shown in FIG. 5A, shows a bimodal distribution of polymers with a large population of low molecular weight samples and a small population of high molecular weight species. This analysis confirms that upon contact with water, a portion of the polymer having a low molecular weight dissolves, disperse, or both dissolves and disperses in water and travels through the clay pores and platelets to provide an immediate impermeability. The low molecular weight polymer chains eventually pass through the clay, but allow sufficient time for high molecular weight polymer chains to dissolve, disperse, or both dissolve and disperse in water and become entrapped (more permanently) in the clay platelets and pores to provide a more permanent and long-lasting impermeability. The outlet water from the bladder accumulator was dried for analysis by scanning electron microscopy/energy dispersive X-ray Spectroscopy (SEM/EDS). The dried polymer sample from the outlet accumulator shows the presence of a small amount of aluminosilicate clay that is rich in sulfur. This data indicates that there may be some chemical bonds formed between the polymer and the clay to further aid in the process of blocking the pores in between the clay granules.

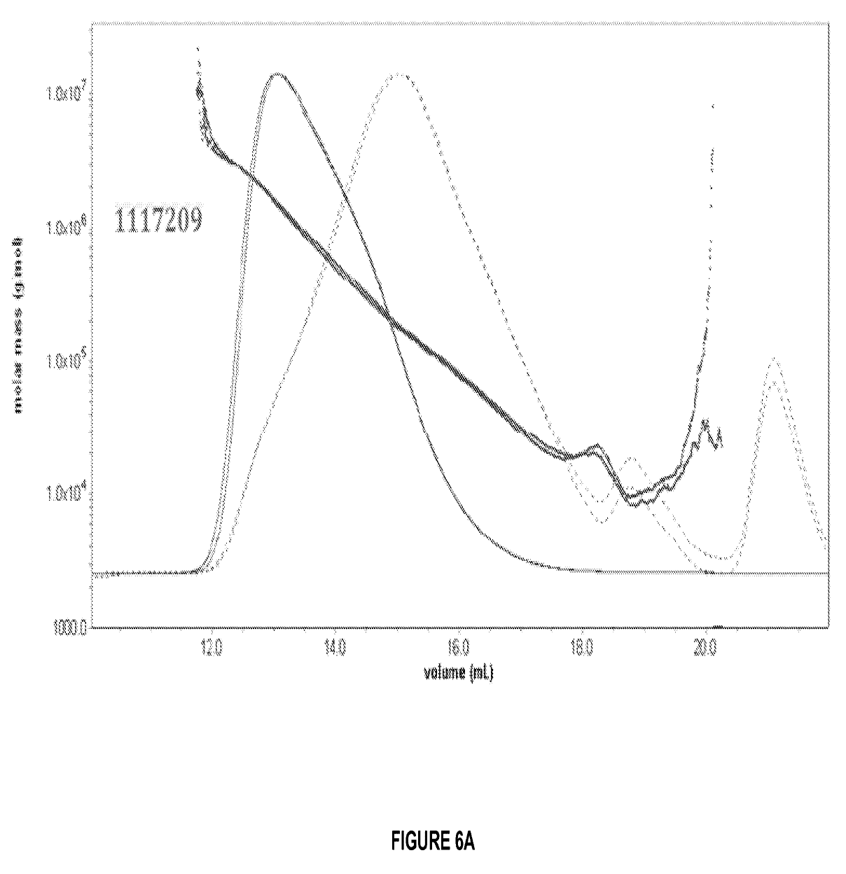

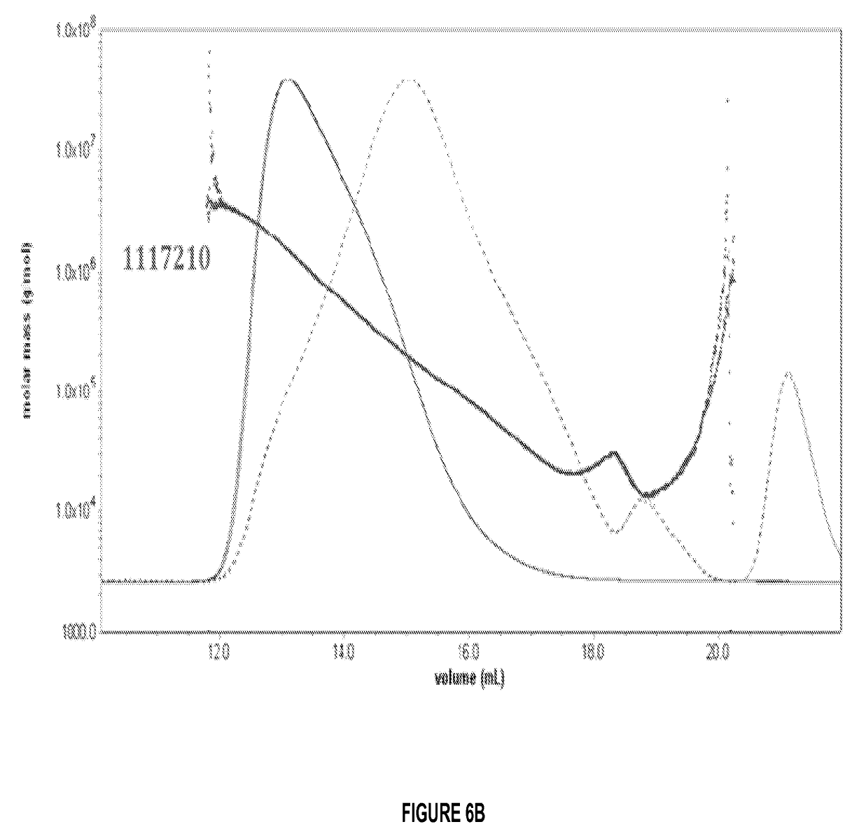

Further molecular weight testing of the CPC-1 sample by size exclusion chromatography using a multiple angle laser light scattering detector was performed on the polymer solutions isolated on both the inlet side and the outlet sides of the permeability experiment. Results of the analysis are shown in Table 8, below, and in FIGS. 6A and 6B. The data shown in FIGS. 6A (inlet side) and 6B (outlet side) show that the molecular weight distribution changes as the polymers pass through the hydraulic barrier. The analysis of the chromatograms detailed in Table 8 shows that the polydispersity index decreases from 6 to 4 as the polymers pass through the hydraulic barrier. Comparison of the size exclusion chromatography traces shows that the polymer collected on the outlet side of the experiment contained less low molecular weight and high molecular weight species.

TABLE 8
Molecular Weight Change from Influent to Effluent

| Sample | Injection | Molecular Weight Averages (g/mol) | | | |
|---|---|---|---|---|---|
| Number | No. | Mₙ | M_{w} | M_{z} | M_{w}/Mₙ |
| Influent | 1 | 53,980 | 280,100 | 954,700 | 5.19 |
| (1117209) | 2 | 47,400 | 282,300 | 924,300 | 5.96 |
| | Average | 50,690 | 281,200 | 939,500 | 5.57 |
| | Std. Dev. | 4,653 | 1,556 | 21,496 | 0.54 |
| Effluent | 1 | 61,820 | 294,200 | 920,00 | 4.76 |
| (1117210) | 2 | 61,730 | 293,600 | 917,400 | 4.76 |
| | Average | 61,775 | 293,900 | 918,700 | 4.76 |
| | Std. Dev. | 64 | 424 | 1838 | 0 |

The results demonstrate that the molecular weight of the effluent polymer is attenuated, which indicates that lower-molecular weight polymer chains are activating quickly upon contact with water. These polymers are smaller and more mobile, which may allow them to interact with more areas of the clay galleries and increase their likelihood of interacting with binding sites on the clay. From the size exclusion chromatography data (using the multiple angle laser light scattering detector), it is believed that polymer chains having a molecular weight less than 6×10⁴ g/mol (i.e., “low molecular weight polymer chains”) are strongly interactive. Very high molecular weight polymers would be expected to be slower to hydrate and also move more slowly through the clay pores due to their coil dimensions in solution. Polymer chains having molecular weights greater than 9×10⁵ g/mol (as determined by SEC-MALLS) (i.e., “very large molecular weight polymer chains”) were less likely to elude from the clay barrier. The “medium sized chains” are more mobile and can elude more easily.

### Example 5

### Polymer Activation Testing in Aggressive Leachate

The elution test described in Example 3 above was used to evaluate the polymer activation of the clay-polymer granules in an aggressive environment. A commercially available, low molecular weight polymer (250,000 M_{w} NAPAA) was used as a control. The commercial polymer had a similar molecular weight to what was experimentally determined as the molecular weight of the polymer chains eluted from the clay-polymer granules during the activity test. Three clay-polymer granule samples were also analyzed. The compositions of the three clay-polymer granule samples are provided in Table 9, below. The samples B and C were prepared using a zoned, production line oven having an average temperature of 375° F., with the first and second zones being set to 350° F. and the third zone being set to 400° F. The oven zones are approximately 20 ft long with a residence time in each zone of approximately 2.5 minutes. Sample A was produced using a lab-sized oven, and prepared as described in Example 1. Samples B and C were prepared as described in Example 2. The composition and processing conditions for Sample C were optimized as described in Example 3.

TABLE 9
Clay-Polymer Composition

| | Sample A | Sample B | Sample C |
|---|---|---|---|
| | (wt %) | (wt %) | (wt %) |
| Acrylic Acid, 99% | 11.41 wt % | 11.41 wt % | 43.85 wt % |
| MBA (crosslinking | 0.03 wt % | 0.03 wt % | 0.03 wt % |
| agent) | | | |
| Deionized Water | 38.90 wt % | 38.90 wt % | 3.23 wt % |
| Sodium Hydroxide | 9.5 wt % | 9.5 wt % | 38.95 wt % |
| Clay | 38.76 wt % | 38.76 wt % | 13.70 wt % |
| Sodium Persulfate | 1.4 wt % | 1.4 wt % | 0.24 wt % |
| | 375° F. | 375° F. | 375° F. |
| Oven Temp | (Lab-oven) | (zoned, | (zoned, |
| | | production | production |
| | | line oven) | line oven) |

FIG. 7 illustrates the results of the elution test performed in 500 mmol CaCl₂, with concentration samples being taken at 2 hours (black bars) and 336 hours (white bars). As demonstrated in FIG. 7, the control—low molecular weight polymer alone—did not activate quickly when exposed to an aggressive environment. The clay-polymer granules demonstrate significantly increased release of polymer in the short time frame (2 hour measurement) as compared to the control sample. Sample C demonstrated improved short and long term polymer release as compared to Samples A and B.

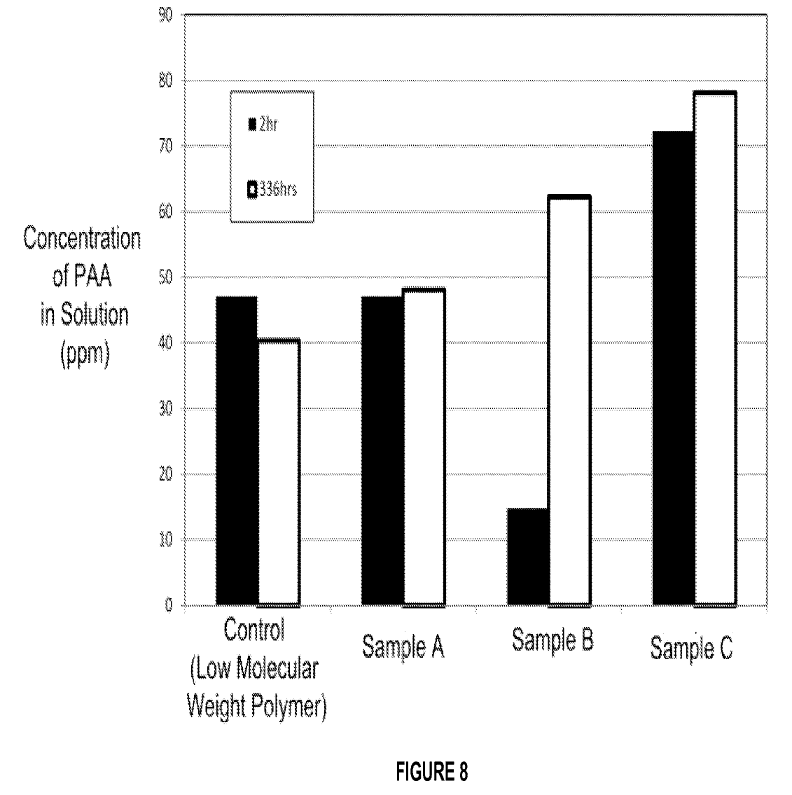

FIG. 8 illustrates the results of the activity test for a low pH (pH=1.5) leachate. Sample C demonstrated significantly improved short and long term elution as compared to the other samples. Sample A demonstrated comparable initial, short term results as the low molecular weight polymer, but improved long term results. Sample B demonstrated improved long term elution results as compared to the control. These results demonstrate that the composition and the processing parameters (optimized in Sample C) can significantly affect the performance of the clay-polymer granules in various aggressive environments.

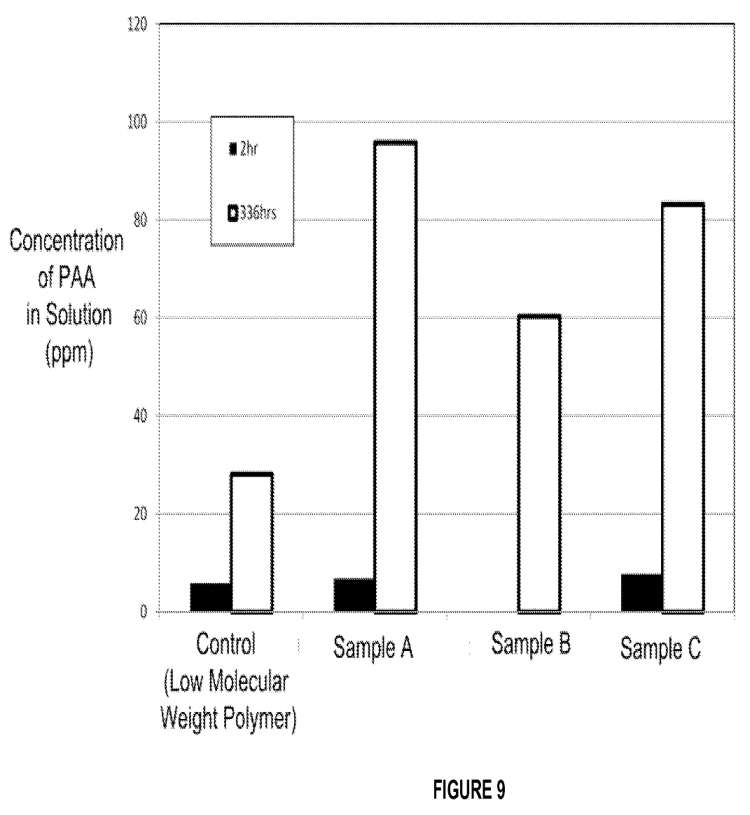

FIG. 9 illustrates the results of the elution test in a high pH (pH=11) leachate. These results demonstrate that the clay-polymer granules in accordance with embodiments of the invention are capable of activating quickly upon contact with an aggressive leachate. These results further demonstrate that providing low-molecular weight polymer alone does not result in a composition that quickly activates. Without intending to be bound by theory, it is believed that the presence of both high and low molecular weight polymers in the clay-polymer granules, as well as the presence of the clay results in the ability of the granules to quickly activate in aggressive environments.

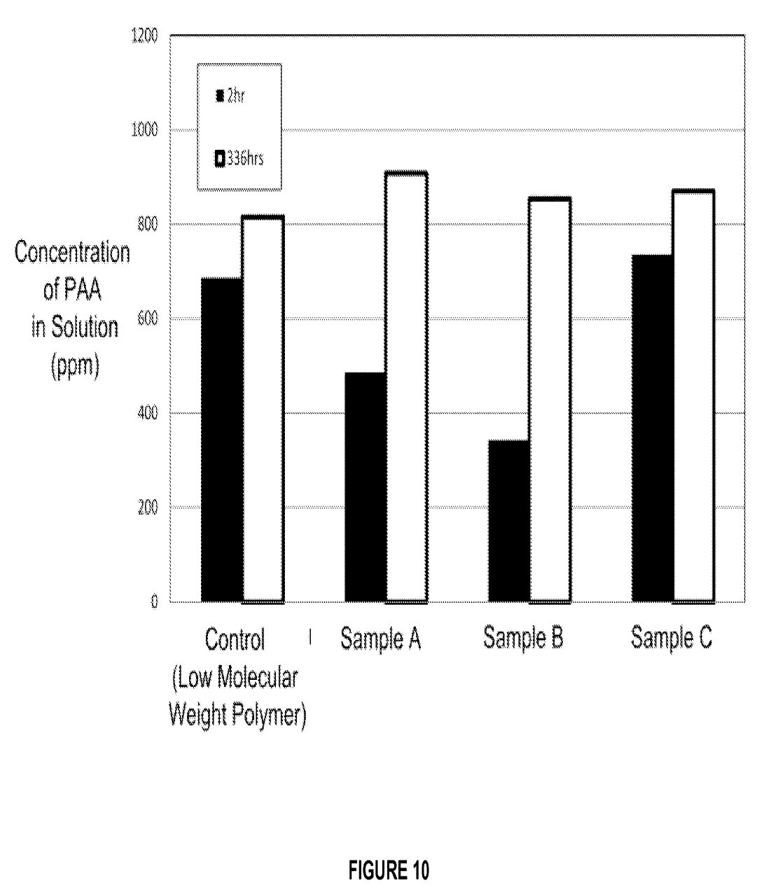

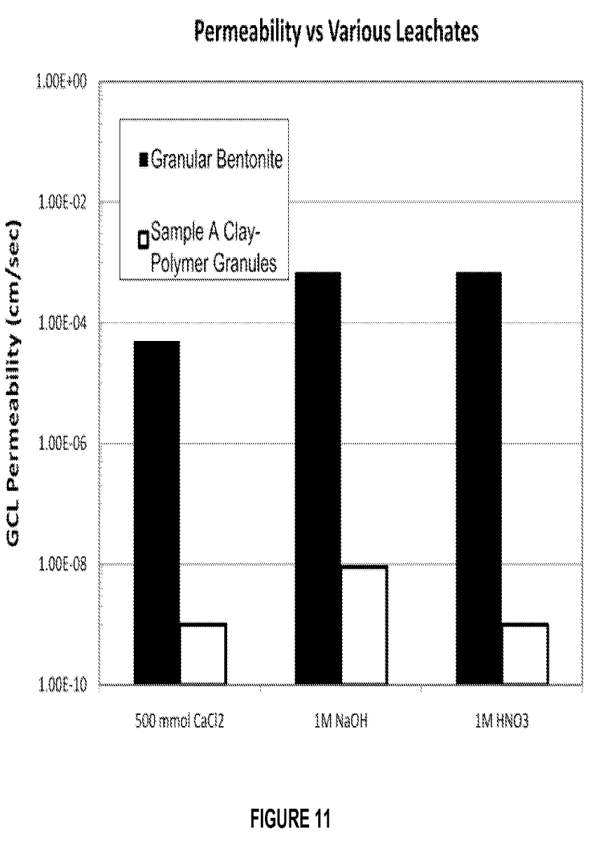

FIG. 10 illustrates the results of the elution test in deionized water. The more comparable performance of the samples in accordance with embodiments of the invention and the control demonstrates that unpolymerized monomer in the clay-polymer granules is not the cause of the improved performance in aggressive leachates. FIG. 11 is a comparison of the permeability of a hydraulic barrier formed using granules of sample A and a hydraulic barrier formed using the control (bentonite clay without polymer). The hydraulic barrier containing Sample A demonstrates significantly improved (i.e., lower) permeability in a variety of aggressive leachates as compared to the control.

### Example 6

Clay-polymer granules formed in accordance with Example 1 were incorporated into geosynthetic clay liner (GCL) samples and permeability tested in various leachates. Each of the GCL samples included clay-polymer granules formed in accordance with Sample C described in Example 5. The clay-polymer granules in each sample had a size (diameter) of about 14 mesh to about 200 mesh (about 70 to 1400 microns) because the particles used were those passing through the 14 mesh screen and retained on the 200 mesh screen. The clay/polymer granules were mixed with various amounts of clay such that the total polymer content in the various samples ranged from 2% to 41% (See Table 10A). Additionally, the samples were prepared by needle punching two sheets having the composition disposed there between, with a needle punching density of about 20800 punches/ft². The samples had a total additive loading of 0.91 lbs/ft². Tables 10A and 10D below provide the results of the testing. Each of the clay-polymer compositions were subjected to a leachate and tested to according ASTM D6766 to determine the permeability (cm/sec) of the compositions in the tested leachate. The samples were subjected directly to the leachate and were not prehydrated in deionized water.

In Table 10A, the clay-polymer granules were tested in an aggressive coal combustion residual (CCR) leachate. The leachate has an RMD value of 1.19, an ionic strength of 2.0, and a pH of 7.3. Each of the tested samples were formed by needle punching two sheets having the hydraulic barrier composition disposed therebetween. For comparison, several samples were made with commercially available polymers. LIQUISORB® (CETCO, IL) is a commercially available sodium acrylate based cross-linked superabsorbent polymer. Low molecular weight linear sodium polyacrylate polymers (6K, 60K and 250K weight average molecular weight (M_{w})) were obtained from Polysciences Inc in solution form, which were dried and sized to 14-80 mesh prior to use. High molecular weight linear sodium polyacrylate was obtained in the dry acid form from Sigma Aldrich, Inc. and neutralized to approximately 60% using a sodium hydroxide solution. The linear sodium polyacrylates were included in equivalent parts if multiple molecular weights were used. For the comparison samples that include the linear sodium polyacrylates, the ratio of cross-linked polymer (Liquisorb) to linear polymer was 66/34. The mesh size for the additives used as listed in Table 10A.

TABLE 10A
Permeability Testing in CCR Leachate

| | | | Total Additive | Needling | |
|---|---|---|---|---|---|
| | | | Loading | Density | |
| | Mesh size | Polymeric | (polymer + | (punches/ln | Perm |
| | of granules | content | clay) (lbs/ft²) | ft) | (cm/sec) |
| Clay/Polymer | 14-200 | 2% | 0.91 | 20800 | 6.64E−07 |
| Sample C (Granule) | | | | | |
| Clay/Polymer | 14-200 | 5% | 0.91 | 20800 | 8.88E−07 |
| Sample C (Granule) | | | | | |
| Clay/Polymer | 14-200 | 12% | 0.91 | 12695 | 9.61E−09 |
| Sample C (Granule) | | | | | |
| Clay/Polymer | 14-200 | 12% | 0.91 | 20800 | 6.84E−10 |
| Sample C (Granule) | | | | | |
| Clay/Polymer | 14-80 | 17% | 0.97 | 20800 | 1.19E−10 |
| Sample C (Granule) | | | | | |
| Clay/Polymer | 200-325 | 12% | 0.91 | 12580 | 3.84E−06 |
| Sample C (powder) | | | | | |
| Clay/Polymer | 200-325 | 25% | 0.91 | 12580 | 2.24E−07 |
| Sample C (powder) | | | | | |
| Clay/Polymer | 200-325 | 41% | 0.91 | 12580 | No Out Flow |
| Sample C (powder) | | | | | |
| LIQUISORB SAP | 25-100 | 15% | 0.91 | 20800 | 4.67E−07 |
| LIQUISORB SAP + | 25-100 | 13% | 0.91 | 20800 | 3.70E−07 |
| NaPAA (250K) | | | | | |
| LIQUISORB SAP + | 25-100 | 15% | 0.91 | 20800 | 2.67E−07 |
| NaPAA (6, 60, 4000K) | | | | | |

As demonstrated in Table 10A, the clay-polymer granules in accordance with the disclosure provided improved permeability with lower polymer loading.

As shown in Table 10B, synthetic leachates were formulated with chemistries considered to be representative of the various types of end-use applications. Leachates A-F, Trona, CCR, FGD and High Ionic Strength, Synthetic High Chloride FGD and Wet/Dry Low RMD represent leachates that could be expected from the bi-products of burning coal. FGD stands for Flue Gas Desulfurization. Several methods are used by coal burning power plants to remove sulfuric acid from the flue gas. One method involves the use of calcium hydroxide (lime) solution in water injected as a liquid. The calcium hydroxide reacts with sulfuric acid to produce water and calcium sulfate (gypsum). This process is called Flue Gas Desulfurization (FGD) and connotes the use of the CaOH₂ slurry. The resulting coal ash leachate can be high in calcium and sometimes high in pH. Another method of scrubbing involves the use trona (a mixture of sodium carbonate and sodium bicarbonate) injected as a dry powder. The carbonate reacts with sulfuric acid to produce water, CO₂ and sodium sulfate. The resulting coal ash is high in sodium sulfate and can also be high in pH. Other types of coal ash are the fly ash, bottom ash and boiler slag that are obtained from the dust collectors, furnace and boiler respectively. Each of these coal combustion residuals (CCRs) can yield a range of chemistries depending on the coal source and design of the power plant. The nickel and uranium leachates represent the liquors or tailings residue associated with the processing of the respective ores. The leachates shown in Table 10B range in ionic strength from 0.1 to 7.8 mol/liter, pH values from 0.9 to 10.9 and RMD values of 0.02 to 38.5 mol/L̂0.5.

TABLE 10B
Chemical Composition of the Various Testing Leachates

| | Synthetic Leachates | | | | | | | | | | | |
|---|---|---|---|---|---|---|---|---|---|---|---|---|
| | | | | | | | | | | High Ionic | | |
| | A | B | C | D | E | F | TRONA | CCR | FGD | Strength | URANIUM | NICKEL |
| Chemical | Conc | Conc | Conc | Conc | Conc | Conc | Conc | Conc | Conc | Conc | Conc | Conc |
| Formula | (mol/L) | (mol/L) | (mol/L) | (mol/L) | (mol/L) | (mol/L) | (mol/L) | (mol/L) | (mol/L) | (mol/L) | (mol/L) | (mol/L) |
| Al2SO43 | | | | | | | | | | | 0.091 | 0.056 |
| NH42SO4 | | | | | | | | | | | 0.186 | |
| CaCl2 | | | 0.016 | 0.007 | 0.004 | 0.007 | 0.001 | 0.039 | 0.06 | 0.356 | 0.043 | 0.012 |
| CaSO4 | 0.01 | 0.01 | 0.01 | 0.01 | 0.01 | 0.01 | | | | | 0.003 | |
| Cr2(SO4)3 | | | | | | | | | | | | 0.003 |
| CoCl2 | | | | | | | | | | | | 0.003 |
| CuSO4 | | | | | | | | | | | | 0 |
| Fe2SO43 | | | | | | | | | | | 0.053 | 0.18 |
| MgCl2 | | | | | | | | 0.072 | | | 0.161 | |
| MgSO4 | 0.054 | | 0.066 | 0.052 | 0.015 | 0.033 | | | | | | 0.823 |
| MnCl2 | | | | | | | | | | | 0.002 | |
| MnSO4 | | | | | | | | | | | | 0.018 |
| NiCl2 | | | | | | | | | | | | 0.068 |
| KCl | | | | | | | | | | | | 0.001 |
| K2SO4 | 0.003 | 0.003 | 0.003 | 0.003 | | | | 0.007 | | | 0.035 | |
| NaCl | | | | | | | 0.97 | 0.272 | 0.015 | 0.192 | | |
| NaOH | 0.001 | 0.001 | | | | | 0.003 | | | | | |
| Na2SO4 | 0.249 | 0.315 | 0.012 | 0.039 | 0.001 | 0.002 | | 0.136 | | | 0.393 | 0.033 |
| H2SO4 | | | | | | | | | | | 0.013 | 0.158 |
| ZnCl2 | | | | | | | | | | | 0.003 | |
| ZnSO4 | | | | | | | | | | | | 0.001 |
| RMD | 2 | 6.31 | 0.1 | 0.31 | 0.02 | 0.02 | 38.47 | 1.67 | 0.06 | 0.32 | 1.35 | 0.32 |
| (mol/L)\hat{ }0.5 | | | | | | | | | | | | |
| [I] (mol/L) | 1.01 | 1 | 0.39 | 0.4 | 0.12 | 0.2 | 0.98 | 1.04 | 0.19 | 1.26 | 0.95 | 7.77 |
| pH | 9.8 | 10.6 | 6.3 | 6.9 | 6.7 | 6.4 | 10.87 | 7.27 | 10.4 | 10.3 | 1.7 | 0.9 |

| | Synthetic Leachates | |
|---|---|---|
| Chemical | Syn. High Chloride FGD | Wet/Dry Low RMD |
| Formula | Conc (mol/L) | Conc (mol/L) |
| Al2SO43 | | |
| NH42SO4 | | |
| CaCl2 | 0.449 | 0.008117 |
| CaSO4 | | |
| Cr2(SO4)3 | | |
| CoCl2 | | |
| CuSO4 | | |
| Fe2SO43 | | |
| MgCl2 | | |
| MgSO4 | | |
| MnCl2 | | |
| MnSO4 | | |
| NiCl2 | | |
| KCl | 0.0256 | |
| K2SO4 | | |
| NaCl | | 0.000631 |
| NaOH | 0.0331 | |
| Na2SO4 | | |
| H2SO4 | | |
| ZnCl2 | | |
| ZnSO4 | | |
| RMD | 0.08 | 0.007 |
| (mol/L)\hat{ }0.5 | | |
| [I] (mol/L) | 2.27 | 0.025 |
| pH | 11.5 | 6.2 |

Table 10C demonstrates leachates from actual sites where a concentrated brine solution from a mining site and a bauxite liquor from an aluminum mine were obtained. The chemistry of the leachates was analyzed by inductively coupled plasma (ICP) to determine the concentration of the major cation species. The ICP data was used to provide an estimate of the RMD. Electrical conductivity was used to provide an estimate of the ionic strength where the ionic strength (expressed in mol/L) is equal to electrical conductivity (expressed in microsiemens per centimeters divided) by 60,800.

TABLE 10C
Chemical Composition of the Actual Site Leachates

| ACTUAL SITE | BAUXITE | BRINE |
|---|---|---|
| LEACHATES | LIQUOR | POND |
| Major Cations | Conc (mol/L) | Conc (mol/L) |
| Na+ | 4.73E−01 | 5.96E−01 |
| Al | 1.62E−01 | |
| K+ | 3.28E−04 | |
| Mg2+ | 2.05E−06 | 2.51E−01 |
| Fe+2 | 8.95E−07 | |
| Ca2+ | 4.42E−05 | 2.15E−01 |
| Est. RMD (mol/L)\hat{ }0.5 | 1.2 | 0.87 |
| Electrical conductivity | 42,300 | 133,000 |
| (μS/cm) | | |
| Est. Ionic Strength | 0.70 | 2.19 |
| pH = | 12 | 10.3 |

Table 10D provides the permeability testing results of the 14-200 mesh Sample C GCL, where the clay/polymer granule to clay was 85:15 (total polymer loading was 12%) in these various leachates.

TABLE 10D
Permeability Testing in Various Leachates for a GCL with
15% CPC content and 0.91 lbs/ft² total additive loading

| | | | | |
|---|---|---|---|---|
| | | Ionic | | |
| | RMD | strength | | PERM |
| Leachate | (mol/L)\hat{ }0.5 | (mol/L) | pH | (cm/sec) |

| | | | | |
|---|---|---|---|---|
| LEACHATE A | 2.00 | 1.01 | 9.8 | 1.80E−10 |
| LEACHATE B | 6.31 | 1.00 | 10.6 | 2.74E−10 |
| LEACHATE C | 0.10 | 0.39 | 6.3 | 1.50E−10 |
| LEACHATE D | 0.31 | 0.40 | 6.9 | 7.29E−10 |
| LEACHATE E | 0.02 | 0.12 | 6.7 | 2.69E−10 |
| LEACHATE F | 0.02 | 0.20 | 6.4 | 2.57E−10 |
| TRONA | 38.47 | 0.98 | 10.87 | 2.14E−10 |
| FGD | 0.06 | 0.19 | 10.4 | 4.07E−10 |
| HIGH IONIC | 0.32 | 1.26 | 10.3 | 1.76E−06 |
| STRENGTH | | | | |
| BAUXITE | 1.2 | 1.71 | 12.02 | 1.0E−09 |
| LIQUOR | | (Est) | | |

As illustrated in Table 10D the hydraulic barriers in accordance with the disclosure provide good permeability results in a variety of leachates, demonstrating that the hydraulic barriers in accordance with the disclosure can be used in a variety of aggressive industrial environments.

### Example 7

### Hydraulic Barrier Arrangement

Referring to FIGS. 12A and 12B, the arrangement of the clay-polymer granules relative to granular bentonite clay in a hydraulic barrier was examined. Referring to FIG. 12 A, a hydraulic barrier was formed by placing a layer of clay-polymer granular after (in the direction of flow) the granular bentonite clay. Referring to FIG. 12B, a hydraulic barrier was formed by placing a layer of clay-polymer granular before (in the direction of flow) the granular bentonite. The hydraulic barrier compositions each include 2 wt. % clay-polymer granules and 98 wt % granular bentonite. The hydraulic conductivity tests were run using 50 mM CaCl₂ as the leachate. It was observed that placing the clay-polymer granules before the granular bentonite resulted in a significant reduction (improvement) in permeability. The hydraulic conductivity of the hydraulic barrier having the clay-polymer granules placed before the granular bentonite was 3×10⁻¹¹ m/sec, while the hydraulic conductivity for the hydraulic barrier having the clay-polymer granules disposed after the granular bentonite was 4×10⁻⁸ m/sec. Further testing was run on a hydraulic barrier having a mixture of 2 wt. % Sample A clay-polymer granules and 98 wt % granular bentonite provided as a single, pre-mixed layer. This hydraulic barrier had a slightly improved hydraulic conductivity of 5×10⁻¹¹ m/s, as compared to the hydraulic barrier providing the clay-polymer granules as a separate layer before the granular bentonite.

### Example 8

### Clay-AMPS Polymer Granules

Clay-polymer granular compositions were formed using the ingredients and amounts shown in Table 11, below.

TABLE 11
Clay-AMPS Polymer Compositions

| | | | Amount |
|---|---|---|---|
| | Material | Function | (wt %) |
| 100% | 2-acrylamido-2-methylpropane | Monomer | 48.0% |
| AMPS- | sulfonic acid | | |
| CPC-41 | N′N′ methylene-bisacrylamide | Cross-linker | 0.011% |
| | Deionized water | Water | 23.94% |
| | 50% NaOH | Neutralizing | 18.53% |
| | | agent | |
| | Sodium Bentonite Clay | Clay | 16.92% |
| | 30% Sodium Persulfate in water | Initiator | 0.09% |
| | | Total | 100% |
| AMPS/ | 2-acrylamido-2-methylpropane | Monomer | 36.05% |
| COOH - | sulfonic acid | | |
| CPC-42 | Acrylic Acid, 99% | Monomer | 9.73% |
| | N′N′ methylene-bisacrylamide | Cross-linker | 0.015% |
| | Deionized water | Water | 20.03% |
| | 50% NaOH | Neutralizing | 22.56% |
| | | agent | |
| | Sodium Bentonite Clay | Clay | 16.92% |
| | 30% Sodium Persulfate in water | Initiator | 0.12% |
| | | Total | 100% |

The 2-acrylamido-2-methylpropane sulfonic acid (AMPS) monomer was purchased from Sigma Aldrich, Inc. The reaction water was added to a chilled glass vessel at 18 degrees Celsius. While stirring, the AMPS was added in a powder form into the water and mixed until fully dispersed. Methyl ether of hydroquinone (MEHQ) was added as an inhibitor along with the N′N′ methylene-bisacrylamide prior to neutralization. The NaOH solution was added drop-wise while keeping the temperature below 29 degrees Celsius and then allowed to cool to room temperature after neutralization. For the acrylic acid copolymers, the acrylic acid and MBA were added prior to the addition of the AMPS monomer. The clay was then added slowly while mixing using a Sterling Multimixer. The initiator was added and stirred using the Multimixer. About 1 liter of the slurry was placed into a 3 quart baking pan and heated to 190° C. for about 20 minutes. The temperature was then lowered to 110° C. and the polymerized mixture was allowed to remain at the elevated temperature overnight. The resulting material was then broken into smaller chunks and ground to form the clay-polymer granules. Table 11 provides various parameters of the slurry used to form the clay-polymer granules. The clay-polymer granules had a diameter falling in the range of mesh size about 14 to about 80, that is the particles were selected to pass through U.S. sieve 14 and be retained on U.S. sieve size 80. The average diameter of these particles was in the range of about 500 to about 600 microns (micron=micrometer). The clay-polymer granules were mixed with varying levels of granular bentonite and incorporated between two sheet materials at a total loading of 0.91 lbs/ft². The resulting content of the AMPS CPC granules ranged from 9 wt. % up to 15 wt. % of the total of the AMPS CPC granules and bentonite in this example (100%×[AMPS CPC/(AMPS CPC+bentonite)]=9 wt % to 15 wt. %). The samples were then needle punched at a needling density of 20800 punches/ft² to form a hydraulic barrier for testing.

The needle punched GCL samples were evaluated for permeability. The permeability experiments were conducted according to ASTM D 6766 with an average effective stress of 20 kPa and a hydraulic gradient of 200. Various aggressive leachates having low pH and high ionic strengths were tested. To further demonstrate the versatility of the clay-AMPS polymer granules, the permeability was also tested in a high pH leachate, brine pond leachate. Each of the leachates tested below represents leachates in which conventional clay liners do not perform adequate and/or require prehydration. The results of the permeability testing are illustrated in Table 12, below:

TABLE 12
Permeability Testing of the Clay-AMPS Polymer Granules

| | | | | | | |
|---|---|---|---|---|---|---|
| | | | | | Weight % | |
| | | Leachate | | | CPC | |
| | Leachate | ionic | | | Loading | |
| | RMD | strength | | CPC | in the | PERM |
| Leachate | (mol/L)\hat{ }0.5 | (mol/L) | pH | Type | Mixture | (cm/sec) |

| | | | | | | |
|---|---|---|---|---|---|---|
| Uranium | 0.95 | 1.35 | 1.7 | CPC-42 | 15 wt. % | 3.23E−10 |
| Leachate | | | | | | |
| Uranium | 0.95 | 1.35 | 1.7 | CPC-42 | 15 wt. % | 1.02E−09 |
| Leachate | | | | | | |
| Nickel | 0.32 | 7.77 | 0.9 | CPC-42 | 15 wt. % | 1.03E−07 |
| Leachate | | | | | | |
| Nickel | 0.32 | 7.77 | 0.9 | CPC-41 | 15 wt. % | 1.55E−10 |
| Leachate | | | | | | |
| Nickel | 0.32 | 7.77 | 0.9 | CPC-41 | 9 wt. % | 5.08E−06 |
| Leachate | | | | | | |
| Brine Pond | 0.87 | 1.78 | 10.3 | CPC-41 | 15 wt. % | 7.48E−10 |
| Leachate | | | | | | |

CPC-42 = AMPS/COOH (50/50) BPA = 2-acrylamido-2-methylpropane sulfonic acid/carboxylic acid at 50 mol %/50 mol % Bentonite Polymer Alloy
CPC-41 = AMPS BPA (100%) = 2-acrylamido-2-methylpropane sulfonic acid 100 mol % Bentonite Polymer Alloy

The clay-polymer granules were further analyzed for free swell using ASTM D5890 and fluid loss using ASTM D5891 in an aggressive nickel leachate. The following compositions were tested and compared: 100 mol % AMPS polymer (no clay), clay-polymer granules with the polymer being 100 mol % (referred to in Table 13 as 100% AMPS with clay) AMPS, clay-polymer granules with the polymer having a 50/50 (mol %/mol %) mixture of AMPS and NaPAA (sodium poly(acrylic acid)) (referred to in Table 13 as 50/50 AMPS/NaPAA with clay), and clay-polymer granules with the polymer having a 30/70 (mol %/mol %) mixture of AMPS and NaPAA (referred to in Table 13 as 30/70 AMPS/NaPAA with clay). Testing was done in accordance with ASTM 5890, with the leachate being substituted for water. The clay-AMPS polymer granules demonstrated high free swell and limited fluid loss in the aggressive leachate. These results further demonstrate that the benefit of containing such aggressive leachates can be realized when combining AMPS with other polymer, provided a sufficient amount of AMPS is present. The results of the testing are illustrated in Table 13, below.

TABLE 13
Free Swell and Fluid Loss Testing

| Composition | Free swell | Fluid Loss |
|---|---|---|
| 100% AMPS (no clay) | 30 | 5 |
| 100% AMPS with clay (CPC- 41) | 100 | 4 |
| 50/50 AMPS/NaPAA with clay (CPC-42) | 66 | 3 |
| 30/70 AMPS/NaPAA with clay | 45 | 32 |

### Example 9

### Additional AMPS Polymer Granules

Additional polymer granules were manufactured. In this case, the polymer was synthesized, dried, and ground prior to being formed into a composite with the clay, or formed into clay-polymer granules. A cross-linking agent, specifically MBA, is dissolved in a solution of the monomers, the monomers being AMPS and optionally one or more other monomers. The solution of cross-linking agent and monomers is neutralized with a 50 weight % solution of sodium hydroxide in water at a rate to maintain the temperature in the mixing vessel to below 105° F. Immediately prior to being pumped onto a PTFE (poly(tetra-fluoroethylene), a.k.a. Teflon®) coated belt at a thickness of 2.5 millimeters, an aqueous solution of 30% by weight sodium persulfate is thoroughly mixed with the neutralized monomer and cross-linking agent mixture. The mixture of monomer, cross-linking agent, and polymerization initiator that has been pumped onto the belt is conveyed on the coated belt through a forced air oven at a speed of 3.1 meters per minute. The oven has four temperature zones: 350° F. (zone 1), 375° F. (zone 2), 400° F. (zone 3), and 450° F. (zone 4). The ingredients and amounts for forming the polymers for the clay-polymer granules are shown in Table 14 below:

TABLE 14
Polymer Compositions for Additional Polymer Granules with AMPS

| | | | | | | | | Ratio of |
|---|---|---|---|---|---|---|---|---|
| | | | | | | | Mol % | Moles |
| | 50% | | | | 30% | MBA² | AMPS | Monomer |
| | NaAMPS¹ | 50% | Acrylic | | Na₂S₂O₈ | (Cross- | in | to Moles |
| ID | soln. | NaOH | Acid | Acrylamide | soln. | linker) | Polymer | Crosslinker |
| P1 | 43.6% | 11.9% | 17.8% | 26.4% | 0.24% | 0.024% | 13.3% | 4511 |
| P2 | 74.3% | | | 25.5% | 0.17% | 0.018% | 31.1% | 4510 |
| P3 | 81.2% | 8.8% | 9.9% | | 0.10% | 0.011% | 56.4% | 4509 |
| P4 | 89.2% | | | 10.7% | 0.11% | 0.012% | 56.4% | 4509 |
| P5 | 89.2% | | | 10.7% | 0.11% | 0.024% | 56.4% | 2255 |
| P6 | 89.2% | | | 10.7% | 0.11% | 0.035% | 56.4% | 1503 |

¹NaAMPS is sodium 2-acrylamido-2-methylpropane sulfonate
²MBA is N,N′-methyl bisacrylamide

The sodium 2-acrylamido-2-methylpropane sulfonate (NaAMPS) in solution is obtained as a 50/50 aqueous solution under the trade name 2403 from Lubrizol. Acrylic Acid (Aldrich grade 147230, 99%) and acrylamide (Sigma, Grade A8887≧99%) were obtained from Sigma-Aldrich.

Once the cross-linked polymer exited the oven, it was fed into a “crunch roller” designed with impinging teeth to break the sheet into “quarter size” pieces, and then subsequently hammer milled. The hammer milled product was sized using a vibratory screener prior to combination with the clay to form a clay-polymer blend or clay-polymer granules. To form other types of granules, the original polymer-based granules can be mixed with another granular material, such as sodium bentonite clay, and bonded together using water. Yet another approach to making polymer clay granules is mixing the original polymer-based granules with another granular material, such as sodium bentonite clay and compacting them together using pressure into new granules. Yet another approach to making polymer clay granules is mixing the original polymer-based granules with another granular material and adding water to agglomerate the particles and subsequently allowing the particles to dry.

The polymer-based granules had a diameter in the range of 14-80 mesh (177 to 1410 microns) because only particles passing through the 14 mesh sieve and retained on the 80 mesh sieve (U.S. sieve sizes) were used. The polymer granules were formed into clay-polymer granules or a clay-polymer composite, or blended with a clay. The clay-polymer granules or blend of polymer granules and clay, along with optional fillers, were incorporated between two sheet materials at a total loading of 0.9 to 1.3 lbs/ft², and the content of the AMPS CPC (clay-polymer composite) granules or content of the blend of clay and polymer was varied to result in a polymer loading of up to 20 wt % in this example where wt % represents % by weight. One optional filler and/or clay used in the blend of clay and polymer granules was CETCO CG-50® which is a natural sodium bentonite clay with a size (diameter) range of approximately 500 microns to 2500 microns (as determined by sieving). Another optional filler and/or clay used in the blend of clay and polymer granules was CETCO MX-80® which is a natural sodium bentonite clay with a size range of approximately 50 to 840 microns. The samples were then needle punched at a needling density of 20,800 punches/ft² to form a hydraulic barrier for testing.

The hydraulic barriers were tested to evaluate the hydraulic conductivity against various leachate types. The permeability experiments were conducted according to ASTM D 6766 with an average effective stress of 20 kPa and a hydraulic gradient of 200. Various aggressive leachates having low pH and high ionic strengths were tested. Table 15 below provides the chemical composition of the leachates tested, and Tables 16A and 16B provide the characteristics of the GCL tested and the results of the permeability, respectively. As shown in Table 16 A, GCL samples AG1-AG22 and AG25-AG31 were physical blends of clay and polymer granules, while examples AG23 and AG24 used clay-polymer granules blended with additional clay granules and/or optional fillers.

TABLE 15
Chemical Composition of the Various Testing Leachates for Additional AMPS clay-polymer granules

| | | | | Real Cu | | | | | |
|---|---|---|---|---|---|---|---|---|---|
| | | | Real Cu³ | Site | Syn.⁴ Cu | Syn. PG⁵ | Syn. PG | Real PG | Real PG |
| | TM¹ | RealV² | Site #1 | #2 | Site #1 | #1 | #2 | #1 | #2 |
| pH | 9.56 | 1.27 | 2.70 | 1.08 | 1.08 | 2.05 | 0.50 | 1.81 | 1.67 |
| Electrical | 133300 | 39800 | 29200 | 45100 | 71000 | 21700 | 160000 | 24500 | 24300 |
| Conductivity | | | | | | | | | |
| (mS/cm) | | | | | | | | | |
| Ag (mg/L) | | | | | | | | | |
| Al (mg/L) | .81 | 2372 | 3484 | 1323 | 2680 | | 28 | 42 | 596 |
| Ar (mg/L) | | 5 | 1 | | | | | 2 | |
| B (mg/L) | | 5 | | | | | | 2 | |
| Ba (mg/L) | 0.97 | 0.2 | | | | | | | |
| Ca (mg/L) | | 318 | 487 | 53 | 588 | 537 | 211 | 703 | 1663 |
| Cd (mg/L) | | 2 | 212 | 27 | | | | 0.1 | |
| Cr (mg/L) | 0.58 | 15 | 4 | 7 | | | | 1 | |
| Cu (mg/L) | | 22 | 5437 | 106 | | | | | |
| Fe (mg/L) | | 1674 | 616 | 309 | | 157 | 30 | 35 | 141 |
| Hg (mg/L) | | | | | | | | | |
| K (mg/L) | 956 | 206 | 74 | | 807 | 71 | 282 | 349 | 345 |
| Mg (mg/L) | | 126 | 3428 | 578 | 5100 | 345 | 426 | 220 | 820 |
| Mn (mg/L) | | 5 | | 1229 | 2180 | 17 | | 2 | |
| Mo (mg/L) | 1.5 | 5 | | 0.2 | | | | | |
| Na (mg/L) | 62950 | 0.2 | 668 | 5 | 2430 | 1430 | 1370 | 2129 | 1739 |
| Ni (mg/L) | 0.01 | 2 | 90 | 24 | | | | 0 | |
| P (mg/L) | | 1782 | 57 | 308 | 2298 | 6367 | 200 | 644 | |
| Pb (mg/L) | | | | | | | | | |
| S (mg/L) | | 7133 | 16250 | 35070 | | | 8900 | 204 | |
| Sb (mg/L) | | 4 | | | | | | | |
| Se (mg/L) | | 3 | | 0.5 | | | | | |
| Ti (mg/L) | 0.08 | 20 | | | | | | | |
| Zn (mg/L) | | 12 | 1968 | 1036 | | | | 1 | |
| Zr (mg/L) | 0.16 | 9 | | | | | | | |
| NH₄ (mg/L) | | | | | | 1390 | | | |
| SO₄⁻² (mg/L) | 17976 | | | | 51732 | 4000 | | | |
| CO3⁻² | 115037 | | | | | | | | |
| Cl⁻ (mg/L) | | | | | 3048 | 4876 | | | |

¹TM = Trona Mining
²V = Vanadium
³Cu = Copper
⁴Syn. = Synthetic
⁵PG = Phospho-gypsum

TABLE 16A
Characteristics of the Geosynthetic Clay Liners Tested

| | | | | | Polymer | Polymer |
|---|---|---|---|---|---|---|
| | | | | Target | Content | System |
| | Polymer | Clay | | Loading | in Mix | Mesh |
| GCL ID | ID | Type | Clay Size | (lbs/ft²) | (wt. %) | Size |
| AG1 | P1 | Na—B | MX-80 | 1.0 | 8 | 14-80 |
| AG2 | P2 | Na—B | MX-80 | 1.0 | 4 | 14-80 |
| AG3 | P2 | Na—B | CG-50 | 1.0 | 6 | 14-80 |
| AG4 | P2 | Na—B | CG-50 | 1.3 | 6 | 12-325 |
| AG5 | P2 | Na—B | MX-80 | 1.0 | 8 | 14-80 |
| AG6 | P2 | Na—B | CG-50 | 1.0 | 8 | 14-80 |
| AG7 | P2 | Na—B | MX-80 | 1.0 | 8 | 12-325 |
| AG8 | P2 | Na—B | MX-80 | 1.0 | 10 | 12-325 |
| AG9 | P3 | Na—B | CG-50 | 1.0 | 8 | 60-150 |
| AG10 | P3 | Na—B | CG-50 | 1.0 | 8 | 14-80 |
| AG11 | P3 | Na—B | CG-50 | 1.0 | 8 | 14-80 |
| AG12 | P4 | Na—B | CG-50 | 1.1 | 4 | 16-270 |
| AG13 | P4 | Na—B | CG-50 | 1.3 | 6 | 16-270 |
| AG14 | P4 | Na—B | CG-50 | 1.2 | 6 | 14-80 |
| AG15 | P4 | Na—B | CG-50 | 1.0 | 6 | 14-80 |
| AG16 | P4 | Na—B | CG-50 | 0.9 | 8 | 18-270 |
| AG17 | P4 | Na—B | CG-50 | 1.1 | 8 | 16-270 |
| AG18 | P4 | Na—B | CG-50 | 1.0 | 8 | 14-80 |
| AG19 | P4 | Na—B | CG-50 | 0.9 | 8 | 12-325 |
| AG20 | P5 | Na—B | CG-50 | 1.2 | 8 | 14-80 |
| AG21 | P6 | Na—B | CG-50 | 1.1 | 8 | 14-80 |
| AG22 | Stockosorb F | Na—B | CG-50 | 1.0 | 8 | 70-270 |
| AG23 | CPC-41 | Na—B | CG-50 | 0.9 | 15 | 14-80 |
| AG24 | CPC-42 | Na—B | CG-50 | 1.2 | 6 | 14-80 |
| AG25 | P2 | Na—B | CG-50 | 0.85 | 8 | 14-80 |
| AG26 | P2 | Na—B | CG-50 | 0.85 | 8 | 18-270 |
| AG27 | P2 | Na—B | CG-50 | 0.85 | 8 | 120-140 |
| AG28 | P2 | Na—B | CG-50 | 0.85 | 8 | 70-120 |
| AG29 | P2 | Na—B | CG-50 | 0.85 | 8 | 35-45 |
| AG30 | P2 | Na—B | CG-50 | 0.85 | 8 | 20-30 |
| AG31 | P2 | Na—B | CG-50 | 0.85 | 8 | 14-18 |

TABLE 16B
Characteristics of the Permeant and Hydraulic Conductivity for Geosynthetic Clay Liners Tested

| | | | | Per- | | | |
|---|---|---|---|---|---|---|---|
| | | | | meant | | | |
| | | | Permeant | Ionic | Permeant | | Hydraulic |
| | | | Electrical | Strength | RMD | | Conduc- |
| GCL | | Permeant | Conductivity | by ICP | by ICP | | tivity |
| ID | Permeant Type | pH | (μS/cm) | (M) | (M\hat{ }0.5) | PVF | (cm/sec) |
| AG1 | Real Vanadium | 1.27 | 39800 | 1.28 | 0.09 | 29.8 | 3.18E−07 |
| AG2 | Real Vanadium | 1.27 | 39800 | 1.28 | 0.09 | 32.9 | 6.69E−08 |
| AG2 | Real Vanadium | 1.27 | 39800 | 1.28 | 0.09 | 36.1 | 8.57E−08 |
| AG2 | Syn. Copper Site #1 | 1.08 | 71000 | 1.99 | 0.21 | 11.3 | 1.24E−08 |
| AG3 | Real Copper Site #1 | 2.7 | 29200 | 1.05 | 4.76 | 30 | 6.10E−08 |
| AG3 | Real Vanadium | 1.27 | 39800 | 1.28 | 0.09 | 26.8 | 7.19E−08 |
| AG4 | Real Copper Site #2 | 1.08 | 45100 | 2.61 | 0.0006 | 22.2 | 2.33E−07 |
| AG5 | Syn. Phosphogypsum #1 | 2.05 | 21700 | 0.79 | 0.66 | 23.6 | 2.71E−09 |
| AG5 | Real Phosphogypsum #2 | 1.67 | 24300 | 0.3 | 0.27 | 2.7 | 1.97E−09 |
| AG5 | Real Copper Site #1 | 2.7 | 29200 | 1.05 | 4.76 | 67.7 | 5.24E−09 |
| AG5 | Real Vanadium | 1.27 | 39800 | 1.28 | 0.09 | 19.3 | 1.02E−08 |
| AG5 | Syn. High Chloride FGD | 11.5 | 73800 | 2.27 | 0.08 | 18.04 | 6.42E−07 |
| AG6 | Real Vanadium | 1.27 | 39800 | 1.28 | 0.09 | 29.2 | 5.76E−08 |
| AG6 | Syn. High Chloride FGD | 11.5 | 73800 | 2.27 | 0.08 | 15 | 3.27E−06 |
| AG6 | Trona Mining | 9.7 | 133300 | 4.16 | 48.1 | 40 | 9.65E−06 |
| AG7 | Syn. Phosphogypsum #2 | 0.5 | 160000 | 1.52 | 0.53 | 10.2 | 6.77E−06 |
| AG8 | Syn. Phosphogypsum #1 | 2.05 | 21700 | 0.79 | 0.66 | 13.8 | 3.64E−08 |
| AG9 | Syn. Phosphogypsum #1 | 2.05 | 21700 | 0.79 | 0.66 | 5.6 | 1.33E−09 |
| AG10 | Syn. Phosphogypsum #1 | 2.05 | 21700 | 0.79 | 0.66 | 0.9 | 4.75E−10 |
| AG9 | Real Copper Site #1 | 2.7 | 29200 | 1.05 | 4.76 | 18.3 | 6.52E−09 |
| AG9 | Real Vanadium | 1.27 | 39800 | 1.28 | 0.09 | 5.5 | 7.09E−10 |
| AG11 | Syn. High Chloride FGD | 11.5 | 73800 | 2.27 | 0.08 | 4.2 | 1.57E−09 |
| AG12 | Real Copper Site #2 | 1.08 | 45100 | 2.61 | 0.0006 | 7.2 | 4.04E−09 |
| AG12 | Syn. Copper Site #1 | 1.08 | 71000 | 1.99 | 0.21 | 15.8 | 1.28E−08 |
| AG13 | Real Phosphogypsum #1 | 1.81 | 24500 | 0.27 | 0.82 | 0.6 | 3.86E−10 |
| AG13 | Real Copper Site #2 | 1.08 | 45100 | 2.61 | 0.0006 | 12.5 | 7.97E−09 |
| AG13 | Syn. Phosphogypsum #2 | 0.5 | 160000 | 1.52 | 0.53 | 7.8 | 9.82E−09 |
| AG15 | Syn. Phosphogypsum #2 | 0.5 | 160000 | 1.52 | 0.53 | 14.8 | 4.17E−09 |
| AG13 | Syn. Phosphogypsum #2 | 0.5 | 160000 | 1.52 | 0.53 | 19.1 | 1.14E−08 |
| AG16 | Real Vanadium | 1.27 | 39800 | 1.28 | 0.09 | 9.7 | 3.33E−09 |
| AG15 | Real Vanadium | 1.27 | 39800 | 1.28 | 0.09 | 1.1 | 1.48E−09 |
| AG17 | Real Copper Site #2 | 1.08 | 45100 | 2.61 | 0.0006 | 5.8 | 2.39E−09 |
| AG18 | Syn. Phosphogypsum #2 | 0.5 | 160000 | 1.52 | 0.53 | 8.7 | 2.75E−09 |
| AG17 | Syn. Phosphogypsum #2 | 0.5 | 160000 | 1.52 | 0.53 | 16.1 | 8.24E−09 |
| AG19 | Syn. Phosphogypsum #2 | 0.5 | 160000 | 1.52 | 0.53 | 14.6 | 1.88E−07 |
| AG20 | Real Vanadium | 1.27 | 39800 | 1.28 | 0.09 | 5.5 | 7.96E−09 |
| AG21 | Real Vanadium | 1.27 | 39800 | 1.28 | 0.09 | 13 | 2.20E−08 |
| AG22 | Real Vanadium | 1.27 | 39800 | 1.28 | 0.09 | 21.2 | 2.39E−06 |
| AG25 | B | 10.6 | 44,440 | 1.05 | 6.31 | 2.6 | 7.34E−09 |
| AG26 | B | 10.6 | 44,440 | 1.05 | 6.31 | 33 | 8.60E−07 |
| AG27 | B | 10.6 | 44,440 | 1.05 | 6.31 | 15.2 | 2.74E−08 |
| AG28 | B | 10.6 | 44,440 | 1.05 | 6.31 | 27.5 | 4.51E−08 |
| AG29 | B | 10.6 | 44,440 | 1.05 | 6.31 | 19.3 | 8.48E−08 |
| AG30 | B | 10.6 | 44,440 | 1.05 | 6.31 | 27.4 | 5.32E−06 |
| AG31 | B | 10.6 | 44,440 | 1.05 | 6.31 | 6.1 | 1.27E−07 |

TABLE 17
Characteristics of the Permeant and Hydraulic Conductivity for
Geosynthetic Clay Liners Tested after multiple wet/dry cycles

GCL Sample ID

| | AG23 | AG24 |
|---|---|---|
| Permeant Type | Wet/Dry | Wet/Dry |
| | Low RMD | Low RMD |
| Wet/Dry Cycles in Permeant | 20 | 15 |
| Permeant pH | 6.2 | 6.2 |
| Permeant Electrical Conductivity | 1562 | 1562 |
| (μS/cm) | | |
| Permeant Ionic Strength by ICP (M) | 0.025 | 0.025 |
| Permeant RMD by ICP (M\hat{ }0.5) | 0.007 | 0.007 |
| PVF | 7.7 | 1.3 |
| Hydraulic Conductivity (cm/sec) | 5.30 × 10⁻⁸ | 2.4 × 10⁻⁹ |

TABLE 18
Free swell for the various AMPS-based polymers systems
as a function of leachate type and particle size.

| | | Polymer | |
|---|---|---|---|
| Polymer | | System Mesh | Free Swell |
| System | Permeant | Size | (mL/2 grams) |
| P1 | Real Vanadium | 14-80 | 50 |
| P2 | Real Copper Site #1 | 14-80 | 46 |
| P2 | Real Vanadium | 14-80 | 65 |
| P2 | Syn. FGD Leachate | 14-80 | 42 |
| P2 | Syn. Phosphogypsum #1 | 14-80 | 67 |
| P2 | Syn. Phosphogypsum #2 | 12-325 | 58 |
| P2 | Trona Mining | 14-80 | 32 |
| P3 | Real Copper Site #1 | 60-150 | 49 |
| P3 | Real Vanadium | 60-150 | 42 |
| P3 | Syn. FGD Leachate | 14-80 | 40 |
| P3 | Syn. Phosphogypsum #1 | 14-80 | 46 |
| P3 | Syn. Phosphogypsum #1 | 60-150 | 46 |
| P4 | Syn. Phosphogypsum #2 | 12-325 | 67 |
| P4 | Syn. Phosphogypsum #2 | 14-80 | 93 |
| P4 | Syn. Phosphogypsum #2 | 16-270 | 102 |
| Stockosorb F | Real Vanadium | 70-270 | 24 |

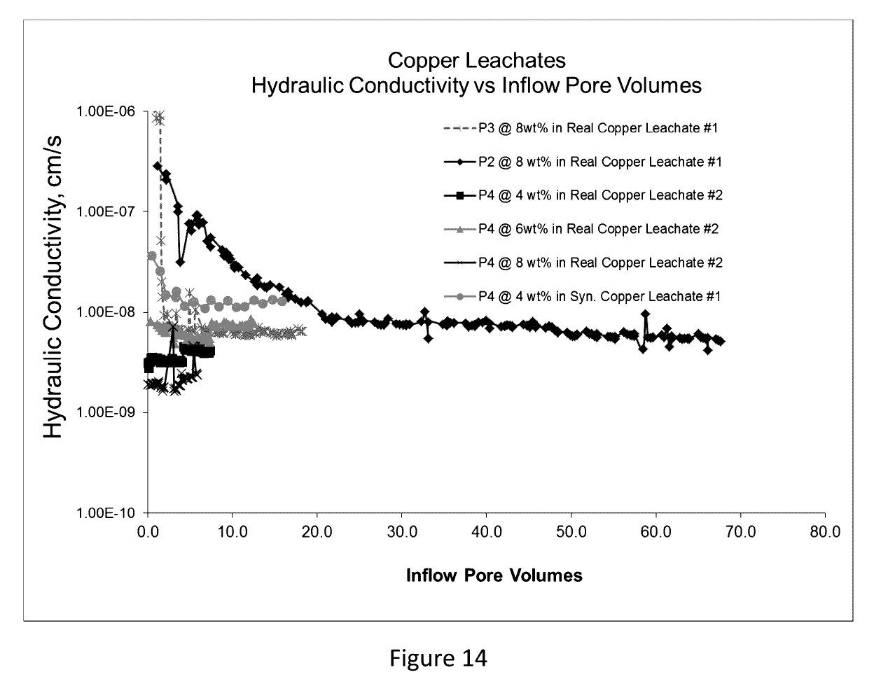

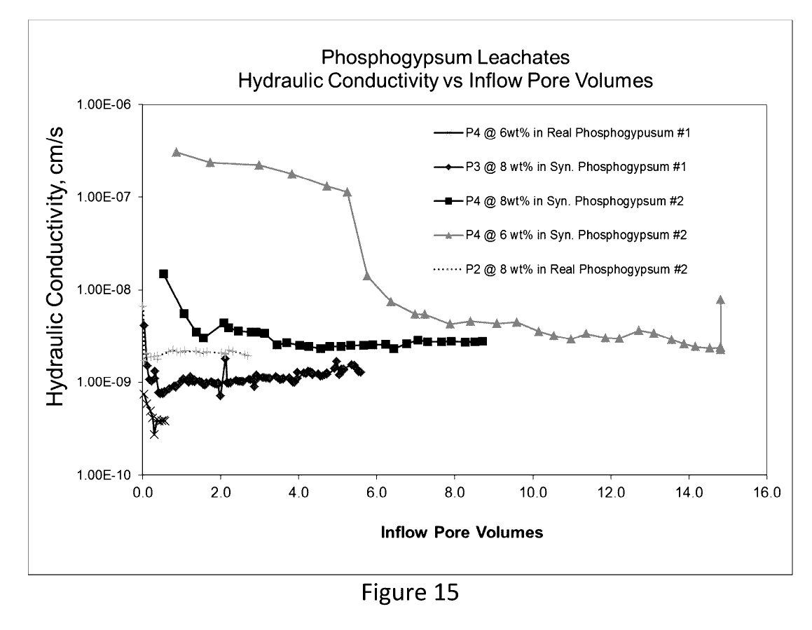

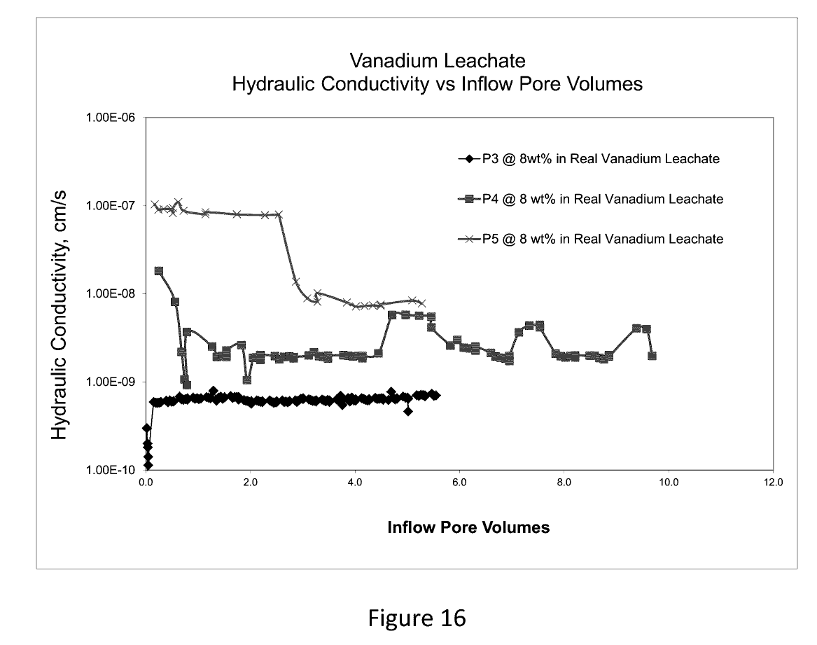

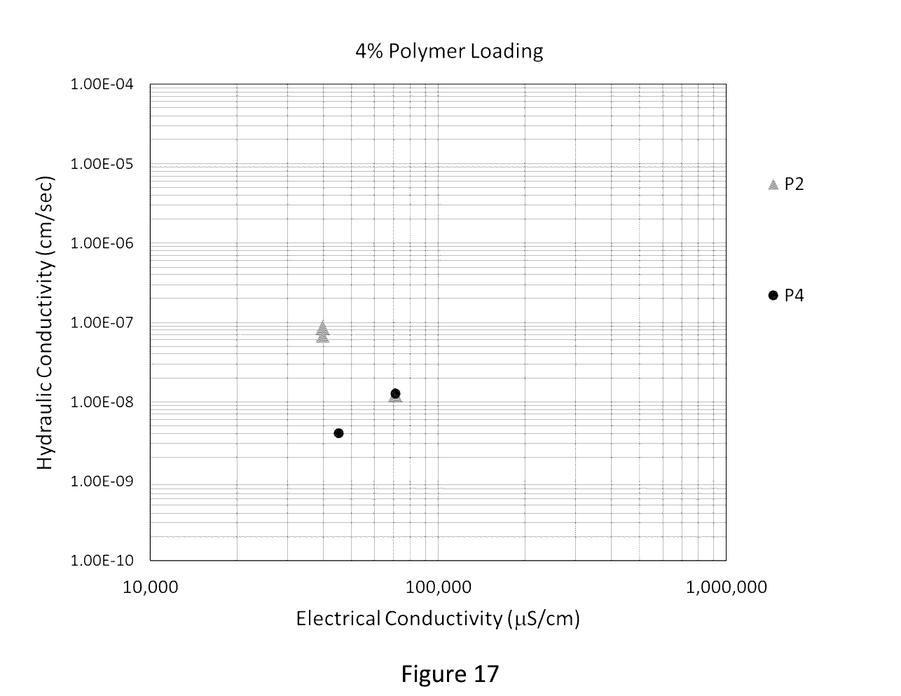

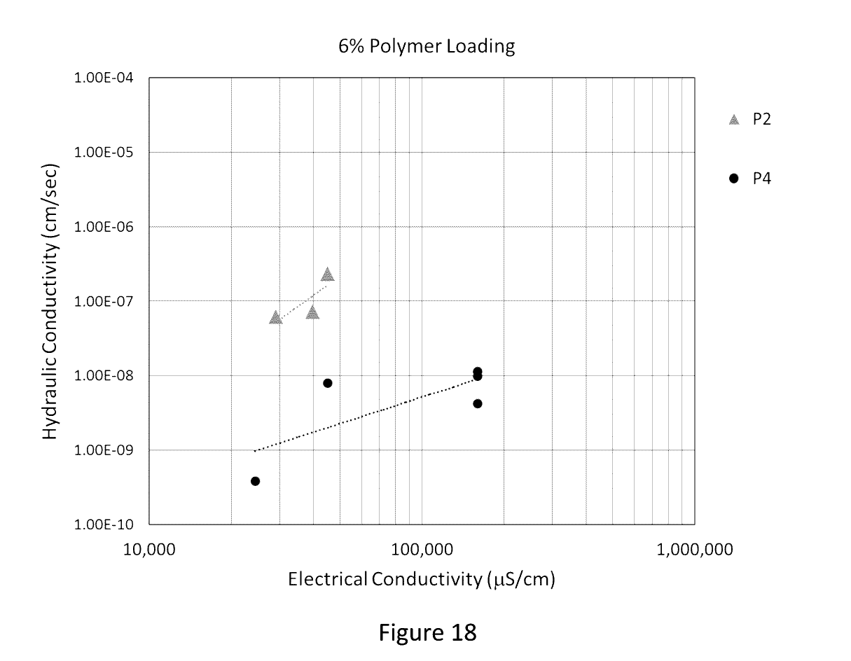

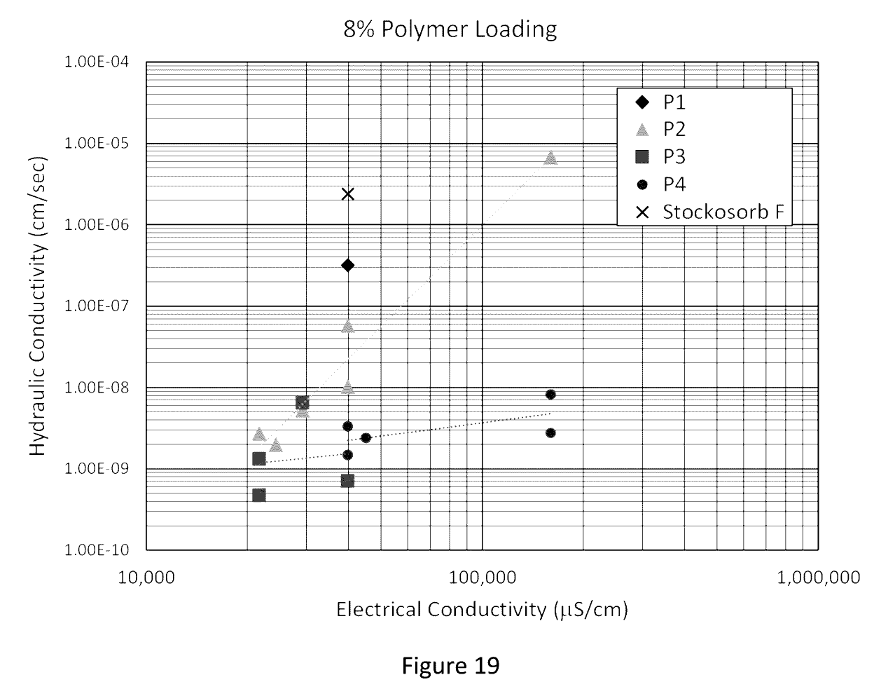

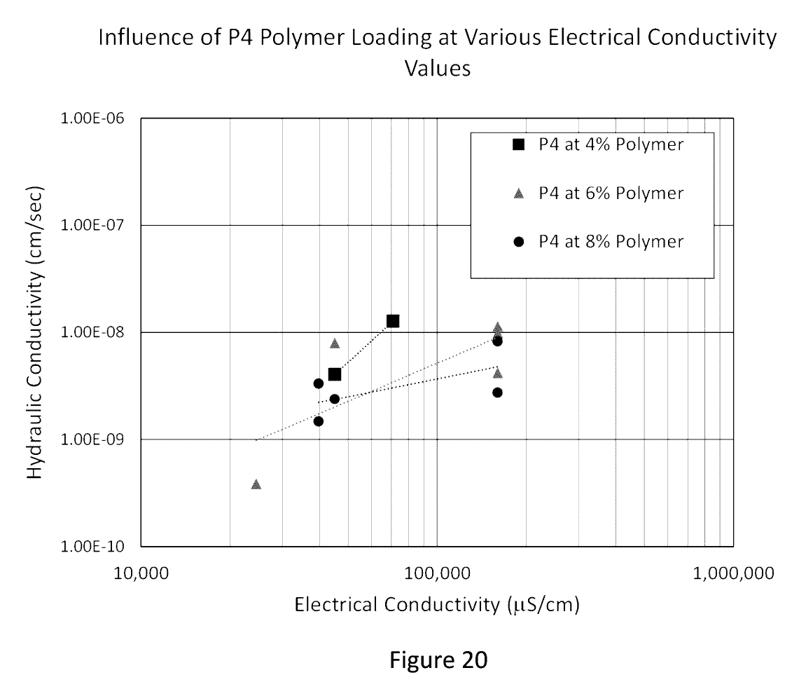

In FIGS. 14, 15, and 16, the hydraulic conductivity is shown as a function of in-flow pore volume for three different types of leachates, copper leachate, phosphogypsum leachate, and vanadium leachate. The pore volume was estimated by taking the difference between the total volume of the hydrated GCL and the volume of the solids. As shown in these Figures, low hydraulic conductivity is exhibited for all three aggressive leachates. FIGS. 17, 18, and 19 show the hydraulic conductivity as a function of the electrical conductivity of the leachate (where electrical conductivity is an estimate of the ionic strength, as discussed above). FIG. 20 compares several polymer loadings for polymer P4 (see table 14). As shown in FIG. 20, increasing the amount of polymer in the hydraulic barrier composition reduce the hydraulic conductivity for a given polymer.

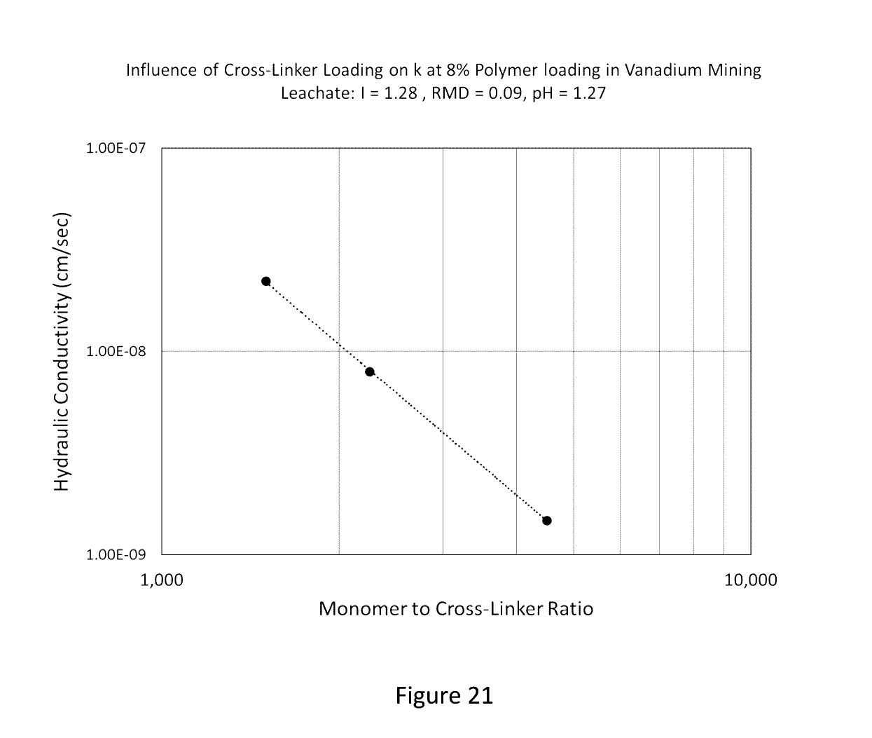

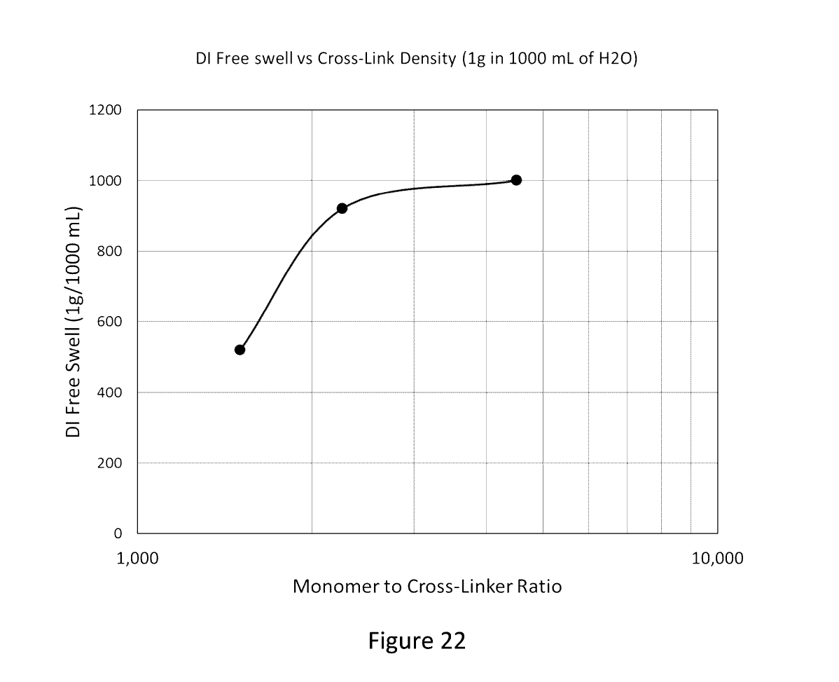

FIGS. 21 and 22 illustrate the effects of the cross-link density, expressed as the molar ratio of monomer to crosslinking agent. The hydraulic conductivity decreases as the molar ratio of the monomer to cross-linking agent increases (or the cross-link density decreases). As shown in FIG. 22, the free swell in deionized water decreases as the ratio of the monomer to crosslinking agent decreases (or the cross-link density increases).

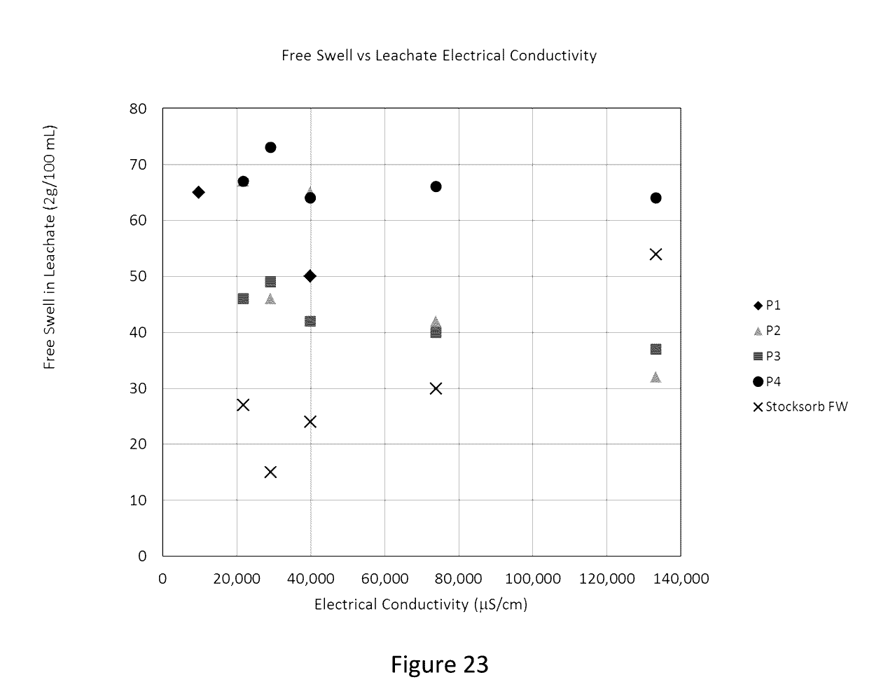

Table 18 shows the free swell of the various AMPS-polymer granules in the leachates evaluated in this work. The free swell test was performed according to ASTM D5890. STOCKOSORB™ F is partially cross-linked acrylamide/partially neutralized acrylic acid copolymers, with about 90 wt. % of the particles having a diameter falling between 177 microns and 74 microns (80-200 mesh) as determined by a sieve analysis where 90 wt. % of a sample passed through the 80 mesh sieve and was retained on the 200 mesh sieve (U.S. sieve sizes). FIG. 23 is a graph of the free swell in leachate as a function of the electrical conductivity of the leachate. For the polymer-granules of the embodiments of the disclosure shown in FIG. 23, there is not a large decrease in the free swell with an increase in electrical conductivity. This is contrast to traditional swelling clays and superabsorbent polymers.

Two GCL samples were evaluated for the effects of wet/dry cycling in a low RMD leachate. GCL samples were cut to dimensions of 20 cm×20 cm (8″×8″). A silicone caulk was applied to the edges of the GCL specimens to retain the clay/polymer blends (see Table 14 for polymer descriptions). The samples were submerged between two geonet or geocomposites samples, rubber banded together. GCL samples were allowed to hydrate for a minimum of 48 hours in the test solution in the low RMD solution. Samples were allowed to air dry to a maximum of 40% moisture content as measured according to the methods outlined in ASTM D2216 Standard Test Method for Laboratory Determination of Moisture Content of Soil and Rock. Table 17 represents the resistance of the GCLs to the effects of wet/dry cycling in low RMD leachates. Traditional bentonite GCLs can exhibit an increase in hydraulic conductivity when exposed to calcium rich leachates due to ion exchange. Sample AG23, prepared with the 15 wt % of the CPC-41 AMPS-polymer granules, exhibited a low hydraulic conductivity of 5.3×10⁻⁸ cm/sec despite undergoing 20 wet/dry cycles with the “wet/dry Low RMD leachate” described in Table 10B. Similarly, sample AG24, prepared with 6 wt. % of the CPC-42 AMPS-polymer system withstood 15 wet dry cycles and maintained a low hydraulic conductivity of 2.4×10⁻⁹ cm/sec.

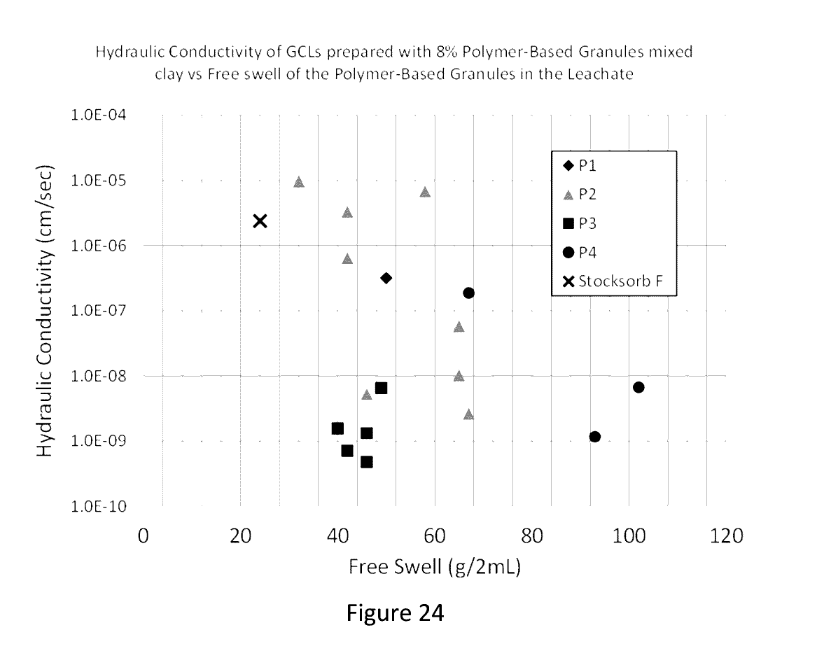

FIG. 24 is a graph of the hydraulic conductivity for GCL samples prepared with 8 wt % of the various AMPS-based polymer systems. As can be seen in FIG. 24, some polymer systems exhibit lower hydraulic conductivity (i.e. P3) despite having similar free swells in the given leachates. As a general trend, systems with free swells greater than 40 in a given leachate have lower hydraulic conductivity. Systems with free swells greater than 60 appear to yield the lowest hydraulic conductivity.

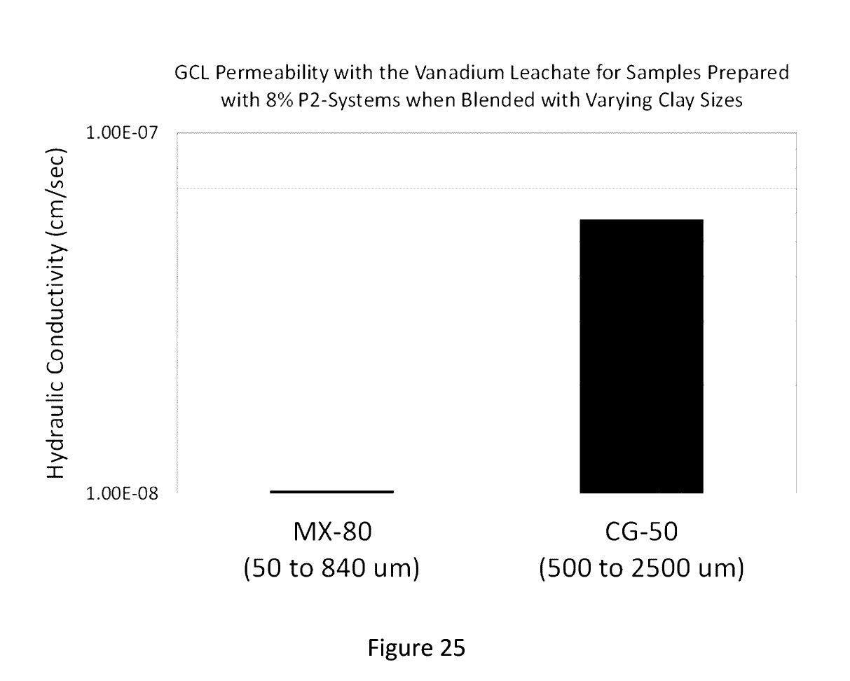

FIG. 25 compares the hydraulic conductivity for two systems with where the AMPS-based polymer granules are mixed with clays of different sizes. From the graph it appears that smaller clay particle sizes (50 to 840 μm) promote lower hydraulic conductivity for the P2 polymer system at 8 wt % loading compared to the larger clay particle sizes (500 to 2500 μm) where size refers to diameter. Diameters are estimated based on removing particles larger and smaller than the stated range by sieving/screening out those particles falling above or below the limits.

### Example 10

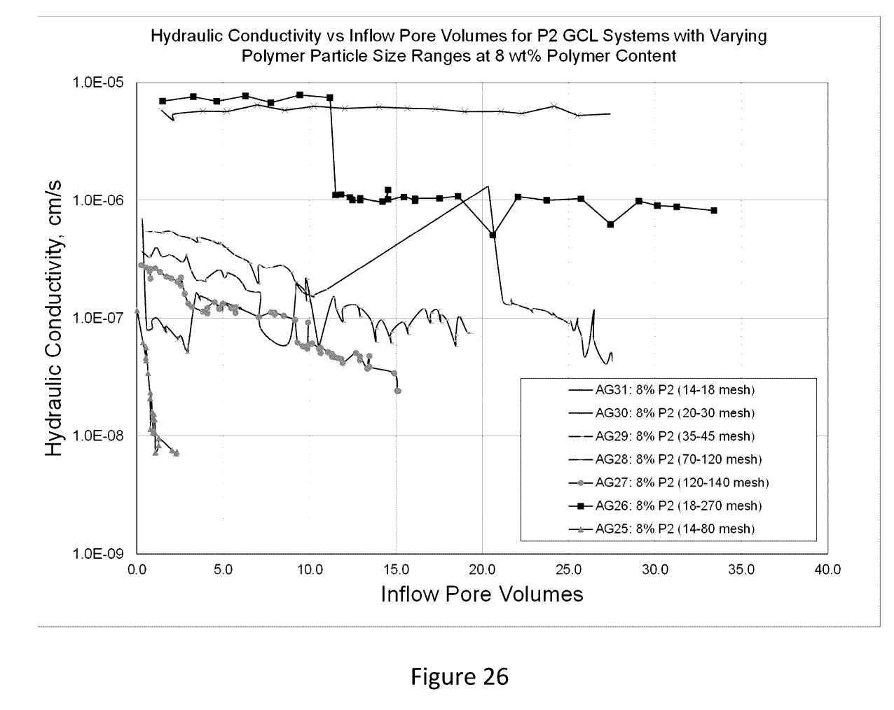

FIG. 26 shows the influence of P2 polymer particle size on hydraulic conductivity as a function of pore flow through the GCL. Samples AG25 to AG31 were tested for hydraulic conductivity against leachate B (leachate chemistry was described in Table 10B). The GCL samples were formulated as described in Table 16A, where 8 wt % of the P2 polymer of various particle diameter ranges were physically mixed with CG-50 sized bentonite (no clay-polymer granules were formed). The P2 polymer size fractions were obtained by sieving the original polymer size distribution which ranged from 14 to 270 mesh. Two systems with wider particle size distributions were also prepared. One sample with a wider particle size distribution was prepared by sieving such that the polymer particles passed through a 14 mesh sieve and were retained on 80 mesh sieve. Another sample had a size fraction such that the particles passed through 18 mesh sieve and were retained on a 270 mesh sieve. Surprisingly, the sample AG25, with the particle size distribution from 14 to 80 mesh (AG25), reached a hydraulic conductivity of less than 1×10⁻⁷ cm/sec much more quickly than the samples with the narrower cuts of a particular mesh range. In addition, system AG25 had the lowest hydraulic conductivity of all the P2 samples tested against leachate B of 7.34×10⁻⁹ cm/sec. Sample AG26, which contained the wide particle size distribution of 18 to 270 mesh sized particles did not reach a reach a hydraulic conductivity of less than 1×10⁻⁷ cm/sec. This implies that the systems containing polymer particles with sizes smaller than 140 mesh will have higher hydraulic conductivities than those prepared with samples prepared with polymer particles sieved to between 45 and 140 mesh.

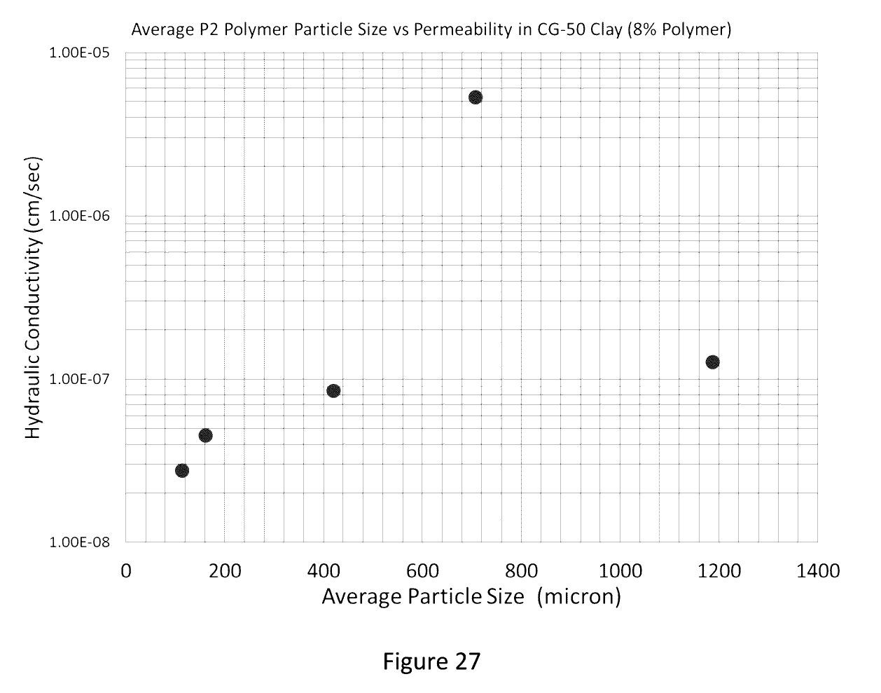

In FIG. 27, the hydraulic conductivity values for samples AG27 to AG31 tested against leachate B were plotted versus their respective estimated average P2 polymer particle diameter. The average P2 polymer particle diameter was estimated from the sieve mesh sizes listed in Table 16A. For this plot, only the GCL samples that had narrow cuts of the different P2 polymer particle diameters were included by screening out particles above or below the limits. The data in FIG. 27 shows that hydraulic conductivity values of less than 1×10⁻⁷ cm/sec were seen for polymers with particle diameters ranging from 105 microns to 500 microns (35 mesh to 140 mesh). The lowest hydraulic conductivity values was observed for the polymer particles sized between 120 mesh to 140 mesh (˜105 to ˜125 microns), which had a hydraulic conductivity of 2.74×10⁻⁸ cm/sec.

While various embodiments have been described above, this disclosure is not intended to be limited thereto. Variations can be made to the disclosed embodiments that are still within the scope of the appended claims.

1. A method comprising:
providing a clay-polymer composite comprising a polymer, the polymer of the composite formed from one or more monomers, at least one monomer being acrylamido-methyl-propane sulfonate (AMPS), and optionally a cross-linking agent;
wherein providing the clay-polymer composite comprises
polymerizing AMPS monomer, optionally with one or more other monomers, and optionally, with one or more crosslinking agents, one or more additives, or one or more crosslinking agents and one or more additives, in the presence of the clay;
or
blending the clay and the polymer and optionally one or more additives,
the polymer being a pre-synthesized polymer;
and
forming a hydraulic barrier composition comprising the clay-polymer composite.

2. The method of claim 1, wherein the polymer of the composite is a homopolymer of AMPS.

3. The method of claim 1, wherein the polymer of the composite is a copolymer of AMPS.

4. The method of claim 3, wherein AMPS comprises at least 25 mol % of the monomers used to form the copolymer.

5. The method of claim 3, wherein AMPS comprises at least 30 mol % of the monomers used to form the copolymer.

6. (canceled)

7. (canceled)

8. The method of claim 3, wherein AMPS comprises at least 50 mol % of the monomers used to form the copolymer.

9. (canceled)

10. The method of claim 3, wherein AMPS comprises not more than 95 mol % of the monomers used to form the copolymer.

11. The method of claim 3, wherein the one or more other monomers are selected from the group consisting of alkylacrylamides, methacrylamides, styrenes, allylamines, allylammonium, diallylamines, diallylammoniums, alkylacrylates, methacrylates, acrylates, n-vinyl formamide, vinyl ethers, vinyl sulfonate, acrylic acid, sulfobetaines, carboxybetaines, phosphobetaines, and maleic anhydride and combinations thereof.

12. (canceled)

13. (canceled)

14. The method of claim 1, wherein at least 85 wt % of the polymer of the composition is part of a cross-linked network.

15. The method of claim 1, wherein the polymer comprises 2 wt % to 80 wt % based on the total weight of the clay-polymer composite.

16. (canceled)

17. The method of claim 15, wherein the clay of the composite is a water-swellable smectite clay selected from the group consisting of sodium montmorillonite, sodium bentonite, sodium activated calcium bentonite, and mixtures thereof.

18. (canceled)

19. The method of claim 15, wherein the clay-polymer composite comprises clay-polymer granules at least a portion of which are used in forming the hydraulic barrier composition.

20. The method of claim 19, wherein at least 80% of the clay-polymer granules, by weight, have a diameter in a range of 6 mesh (3360 μm) to 325 mesh (44 μm).

21. (canceled)

22. The method of claim 19, wherein forming the hydraulic barrier composition comprises disposing the clay-polymer granules and optionally disposing filler granules and optionally disposing other materials, in between a first sheet material and a second sheet material, and attaching the second sheet material to the first sheet material; wherein the first sheet is attached to the second sheet by needle punching, chemical binding, adhesive binding, or a combination thereof.

23. The method of claim 22, wherein from about 0.75 lb/ft² to about 2.0 lbs/ft² of the combination of the clay-polymer granules, the optional filler granules, and the optionally other materials are disposed between the first sheet material and the second sheet material.

24. The method of claim 23, wherein the optional filler granules, the optional other materials, or the optional filler granules and the optional other materials are present, and the filler granules comprising a filler; and wherein the clay-polymer granules comprise at least 0.25 wt. % of the combination of clay-polymer granules, optional filler granules and optional other materials disposed between the first and second sheet materials.

25. The method of claim 23, wherein the optional filler granules are present, and the filler is selected from the group consisting of a water-swellable clay, gypsum, fly ash, silicon carbide, silica sand, lignite, recycled glass, calcium sulfate, cement, calcium carbonate, talc, mica, vermiculite, acid activated clays, kaolin, silicon dioxide, titanium dioxide, calcium silicate, calcium phosphate, and mixtures thereof.

26. (canceled)

27. (canceled)

28. The method of claim 25, wherein the water-swellable clay filler is of a diameter in the range of 50 microns to 840 microns as determined by a sieve analysis and wherein the water-swellable clay filler is a water-swellable smectite clay selected from the group consisting of sodium montmorillonite, sodium bentonite, sodium activated calcium bentonite, and mixtures thereof.

29. (canceled)

30. The method of claim 22, wherein other materials are present, the other materials comprising a second water-solvatable polymer which may be the same as or different from the polymer of the composition.

31. The method of claim 30, wherein the second water-solvatable polymer is mixed with the clay-polymer granules prior to being disposed between the first sheet material and the second sheet material.

32. (canceled)

33. A hydraulic barrier composition, comprising clay-polymer granules comprising a water-solvatable clay and a sulfonated water-soluble polymer, at least 25 mol % of the constituent monomer(s) of the sulfonated polymer of the composition being acrylamido-methyl-propane sulfonate (AMPS); and the composition comprising the clay-polymer granules being disposed between a first and a second sheet material.

34. The hydraulic barrier composition of claim 33, wherein the composition disposed between the first and second sheet materials is at a total loading of 0.75 lbs/ft² to 1.2 lbs/ft².

35. The hydraulic barrier composition of claim 33, wherein the composition disposed between the first sheet material and the second sheet material comprises at least 4% by weight of polymer derived from the monomer AMPS and the resulting barrier has a measured by hydraulic conductivity or of 1×10⁻⁷ cm/sec or less when tested with an aqueous liquid.

36. The hydraulic barrier composition of claim 33, wherein the composition disposed between the first sheet material and the second sheet material comprises at least 4% by weight of polymer derived from the monomer AMPS wherein the AMPS based polymer has a free swell of at least 40 with a liquid comprising water and one or more dissolved salts.

37. (canceled)

38. (canceled)

39. (canceled)

40. A method of containing a leachate, comprising;
disposing a hydraulic barrier composition in contact with an aqueous leachate, the hydraulic barrier composition comprising:
a clay; and
a polymer formed from one or more monomers and optionally a cross-linking agent, at least one monomer being acrylamido-methyl-propane sulfonate (AMPS).

41. The method of claim 40, wherein the hydraulic barrier composition comprises at least 4% by weight of polymer derived from the monomer AMPS.

42. The method of claim 41, wherein the hydraulic barrier composition is disposed between a first sheet material and a second sheet material is at a total loading of 0.75 lbs/ft² to 1.2 lbs/ft².

43. The method of claim 40, wherein the hydraulic barrier maintains a hydraulic conductivity of less than 1×10⁻⁷ cm/sec when permeated with an ionic leachate with a pH of less than 4.

44. The method of claim 40, wherein the hydraulic barrier maintains a hydraulic conductivity of less than 1×10⁻⁷ cm/sec when permeated with an ionic leachate with an ionic strength of between 0.02 mol/L and 3 mol/L.

45. (canceled)

46. (canceled)

47. (canceled)

48. The method of claim 1, wherein the clay-polymer composite is a physical blend comprising polymer and clay, and the polymer of the composite is a homopolymer of AMPS or a copolymer of AMPS of a diameter such that it passes through a 14 mesh sieve and is retained on an 80 mesh sieve, and the clay is a natural sodium bentonite clay with a diameter range of approximately 500 microns to 2500 microns as determined by sieving.
